(19) United States
(12) Patent Application Publication
(10) Pub. No.: US 2006/0216660 A1
(43) Pub. Date: Sep. 28, 2006

(54) Photothermographic material

(75) Inventors: Takayoshi Oyamada, Kanagawa (JP); Yoshihisa Tsukada, Kanagawa (JP)

Correspondence Address: TAIYO CORPORATION, 401 HOLLAND LANE, #407, ALEXANDRIA, VA, 22314, US

(73) Assignee: FUJI PHOTO FILM CO., LTD.

(21) Appl. No.: 11/369,765

(22) Filed: Mar. 8, 2006

(30) Foreign Application Priority Data
Mar. 28, 2005 (JP) 2005-093312

(51) Int. Cl. G03C 1/00

(52) U.S. Cl. 430/619

(57) ABSTRACT

A photothermographic material comprising: a support and, on at least one surface of the support, an image-forming layer containing at least a photosensitive silver halide, a non-photosensitive organic silver salt, a reducing agent and a binder and at least a non-photosensitive layer, wherein the image forming layer and/or the non-photosensitve layer contains a polymer latex dispersed and stabilized with a water-soluble polymer protective colloid during polymerization.

### CROSS-REFERENCE TO RELATED APPLICATION

This application claims priority under 35 USC 119 from Japanese Patent Application No. 2005-093312, the disclosure of which is incorporated by reference herein.

### BACKGROUND OF THE INVENTION

1. Field of the Invention

The present invention relates to a photothermographic material which is used advantageously in the fields of films for medical diagnosis and films for photoengraving.

2. Description of the Related Art

In recent years, there has been a strong desire for reduction of waste liquid in the fields of films for medical diagnosis and for photoengraving from the viewpoints of environmental protection and space saving. Under such circumstances, technologies relating to heat developing image-recording materials as films for medical diagnosis and photoengraving which can be exposed to light efficiently with a laser image setter or a laser imager, and can form a clear black image having high resolution and sharpness have been demanded. With these heat developing image-recording materials, it is possible to supply to customers a heat development treatment system which does not require solvent-based processing chemicals, is simpler, and does not harm the environment.

Similar requirements also exist in the field of general image forming materials. However, an image for medical diagnosis is required to have a high image quality excellent in sharpness and graininess, because fine depiction is required. In addition, an image for medical diagnosis is characterized by preferably exhibiting a blue black tone image from the viewpoint of ease of medical diagnosis. Currently, various hard copy systems utilizing pigments or dyes such as inkjet printers and apparatuses for electrophotography are being distributed as general image forming systems. However, there is no system which is satisfactory as a medical image-output system.

On the other hand, thermal image forming systems utilizing organic silver salts are described in, for example, U.S. Pat. Nos. 3,152,904 and 3,457,075, and in “Thermally Processed Silver Systems∞ by D. Klosterboer appearing in Imaging Processes and Material, Neblette, 8th edition, edited by J. Sturge, V Warlworth, and A. Shepp, Chapter 9, page 279, 1989. In particular, photothermographic materials generally have an image-forming layer in which a catalytically active amount of photocatalyst (for example, a silver halide), a reducing agent, a reducible silver salt (for example, an organic silver salt) and, optionally, a color tone adjusting agent for controlling the tone of a developed silver image are dispersed in a binder matrix. When the photothermographic material is imagewise exposed to light and then heated to a high temperature (for example, 80° C. or higher), a redox reaction between the reducible silver salt (acting as an oxidizing agent) and the reducing agent occurs to form a black-toned silver image. The redox reaction is promoted by the catalytic activity of a latent image on the silver halide formed by exposure. Accordingly, the black-toned silver image is formed in an exposed region.

Such photothermographic materials are already known. However, in many of these recording materials, the image-forming layer is formed using an organic solvent such as toluene, methyl ethyl ketone, or methanol. It is not advantageous to use an organic solvent since the organic solvent may cause harmful effects on humans during the production process of the recording materials, and since it is costly to recover the solvent and to conduct other related processes.

In order to solve such problems, a method has been proposed in which a water-based coating liquid is used for forming an image-forming layer (hereinafter sometimes referred to as a “water-based photosensitive layer.” For example, techniques of using gelatin as a binder are disclosed in Japanese Patent Application Laid-Open (JP-A) Nos. 49-52626 and 53-116144. Further, a technique of using polyvinyl alcohol as a binder is disclosed in JP-A No. 50-151138.

However, these techniques exhibit a large quantity of fogging and poor color tone of a formed image, and thus the techniques have not reached a practical level. On the other hand, a technique for using a polymer as a binder and using an aqueous medium to form an image-forming layer is disclosed in JP-A Nos. 10-10669 and 10-62899. The technique can manufacture a photothermographic material which has good fogging and image color tone and is preferable in view of environmental preservation, safety, cost and the like.

Improvement in processing brittleness and dark heat image storability (fogging during storage) of the photothermographic material by using a polymer latex having specific physical properties as the binder have been (for example, refer to JP-A No. 2002-303953). It has been shown that low Dmin and high Dmax can be obtained by using a specific polymer latex as the binder of the image-forming layer and protective layer (for example, refer to JP-A No. 11-84573).

However, all components such as components for image formation and additives for preventing fogging and improving storability are added into a coating liquid, and the pH also fluctuates greatly. Since association and aggregation are caused under such conditions when the polymer latex is used as the binder, conventionally, a hydrophilic polymer having water solubility such as polyvinyl alcohol or gelatin has generally been mixed with polymer latex and used.

### SUMMARY OF THE INVENTION

The present invention has been accomplished so as to solve the above problems. The invention provides a photothermographic material having high image quality and improved heat developing environmental dependability.

In accordance with a first aspect of the invention, there is provided a photothermographic material comprising: a support and, on at least one surface of the support, an image-forming layer containing at least a photosensitive silver halide, a non-photosensitive organic silver salt, a reducing agent and a binder, and at least a non-photosensitive layer; wherein the image forming layer and/or the non-photosensitive layer contains a polymer latex dispersed and stabilized with a water-soluble polymer protective colloid during polymerization.

In accordance with a second aspect of the invention, there is provided the photothermographic material as described in the first aspect, wherein the amount of the polymer latex is 50 mass % or more based on the amount of the binder in the image-forming layer.

In accordance with a third aspect of the invention, there is provided the photothermographic material as described in the first aspect, wherein the amount of the polymer latex is 50 mass % or more based on the amount of a binder in the non-photosensitive layer.

In accordance with a fourth aspect of the invention, there is provided the photothermographic material as described in the first aspect, wherein the amount of the polymer latex in the image-forming layer is 50 mass % or more based on the amount of the binder in the image-forming layer, and the amount of the polymer latex in the non-photosensitive layer is 50 mass % or more based on the amount of the binder in the non-photosensitive layer.

In accordance with a fifth aspect of the invention, there is provided the photothermographic material as described in any one of the first to fourth aspects, wherein the water-soluble polymer protective colloid is at least one polymer selected from the group consisting of vinyl alcohol based polymers including polyvinyl alcohol and derivatives thereof, gelatin or a derivative thereof; a polyacrylic acid or a polymethacrylic acid and salts of these acids; a poly vinyl alkyl ether; copolymers of vinyl acetate and acrylic acid, methacrylic acid or maleic anhydride, and saponified compounds of these copolymers; copolymers of lower alkyl vinyl ether and maleic anhydride; cellulose derivatives including alkylcellulose, hydroxyl alkylcellulose, alkylhydroxyl alkylcellulose and carboxymethyl cellulose; starch derivatives including an alkyl starch, a carboxymethyl starch and an oxidized starch; gum arabic or gum tragacanth; and a polyalkylene glycol.

In accordance with a sixth aspect of the invention, there is provided the photothermographic material as described in the fifth aspect, wherein the water-soluble polymer protective colloid is at least one polymer selected from the group consisting of vinyl alcohol based polymers including polyvinyl alcohol and derivatives thereof.

In accordance with a seventh aspect of the invention, there is provided the photothermographic material as described in the fifth aspect, wherein the water-soluble polymer protective colloid is gelatin or a derivative thereof.

In accordance with an eighth aspect of the invention, there is provided the photothermographic material as described in any one of the first to seventh aspects, wherein the polymer latex is a (co) polymer comprising, as a main component, at least one kind of monomer unit selected from the group consisting of a (meth) acrylic ester monomer unit, a styrenic monomer unit and a diene monomer unit.

In accordance with a ninth aspect of the invention, there is provided the photothermographic material as described in the eighth aspect, wherein the polymer latex is a polymer latex obtained by copolymerizing 10 mass % to 70 mass % of a monomer unit represented by the following formula (M).
CH₂═CR⁰¹—CR⁰²═CH₂
wherein R⁰¹ and R⁰² are each independently a group selected from a hydrogen atom, an alkyl group having 1 to 6 carbon atoms, a halogen atom or a cyano group.

In accordance with a tenth aspect of the invention, there is provided the photothermographic material as described in the ninth aspect, wherein one of R⁰¹ and R⁰² in the formula (M) is a hydrogen atom, and the other is a methyl group.

In accordance with an eleventh aspect of the invention, there is provided the photothermographic material as described in the eighth aspect, wherein the polymer latex is a polymer latex obtained by copolymerizing 20 mass % to 80 mass % of the (meth) acrylic ester monomer unit.

### DETAILED DESCRIPTION OF THE INVENTION

Hereinafter, the present invention will be described in detail. The photothermographic material of the invention comprises: a support and, on at least one surface of the support, an image-forming layer containing at least a photosensitive silver halide, a non-photosensitive organic silver salt, a reducing agent and a binder and at least a non-photosensitive layer, wherein the image forming layer and/or the non-photosensitive layer contains a polymer latex dispersed and stabilized with a water-soluble polymer protective colloid during polymerization.

The amount of the polymer latex is preferably 50 mass % or more based on one of the amount of a binder in the image-forming layer and the amount of a binder of the non-photosensitive layer, and more preferably 50 mass % or more based on the amount of the binder in the image-forming layer. The polymer latex is more preferably contained in an amount of 50 mass % or more based on the amount of the binder in the image-forming layer and 50 mass % or more based on the amount of the binder in the non-photosensitive layer.

It is preferable that the water-soluble polymer protective colloid is at least one polymer selected from the group consisting of vinyl alcohol polymer based polymers including polyvinyl alcohol and derivatives thereof, gelatin or a derivative thereof, a polyacrylic acid or a polymethacrylic acid and salts of these acids; a poly vinyl alkyl ether; copolymers of vinyl acetate and acrylic acid, methacrylic acid or maleic anhydride, and saponified compounds of these copolymers; copolymers of a lower alkyl vinyl ether and maleic anhydride; cellulose derivatives including alkylcellulose, hydroxyl alkylcellulose, alkylhydroxyl alkylcellulose and carboxymethyl cellulose; starch derivatives including an alkyl starch, a carboxymethyl starch and an oxidized starch; gum arabic or gum tragacanth; and a polyalkylene glycol. It is more preferable that the water-soluble polymer protective colloid is at least one polymer selected from the group consisting of vinyl alcohol based polymers including polyvinyl alcohol and derivatives thereof.

It is preferable that the polymer latex is a (co) polymer comprising, as a main component, at least one kind of monomer unit selected from the group consisting of a (meth) acrylic ester monomer unit, a styrenic monomer unit and a diene monomer unit. It is preferable that the polymer latex is a polymer latex obtained by copolymerizing 10 mass % to 70 mass % of a monomer unit represented by the following formula (M).
CH₂═CR⁰¹—CR⁰²═CH₂
wherein, R⁰¹ and R⁰² are each independently a group selected from a hydrogen atom, an alkyl group having 1 to 6 carbon atoms, a halogen atom or a cyano group. It is preferable that one of R⁰¹ and R⁰² in the formula (M) is a hydrogen atom, and the other is a methyl group. The other preferable polymer latex is a polymer latex obtained by copolymerizing 20 mass % to 80 mass % of the (meth) acrylic ester monomer unit.
(Polymer Latex Dispersed and Stabilized with Water-Soluble Polymer Protective Colloid)

The polymer latex dispersed and stabilized with the water-soluble polymer protective colloid is a polymer latex obtained by copolymerizing 10 mass % to 70 mass % of a monomer unit selected from monomers which comprise, as a main component, at least one monomer selected from the group consisting of diene monomers, (meth) acrylic ester monomers and styrene monomers, or mixtures thereof (hereinafter, both may be merely referred to as mixture collectively).

(Monomer Components)

Examples of the diene monomer include 1,3-butadiene, 2-methyl-1,3-butadiene, 2,3-dimethyl-1,3-butadiene, 2-chloro-1,3-butadiene and 1,3-pentadiene.

Examples of the (meth) acrylic ester monomer include acrylic ester and methacrylic ester. Specific examples thereof include methyl acrylate, ethyl acrylate, butyl acrylate, 2-ethyl hexyl acrylate, dodecyl acrylate, methyl methacrylate, ethyl methacrylate, butyl methacrylate, 2-ethylhexyl methacrylate, dodecyl methacrylate, β-hydroxyethyl acrylate, β-hydroxyethyl methacrylate, hydroxypropyl acrylate, hydroxypropyl methacrylate, hydroxybutyl acrylate, hydroxybutyl methacrylate, dimethylaminoethyl acrylate, dimethylaminoethyl methacrylate and quaternized compounds of these esters, and ethylene glycol dimethacrylate.

Examples of the styrene monomers include styrene, α-methyl styrene, vinyltoluene, p-styrenesulfonic acid, and sodium salt and potassium salt thereof.

The other examples of the monomers capable of being copolymerized with the monomer used as the main components include a halogenated vinyl monomer and a carboxylic vinyl ester monomer. These monomers can be usually used in a range of less than 50% based on the total content of the monomers within a range that does not harm the purpose and effect of the invention.

The latex polymer in the invention is preferably a copolymer of at least styrene monomer/a monomer represented by the formula (M)/a vinyl monomer having an acidic group.
CH₂═CR⁰¹—CR⁰²═CH₂ Formula (M)
wherein, R⁰¹ and R⁰² are each independently represent a group selected from a hydrogen atom, an alkyl group having 1 to 6 carbon atoms, a halogen atom, or a cyano group. More preferably, R⁰¹ and R⁰² are each independently a hydrogen atom, or one of R⁰¹ and R⁰² is a hydrogen atom and the other is a methyl group.

The alkyl group in R⁰¹ and R⁰² preferably has 1 to 4 carbon atoms and more preferably 1 to 2 carbon atoms. The halogen atom in R⁰¹ and R⁰² is preferably a fluorine, chlorine, or bromine atom, and more preferably a chlorine atom.

Preferably, each of R⁰¹ and R⁰² is a hydrogen atom, or one of R⁰¹ and R⁰² is a hydrogen atom and the other is a methyl group or a chlorine atom. More preferably, each of R⁰¹ and R⁰² is a hydrogen atom, or one of R⁰¹ and R⁰² is a hydrogen atom and the other is a methyl group.

Specific examples of the monomer represented by the formula (M) include 2-ethyl-1,3-butadiene, 2-n-propyl-1,3-butadiene, 2,3-dimethyl-1,3-butadiene, 2-methyl-1,3-butadiene, 2-chloro-1,3-butadiene, 1-bromo-1,3-butadiene, 2-fluoro-1,3-butadiene, 2,3-dichloro-1,3-butadiene, and 2-cyano-1,3-butadiene.

Copolymerization ratio of the monomer represented by the formula (M) in the invention is 10 mass % to 70 mass %, preferably 15 mass % to 65 mass %, and more preferably 20 mass % to 60 mass %. When the copolymerization ratio of the monomer represented by the formula (M) is less than 10 mass %, the amount of fusible component in the binder reduces, whereby processing fragility deteriorates.

On the other hand, when the copolymerization ratio of the monomer exceeds 70 mass %, the amount of fusible component in the binder increases, and the mobility of the binder increases. Therefore, image storability deteriorates.

The acidic group is preferably carboxylic acid, sulfonic acid, or phosphoric acid, and more preferably carboxylic acid. The copolymerization ratio of the acidic group is preferably 1 to 20 mass %, and more preferably 1 to 10 mass %. Specific examples of monomers having the acidic group include acrylic acid, methacrylic acid, itaconic acid, sodium p-styrenesulfonate, isoprenesulfonic acid, and phosphorylethyl methacrylate, and more preferably, acrylic acid or methacrylic acid, and still more preferably acrylic acid.

The glass transition temperature (Tg) of the polymer latex in the invention is preferably in the range of −30° C. to 70° C., more preferably −10° C. to 50° C., and still more preferably 0° C. to 40° C. from the viewpoints of film forming property and image storability. Two or more polymers can be used in combination as a binder. In an embodiment, the average Tg obtained by summing up the Tg of each polymer weighted by its proportion is preferably within the range specified above. Also, In the case of phase separation or a core-shell structure, the weighted average Tg is preferably within the range specified above.

The glass transition temperature (Tg) can be calculated by the following equation:
1/Tg=Σ(Xi/Tgi)

In the equation, it is assumed that the polymer is comprised of n monomer which are designated by “monomer i” (i=1 to n). Xi represents the mass fraction of the monomer i (ΣXi=1), and Tgi represents the glass transition temperature (absolute temperature) of a homopolymer of the monomer i. Σ(Xi/Tgi) is the sum of Xi/Tgi for i=1 to n. The glass transition temperature (Tgi) of the homopolymer of each monomer is a value described in J. Brandrup and E. H. Immergut, Polymer Handbook, 3rd edition (Wiley-Interscience, 1989).

<Water-Soluble Polymer Protective Colloid>

Examples of water-soluble polymers for forming the water-soluble polymer protective colloid to be used in the invention include vinyl alcohol polymers such as polyvinyl alcohol and modified products thereof; gelatin or a derivative thereof; a polyacrylic acid or a polymethacrylic acid and salts of these acids; a poly vinyl alkyl ether; copolymers of a vinyl acetate and acrylic acid, methacrylic acid or maleic anhydride, and saponified compounds of these copolymers; copolymers of lower alkyl vinyl ether and maleic anhydride; cellulose derivatives such as alkyl cellulose, hydroxylalkyl cellulose, alkylhydroxylalkyl cellulose and carboxymethyl cellulose; starch derivatives such as an alkyl starch, a carboxymethyl starch and an oxidized starch; gum arabic or tragacanth gum; and polyalkylene glycol.

The water-soluble polymer is preferably vinyl alcohol polymers such as polyvinyl alcohol and modified products thereof, or gelatin or a derivative thereof, and more preferably vinyl alcohol polymers.

The vinyl alcohol polymers are not limited as long as they are substantially water soluble and provide a stable emulsion. The vinyl alcohol polymers can be obtained by saponifying conventionally vinyl ester polymers that prepared by polymerizing a vinyl monomer (homopolymer of vinyl ester monomer, copolymers of two or more vinyl ester monomers and copolymers of vinyl ester monomer and other ethylenically unsaturated monomer) consisting mainly of a vinyl ester monomer. Preferably, one obtained by introducing a modifying group such as a mercapto group into a main chain, side chain or end of a molecule can be used.

The vinyl ester monomers are not limited as long as they are capable of radical polymerization. Specific examples thereof include vinyl formate, vinyl acetate, vinyl propionate, isopropenyl acetate, vinyl valerate, vinyl caprate, vinyl laurate, vinyl stearate, vinyl benzoate, vinyl versatate and vinyl pivalate. Among them, vinyl acetate is generally used, since it is industrially manufactured and inexpensive.

Also, monomers copolymerizable with the vinyl ester monomer can be coexisted and copolymerized. Examples of the coplymerizable monomers include olefins such as ethylene, propylene, 1-butene and isobutene; an unsaturated carboxylic acid such as acrylic acid, methacrylic acid, fumaric acid, maleic acid, itaconic acid, maleic anhydride, phthalic anhydride, trimellitic anhydride or itaconic anhydride; acrylic esters such as methyl acrylate, ethyl acrylate, n-propyl acrylate, i-propyl acrylate, n-butyl acrylate, t-butyl acrylate, 2-ethyl hexyl acrylate, dodecyl acrylate and octadecyl acrylate; methacrylic esters such as methyl methacrylate, ethyl methacrylate, n-propyl methacrylate, i-propyl methacrylate, n-butyl methacrylate, t-butyl methacrylate, 2-ethyl hexyl methacrylate, dodecyl methacrylate and octadecyl methacrylate; unsaturated carboxylic esters such as dimethyl fumarate, diethyl maleate and diisopropyl itaconate; vinyl ethers such as methyl vinyl ether, n-propyl vinyl ether, i-propyl vinyl ether, n-butyl vinyl ether, i-butyl vinyl ether, t-butyl vinyl ether, dodecyl vinyl ether and stearyl vinyl ether; nitriles such as acrylonitrile and methacrylonitrile; halogenated vinyls such as vinyl chloride, vinylidene chloride, vinyl fluoride and vinylidene fluoride; allyl compounds such as allyl acetate and allyl chloride; sulfonic group-containing compounds such as ethylene sulfonic acid, allylsulfoic acid, metaallylsulfonic acid and 2-acryl amide-2-methylpropane sulfonic acid; vinylsilane compounds such as vinyl trimethoxysilane; and monomers having a quaternary ammonium group such as 3-acrylamidopropyltrimethyl ammonium chloride and 3-methacrylamidopropyltrimethyl ammonium chloride.

Since a saponification degree of the vinyl ester polymer varies and depends on the existence and kind of a modifying group. However, the saponification degree is preferably 40 mol % to 99.99 mol %, more preferably 50 mol % to 99.9 mol %, and still more preferably 60 mol % to 99.5 mol % in terms of water solubility or the like of the vinyl alcohol polymer obtained. When the saponification degree is less than 40 mol %, the dispersion stability of particles reduce.

A viscosity-average polymerization degree of the vinyl ester polymer is required to be 50 to 8000, preferably 100 to 6000, and more preferably 100 to 5000. When the polymerization degree is less than 50, polymerization stability is insufficient. When the polymerization degree exceeds 8000, it leads to a very high viscosity of emulsions, resulting in problem in that it is difficult to remove the heat during production of the emulsions.

As the gelatin or the derivative thereof, the various gelatins or derivatives thereof, which are conventionally used for photographs such as gelatin produced by lime processing, gelatin produced by acid process, gelatin produced by enzyme processing and gelatin modified with a phthalic acid, trimellitic acid or the like can be used.

(Synthesizing Method)

The polymer latex in the invention can be easily synthesized by a solution polymerization method, a suspension polymerization method, an emulsion polymerization method, a dispersion polymerization method, an anionic polymerization method, a cationic polymerization method, or the like. Among them, an emulsion polymerization method is preferably from the viewpoint in that the polymer is obtained as a latex. In the emulsion polymerization, for example, a system including water or a mixed solvent of water and a water-miscible organic solvent (such as methanol, ethanol, or acetone) is used as a dispersion medium, a monomer mixture is used in an amount of 5 mass % to 150 mass % based on the amount of the dispersion medium, and an emulsifier and a polymerization initiator are used based on the total content of the monomer. The emulsion polymerization is carried out for 3 to 24 hours at a temperature of about 30° C. to about 100° C., preferably 60° C. to 90° C., the system is being stirred. Various conditions such as the type of the dispersion medium, the monomer concentration, the amount of the initiator, the amount of the emulsifier, the amount of the dispersion medium, reaction temperature, and an addition method of the monomer are suitably determined depending on the type of the monomers to be used. Furthermore, it is preferable to use a dispersant as necessary.

The polymer latex of the invention is prepared as follows:

A polymerization initiator is first decomposed in an aqueous medium (i.e., water or a mixture of water or water soluble solvent that is used in combination if desired) to generate radicals, to which the monomer and the water-soluble polymer protective colloid are added, and polymerized. The monomer and the water-soluble polymer protective colloid may be added separately, or may be added in a form of the monomeric emulsified product obtained by mixing the monomer, the water-soluble polymer protective colloid and water. When the monomer and the water-soluble polymer protective colloid are separately added, it is preferable to start simultaneously the addition of both the monomer and the water-soluble polymer protective colloid. When only monomer is added first in large quantity, the agglomeration is easily generated. When only the water-soluble polymer protective colloid is added first in large quantity, the polymerization system is thickened, or the agglomeration is easily generated. Although the addition of both the monomer and the water-soluble polymer protective colloid is not necessarily completed simultaneously, the addition is preferably completed simultaneously. The monomer and the water-soluble polymer protective colloid can be continuously or intermittently added.

The amount of the water-soluble polymer protective colloid is 0.01 to 100 parts by mass per 100 parts by mass of the monomer, preferably 0.05 to 50 parts by mass, and more preferably 1 to 10 parts by mass. When the amount is less than 0.01 parts by mass, there are problems in that stability during polymerization is poor and the large quantity of agglomeration is generated, resulting in lowering of mechanical stability and chemical stability of the emulsion obtained and film strength. On the other hand, the amount exceeds more than 100 parts by mass, there are problems in that it is difficult to remove the reaction heat due to the viscosity rise in the polymerization system, the viscosity of the emulsion obtained is too high to handle the emulsion, and water resistance of the film formed from the emulsion is reduced.

The polymerization initiator may be any one of polymerization initiators having radical generating ability. The polymerization initiator may be selected from inorganic peroxides such as persulfates and hydrogen peroxide, peroxides described in the organic peroxide catalogue of NOF Corporation, and azo compounds described in the azo polymerization initiator catalogue of Wako Pure Chemical Industries, Ltd. The polymerization initiator is preferably a water-soluble peroxide such as persulfate or a water-soluble azo compound described in the azo polymerization initiator catalogue of Wako Pure Chemical Industries, Ltd., and more preferably, ammonium persulfate, sodium persulfate, potassium persulfate, azo-bis(2-methylpropionamidine) hydrochloride, azo-bis-(2-methyl-N-(2-hydroxyethyl)propionamide), or azobiscyanovaleric acid, and still more preferably, peroxide such as ammonium persulfate, sodium persulfate, and potassium persulfate from the viewpoints of image storability, solubility and cost.

The amount of the polymerization initiator to be added is, based on the total amount of monomers, preferably 0.3 mass % to 2.0 mass %, more preferably 0.4 mass % to 1.75 mass %, and still more preferably 0.5 mass % to 1.5 mass %. When the amount of the polymerization initiator is less than 0.3 mass %, image storability deteriorates. Meanwhile, when it exceeds 2.0 mass %, the latex particles easily aggregate, thereby lowering coating property.

The polymerization emulsifier may be selected from anionic surfactants, nonionic surfactants, cationic surfactants, and amphoteric surfactants. Among them, the polymerization emulsifier is preferably an anionic surfactant from the viewpoints of dispersibility and image storability. The polymerization emulsifier is more preferably a sulfonic acid anionic surfactant because polymerization stability can be ensured even when used in a small amount and the surfactant has resistance to hydrolysis. The polymerization emulsifier is still more preferably a long chain alkyldiphenyl ether disulfonate (whose typical examples include PELEX SS-H manufactured by Kao Corporation), and most preferably a low electrolyte types such as PIONIN A-43-S (manufactured by Takemoto Oil & Fat Co., Ltd.).

The amount of a sulfonic acid anionic surfactant serving as the polymerization emulsifier is preferably 0.1 mass % to 10.0 mass %, more preferably 0.2 mass % to 7.5 mass %, and still more preferably 0.3 mass % to 5.0 mass %, based on the total amount of monomers. When the amount of the polymerization emulsifier is less than 0.1 mass %, stability at the time of emulsion polymerization cannot be ensured. When it exceeds 10.0 mass %, image storability deteriorates.

It is preferable to use a chelating agent in synthesizing the polymer latex to be used in the invention. The chelating agent is a compound capable of coordinating (chelating) a polyvalent ion such as a metal ion (for example, an iron ion) or an alkaline earth metal ion (for example, a calcium ion). The chelating agent may be selected from compounds described in Japanese Patent Publication (JP-B) No. 6-8956, U.S. Pat. No. 5,053,322, and JP-A Nos. 4-73645, 4-127145, 4-247073, 4-305572, 6-11805, 5-173312, 5-66527, 5-158195, 6-118580, 6-110168, 6-161054, 6-175299, 6-214352, 7-114161, 7-114154, 7-120894, 7-199433, 7-306504, 9-43792, 8-314090, 10-182571, 10-182570 and 11-190892.

The amount of the chelating agent to be added is preferably 0.01 mass % to 0.4 mass %, more preferably 0.02 mass % to 0.3 mass %, and still more preferably 0.03 mass % to 0.15 mass %, based on the total amount of monomers. When the addition amount of the chelating agent is less than 0.01 mass %, metal ion contaminations during the preparation of the polymer latex are not sufficiently trapped, and the stability of the latex against aggregation deteriorates, whereby the coating property becomes worse. When it exceeds 0.4 mass %, the viscosity of the latex increases, whereby the coating property deteriorates.

In a synthesis of the polymer latex to be used in the invention, it is preferable to use a chain transfer agent. By controlling the addition amount of the chain transfer agent, it is possible to control the gelling rate. The chain transfer agent is preferably one described in Polymer Handbook (3rd Edition) (Wiley-Interscience, 1989). The chain transfer agent is more preferably a sulfur compound, because the compound has a high chain transfer ability and because the required amount is small. The chain transfer agent is particularly preferably a hydrophobic mercaptane chain transfer agent such as tert-dodecylmercaptane or n-dodecyl-mercaptane.

The amount of the chain transfer agent to be added is preferably 0.2 mass % to 2.0 mass %, more preferably 0.3 mass % to 1.8 mass %, and still more preferably 0.4 mass % to 1.6 mass %, based on the total amount of monomers.

Besides the foregoing compounds, other additives such as an electrolyte, a stabilizer, a thickener, an antifoaming agent, an antioxidant, a vulcanizing agent, an antifreezing agent, a gelling agent, and a vulcanization accelerator in the emulsion polymerization may be used, which are described in, for example, Synthetic Rubber Handbook.

<Specific Example of Polymer Latex>

The preferable polymer latexes are exemplified specifically by the following compounds (P-1) to (P-29), but the invention is not limited thereto. The specific examples of the polymer latex are expressed by monomers which are used as raw materials. In the compounds (P-1) to (P-29), x, y, z, z′ in the chemical formula show the mass ratio of polymer compositions, and the total of x, y, z, and z′ is set to 100%. In the compounds (P-31) to (P-42), the numerical value in a parenthesis is mass %, and the molecular weight is a number average molecular weight. When a polyfunctional monomer is used, the concept of a molecular weight can not be applied because of forming a crosslinked structure, and therefore, in this case, a cross-linking property is described, and the description of the molecular weight is omitted. Tg is the glass transition temperature of a dried film obtained from the polymer.

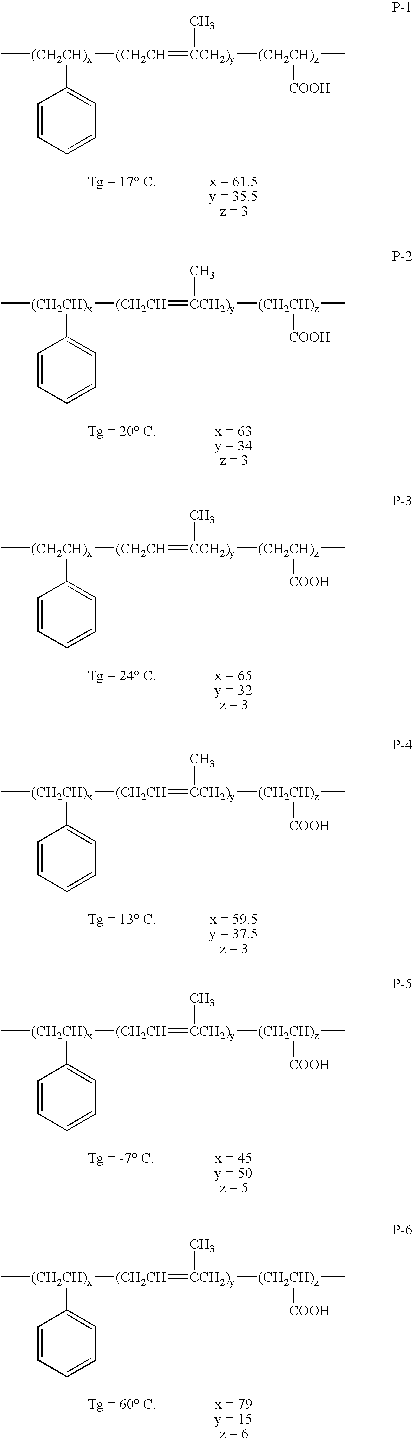

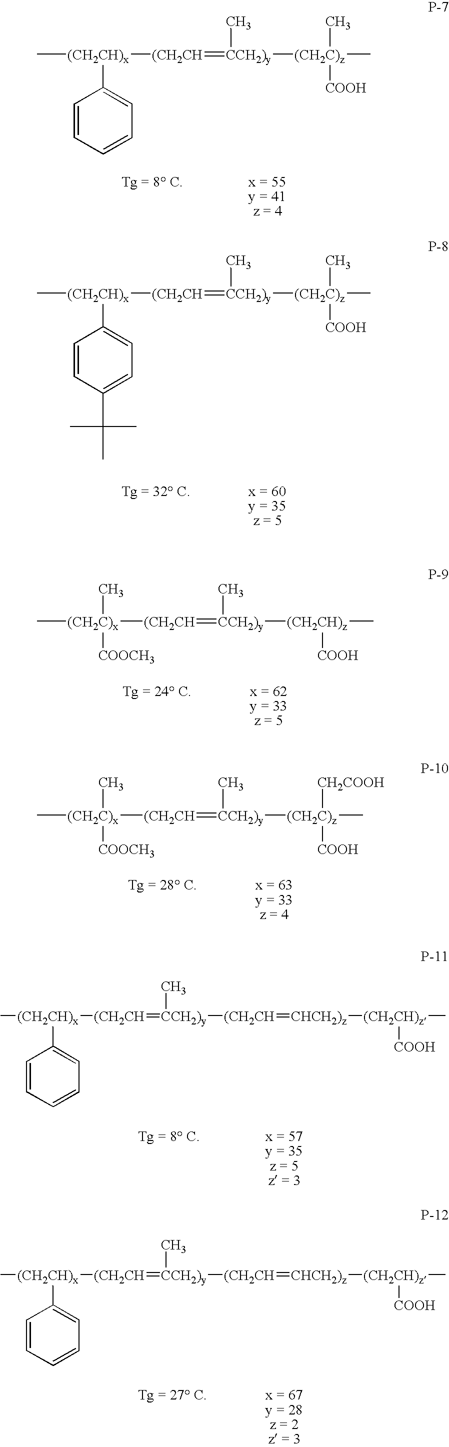

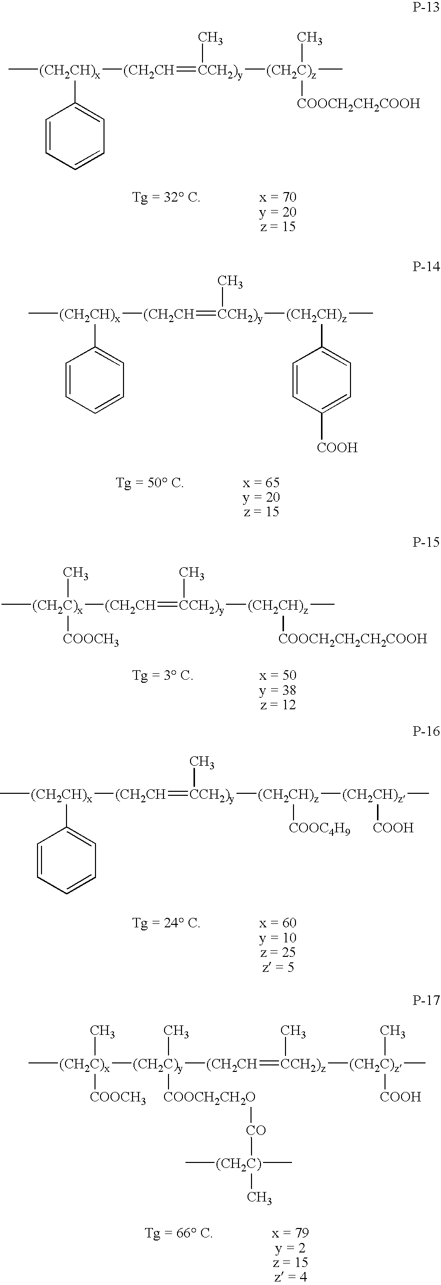

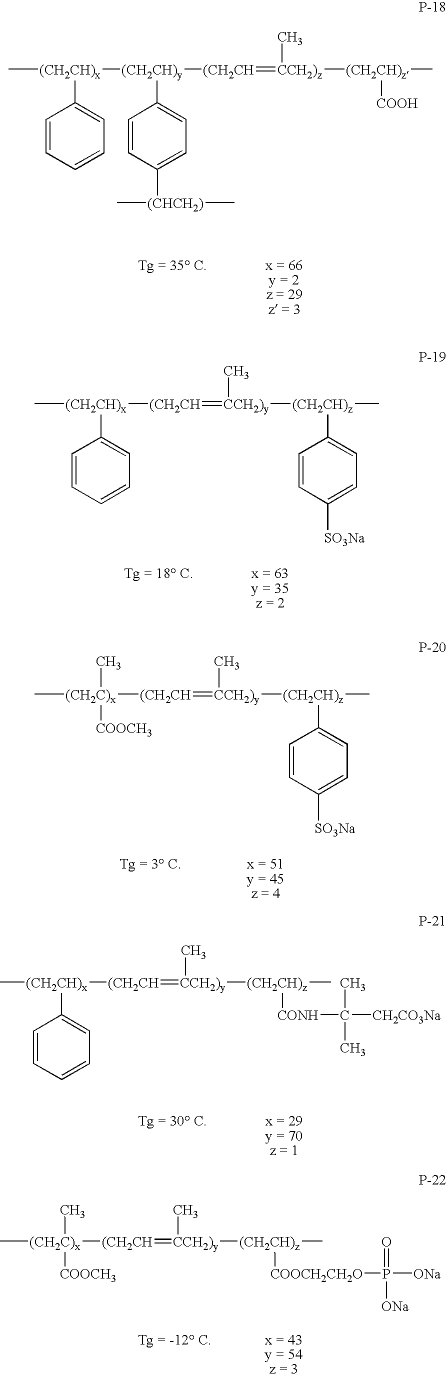

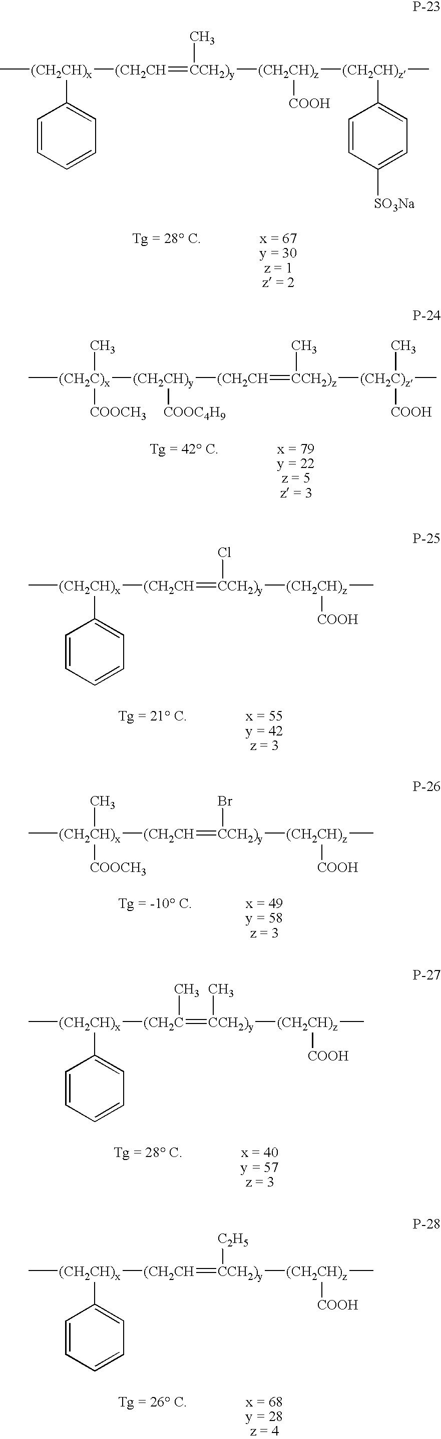

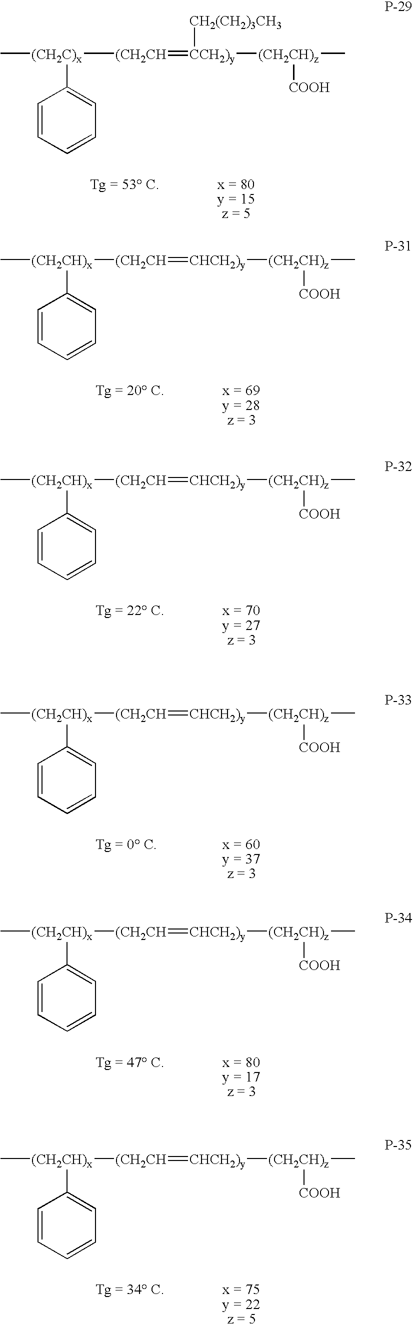

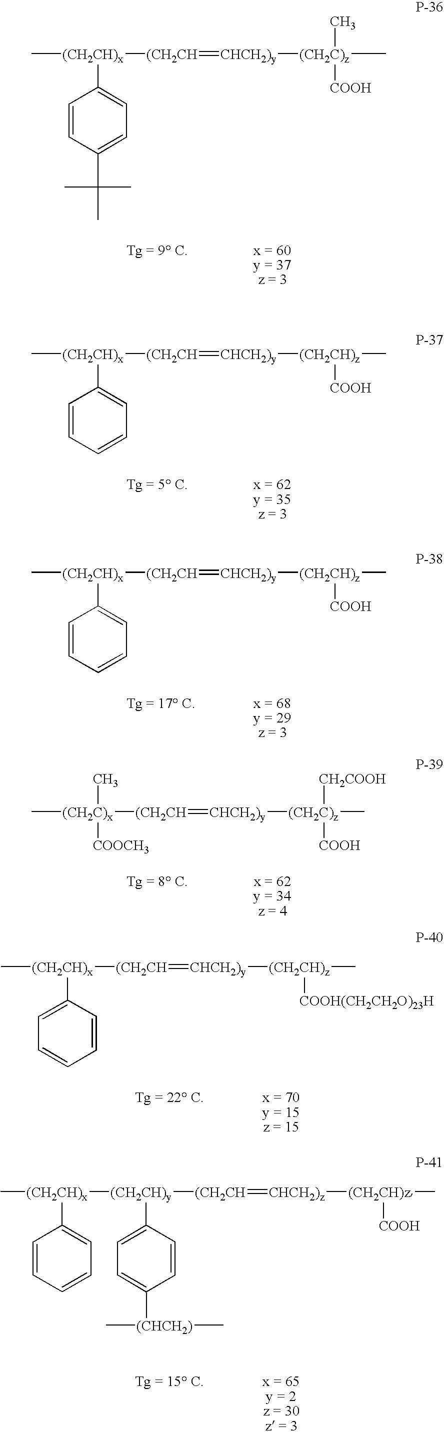

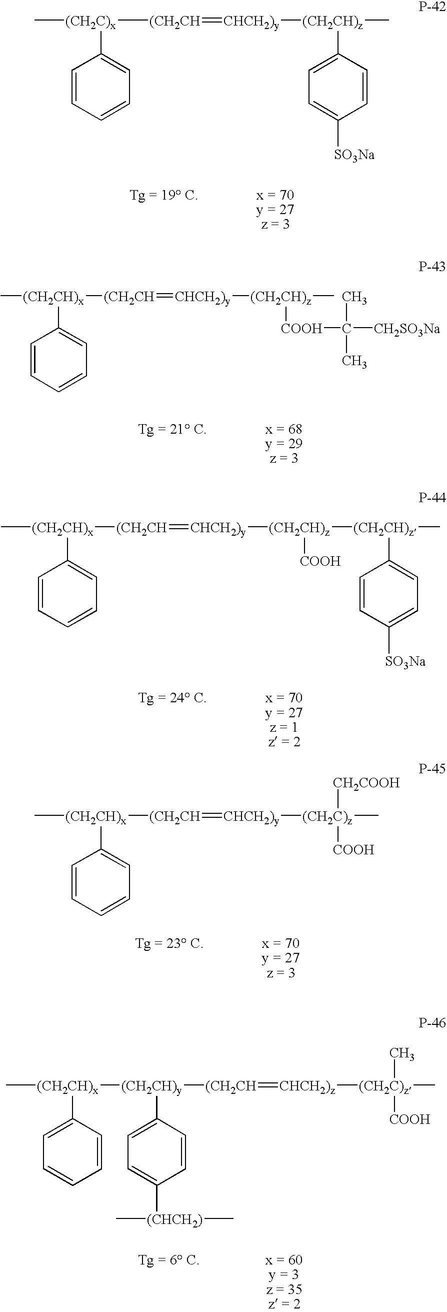

One of these polymer latexes may be used alone, or two or more of them may be used together, as needed.

The coating liquid containing the polymer latex to be used in the invention may contain an aqueous solvent, and may further contain a water-miscible organic solvent. Examples of the water-miscible organic solvent include alcohols (for example, methyl alcohol, ethyl alcohol, and propyl alcohol), cellosolves (for example, methyl cellosolve, ethyl cellosolve, and butyl cellosolve), ethyl acetate, and dimethylformamide. The amount of the organic solvent to be added is preferably 50 % or less, and more preferably, 30 % or less based on the total amount of the solvents in the coating liquid.

Furthermore, in the polymer latex to be used in the invention, the polymer concentration is, based on the amount of the latex liquid, preferably 10 mass % to 70 mass %, more preferably 20 mass % to 60 mass %, and still more preferably 30 mass % to 55 mass %.

The polymer latex in the invention preferably has an equilibrium moisture content of 2 mass % or less at 25° C. and 60 % RH. The equilibrium moisture content is more preferably 0.01 mass % to 1.5 mass %, and still more preferably 0.02 mass % to 1.0 mass %.

The average size of the latex particles in the invention is in the range of 1 nm to 50,000 nm, preferably 5 nm to 1,000 nm, more preferably 10 nm to 500 nm, and still more preferably 50 nm to 200 nm. The particle size distribution of the dispersed particles is not limited, and the dispersed particles may have a broad distribution or a monodispersed particle size distribution. From the viewpoint of controlling the physical properties of a coating liquid, two or more types of particles each having a monodispersed particle distribution are preferably mixed and used.

It is preferable that the polymer latex of the invention has the amount of generating coagulation of 0.1% or less in marlon stability test referring to the mechanical stability at pH 8, and more preferably a ratio (referred to as mechanical stability index) of the amount of generating coagulation at pH 2±0.5 to the amount of generating coagulation at pH 8±0.1 is 5 or less. Thus, it is preferable that polymer latex has excellent mechanical stability in a low pH region.

(Other Components)

The image-forming layer of the invention may comprise a hydrophilic polymer such as gelatin, polyvinyl alcohol, methyl cellulose, hydroxypropyl cellulose, or carboxymethyl cellulose, if necessary. The amount of the hydrophilic polymer to be added is generally 30 mass % or less, and preferably 20 mass % or less based on the total content of the binder(s) contained in the image-forming layer.

The mass ratio of the total of the binders to the photosensitive silver halide in the image-forming layer is within the range of 400 to 5, and more preferably 200 to 10. The total amount of the binders in the image-forming layer is preferably within the range of 0.2 g/m² to 30 g/m², more preferably 1 g/m² to 15 g/m², and still more preferably 2 g/m² to 10 g/m². A cross-linking agent, a surfactant for improving coating ability, or the like may be added to the image-forming layer.

(Organic Silver Salt)

1) Composition

The organic silver salt which can be used in the invention is relatively stable to light, but when heated to a temperature of 80° C. or higher in the presence of an exposed photosensitive silver halide and a reducing agent, the silver salt serves as a silver ion source and forms a silver image. The organic silver salt may be any organic materials which can supply silver ions reducible by the reducing agent. Such a non-photosensitive organic silver salt is described in, for example, JP-A No. 10-62899 (paragraph 0048 to 0049), EP No. 0803764A1 (page 18, line 24 to page 19, line 37), EP No. 0962812A1, and JP-A Nos. 11-349591, 2000-7683, and 2000-72711. The organic silver salt is preferably the silver salt of an organic acid, particularly the silver salt of a long-chain aliphatic carboxylic acid (having 10 to 30 carbon atoms, and preferably having 15 to 28 carbon atoms). Typical examples of a fatty acid silver salt include silver lignocerate, silver behenate, silver arachidate, silver stearate, silver oleate, silver laurate, silver caproate, silver myristate, silver palmitate, and silver erucate, and mixtures thereof In the invention, it is preferred to use the fatty acid silver salt of which a silver behenate content is 50 to 100 mol %, more preferably 85-100 mol %, and still more preferably 95-100 mol % among these fatty acid silver salts. Further, it is preferred to use the fatty acid silver salt of which a silver erucate content is 2 mol % or less, more preferably 1 mol % or less, and still more preferably 0.1 mol % or less.

The content of silver stearate in the organic silver salt is preferably 1 mol % or less. When the content of silver stearate is 1 mol % or less, the silver salt of an organic acid having low Dmin, high sensitivity and excellent image storability can be obtained. The content of silver stearate in the organic silver salt is more preferably 0.5 mol % or less, and is still more preferably, silver stearate is not contained substantially.

When silver arachidate is contained as the silver salt of an organic acid, the content of silver arachidate is preferably 6 mol % or less in order to obtain a silver salt of organic acid having low Dmin and excellent image storability. The content of silver arachidate is more preferably 3 mol % or less.

2) Shape

The shape of the organic silver salt usable in the invention is not limited and the organic silver salt may have a needle-like, rod-like, tabular or flaky shape.

However, the organic silver salt particles preferably have a flaky shape in the invention. Also, short needle-like, rectangular parallelepiped, cuboidal, or potato-like, indefinitely shaped particles with a ratio of the major axis length to the minor axis length of less than 5 are preferably as the organic silver salt. Such organic silver particles have a lower level of fogging during thermal development than that of long needle-like particles with a ratio of the major axis length to the minor axis length of 5 or more. In particular, the organic silver salt particles more preferably have a ratio of the major axis length to the minor axis length of 3 or less, since such particles can improve the mechanical stability of a coated film. In this specification, the flaky organic silver salt particles are defined as follows. When an organic acid silver salt particle is observed under an electron microscope, and the shape of the organic acid silver salt particle is approximated to a rectangular parallelepiped with sides having lengths of a, b and c in ascending order (the length c may be equal to the length b), a value of x is calculated from the shortest length a and the next shortest length b as follows.
x=b/a

When the values x of about 200 particles are calculated in the above manner and averaged, and the average satisfies the relation of x (average)≧1.5, particles having such an average value x are regarded as flaky. The flaky particles preferably satisfy the relation of 30≧x (average)≧1.5, and more preferably satisfy the relation of 15≧x (average)≧1.5. Needle-like particles satisfy the relation of 1≦x (average)≦1.5.

In the flaky particles, the length a corresponds to the thickness of a tabular particle having, as a principal plane, a plane with sides having lengths b and c. The average of lengths a is preferably 0.01 μm to 0.3 μm, and more preferably 0.1 μm to 0.23 μm. The average of the ratios of the lengths c to the lengths b is preferably 1 to 9, more preferably 1 to 6, still more preferably 1 to 4, and most preferably 1 to 3.

The diameter corresponding to sphere maintains within the range of from 0.05 to 1 μm, and it is difficult to cause coagulation in the photothermographic material and provides satisfactory image storability. The diameter corresponding to sphere is preferably 0.1 to 1 μm. In the invention, the diameter corresponding to sphere can be determined by directly taking a photograph of a sample by an electron microscope and then executing image processing of the resultant negative film.

In the aforementioned flaky particles, the ratio of diameter corresponding to sphere /a of each particle is defined as an aspect ratio. The aspect ratio of the flaky particles is preferably within the range of 1.1 to 30 and more preferably within the range of 1.1 to 15 from the viewpoints in that it is difficult to cause coagulation in the photothermographic material and it improves image storability.

The particle size distribution of the organic silver salt particles is preferably monodispersed. The term “monodispersed” means that the percentage of a value obtained by dividing the standard deviations of the lengths of the minor axis and the major axis of each particle by the minor axis and the major axis is preferably 100% or less, more preferably 80% or less and still more preferably 50% or less. The shapes of the organic silver salt particles can be determined from a transmission electron microscopic image of an organic silver salt dispersion. Another method to determine whether the organic silver salt particles are monodispersed can be made as follows. The standard deviation of the volume-weighted average diameter of the organic silver salt particles is obtained, and the percentage (variation factor) of a value obtained by dividing the standard deviation by the volume-weighted average diameter is preferably 100% or less, more preferably 80% or less and still more preferably 50% or less. The volume-weighted average diameter can be obtained by irradiating the organic silver salt dispersed in liquid with laser beam and determining the self-correlation function of the fluctuation of the scattered light over time.

3) Preparation

Methods known in the art may be applied to a method for producing the organic silver salt used in the invention and to a dispersing method thereof For example, reference can be made to JP-A No. 10-62899, EP Nos. 0803763A1 and 0962812A1, JP-A Nos. 11-349591, 2000-7683, 2000-72711, 2001-163889, 2001-163890, 2001-163827, 2001-33907, 2001-188313, 2001-83652, 2002-6442, 2002-49117, 2002-31870, and 2002-107868.

When a photosensitive silver salt is present together with the organic silver salt during dispersion of the organic silver salt, the level of fogging increases and sensitivity becomes remarkably lower. Therefore, it is preferred that the photosensitive silver salt is not substantially contained in the system including the organic silver salt during dispersion. In the invention, the amount of the photosensitive silver salt in an aqueous dispersion in which the organic silver salt is to be dispersed is preferably 1 mol % or less, more preferably 0.1 mol % or less per mol of the organic acid silver salt in the dispersion. It is even more preferable that positive addition of the photosensitive silver salt is not conducted.

In the invention, the aqueous dispersion of the organic silver salt and that of the photosensitive silver salt can be mixed in producing the photothermographic material, and the mixing ratio of the photosensitive silver salt to the organic silver salt can be selected depending on purpose. The ratio of the photosensitive silver salt to the organic silver salt is preferably in the range of 1 mol % to 30 mol %, more preferably in the range of 2 mol % to 20 mol %, and still more preferably in the range of 3 mol % to 15 mol %. Mixing two or more kinds of the aqueous dispersions of organic silver salts and two or more kinds of the aqueous dispersions of photosensitive silver salts is preferable to control photographic properties.

4) Addition Amount

The organic silver salt usable in the invention may be used in a desired amount, but the total amount of silver including silver halide contained in the organic silver salt is preferably 0.1 to 5.0 g/m², more preferably 0.3 to 3.0 g/m², and still more preferably 0.5 to 2.0 g/m². In particular, to improve image storability, the total coating amount of the silver is preferably 1.8 g/m² or less and more preferably 1.6 g/m² or less. Use of a reducing agent preferably used in the invention allows sufficiently high image density even at such a low silver amount.

(Reducing Agent)

The photothermographic material of the invention preferably includes a thermal developing agent which is a reducing agent for the organic silver salt. The reducing agent for the organic silver salt can be any materials (preferably organic material) capable of reducing a silver ion to metal silver. Examples of such a reducing agent are described in JP-A No. 11-65021, paragraph 0043-0045 and EP No. 0803764A1, page 7, line 34 to page 18, line 12.

The reducing agent used in the invention is preferably a bisphenol reducing agent or a so-called hindered phenol reducing agent having a substituent in an ortho-position with respect to the phenolic hydroxyl group, and is more preferably a compound represented by the following formula (R).

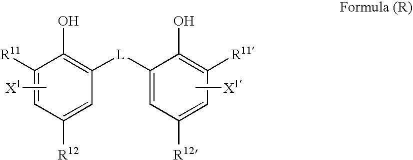

In the formula (R), R¹¹ and R¹¹′ each independently represent an alkyl group having 1 to 20 carbon atoms. R¹² and R¹²′ each independently represent a hydrogen atom or a substituent which can bond to the benzene ring. L represents an —S— or —CHR¹³— group. R¹³ represents a hydrogen atom or an alkyl group having 1 to 20 carbon atoms. X₁ and X₁′ each independently represent a hydrogen atom or a group which can bond to the benzene ring.

Detailed explanations on the formula (R) will be given in the following.

Hereinafter, alkyl groups include cycloalkyl groups, unless otherwise indicated.

1) R¹¹ and R^{11′}

R¹¹ and R^{11′} each independently represent a substituted or unsubstituted alkyl group having 1 to 20 carbon atoms. The type of the substituent in the substituted alkyl group is not particularly limited, but the substituent is preferably an aryl group, a hydroxyl group, an alkoxy group, an aryloxy group, an alkylthio group, an arylthio group, an acylamino group, a sulfonamide group, a sulfonyl group, a phosphoryl group, an acyl group, a carbamoyl group, an ester group, an ureido group, an urethane group or a halogen atom.

2) R¹² and R¹²′, and X₁ and X₁′

R¹² and R¹²′ each independently represent a hydrogen atom or a substituent which can bond to the benzene ring, and X₁ and X₁′ independently represent a hydrogen atom or a group which can bond to the benzene ring. Typical examples of the group which can bond to the benzene ring include alkyl groups, aryl groups, halogen atoms, alkoxy groups, and acylamino groups.

3) L

L represents an —S— or —CHR¹³— group. R¹³ represents a hydrogen atom or a substituted or unsubstituted alkyl group having 1 to 20 carbon atoms. When R¹³ is an unsubstituted alkyl group, typical examples thereof include methyl, ethyl, propyl, butyl, heptyl, undecyl, isopropyl, 1-ethylpentyl, 2,4,4-trimethylpentyl, cyclohexyl, 2,4-dimethyl-3-cyclohexenyl, and 3,5-dimethyl-3-cyclohexenyl groups. The substituents of the substituted alkyl group are the same as those for R¹¹, and examples thereof include halogen atoms, alkoxy groups, aklylthio groups, aryloxy groups, arylthio groups, acylamino groups, sulfonamide groups, sulfonyl groups, phosphoryl groups, oxycarbonyl groups, carbamoyl groups, and sulfamoyl groups.

4) Preferable Substituent

Each of R¹¹ and R¹¹′ is preferably a primary, secondary or tertiary alkyl group having 1 to 15 carbon atoms, and specific examples thereof include methyl, isopropyl, t-butyl, t-amyl, t-octyl, cyclohexyl, cyclopentyl, 1-methylcyclohexyl, and 1-methylcyclopropyl groups. Each of R¹¹ and R¹¹′ is more preferably an alkyl group having 1 to 4 carbon atoms. Among them, each of R¹¹ and R¹¹′ is more preferably a methyl, t-butyl, t-amyl, or 1-methylcyclohexyl group, and is most preferably a methyl or t-butyl group.

Each of R¹² and R¹²′ is preferably an alkyl group having 1 to 20 carbon atoms, and specific examples thereof include methyl, ethyl, propyl, butyl, isopropyl, t-butyl, t-amyl, cyclohexyl, 1-methylcyclohexyl, benzyl, methoxymethyl, and methoxyethyl groups. Each of R¹² and R¹²′ is more preferably a methyl, ethyl, propyl, isopropyl, or t-butyl group, and is most preferably a methyl or ethyl group.

Each of X₁ and X₁′ is preferably a hydrogen or halogen atom, or an alkyl group, and more preferably a hydrogen atom.

L is preferably a —CHR¹³— group.

R¹³ is preferably a hydrogen atom or an alkyl group having 1 to 15 carbon atoms, and a chained alkyl group or a cyclic alkyl group is preferably used as the alkyl group. In addition, an alkyl group having a C═C bond may also be used preferably. Typical examples of the alkyl group include methyl, ethyl, propyl, isopropyl, 2,4,4-trimethylpentyl, cyclohexyl, 2,4-dimethyl-3-cyclohexenyl, and 3,5-dimethyl-3-cyclohexenyl groups. R¹³ is particularly preferably a hydrogen atom or a methyl, ethyl, propyl, isopropyl, or 2,4-dimethyl-3-cyclohexenyl group.

When R¹¹ and R¹¹′ are tertiary alkyl groups and R¹² and R¹²′ are methyl groups, R¹³ is preferably a primary or secondary alkyl group having 1 to 8 carbon atoms such as a methyl, ethyl, propyl, isopropyl, or 2,4-dimethyl-3-cyclohexenyl group.

When R¹¹ and R¹¹′ are tertiary alkyl groups and R¹² and R¹²′ are alkyl groups other than a methyl group, R¹³ is preferably a hydrogen atom.

When R¹¹ and R¹¹′ are not tertiary alkyl groups, R¹³ is preferably a hydrogen atom or a secondary alkyl group, and more preferably a secondary alkyl group. The secondary alkyl group in R¹³is preferably an isopropyl or 2,4-dimethyl-3-cyclohexenyl group.

In the reducing agent, thermal developability, and the silvery tone of developed images vary depending on the combination of R¹¹, R¹¹′, R¹², R¹²′ and R¹³. Two or more of the reducing agents are preferably used together depending on application, because the above properties can be controlled by a proper combination of two or more reducing agents.

Specific examples of the reducing agent used in the invention, including the compounds represented by the formula (R) are shown below, but the invention is not limited by such examples.

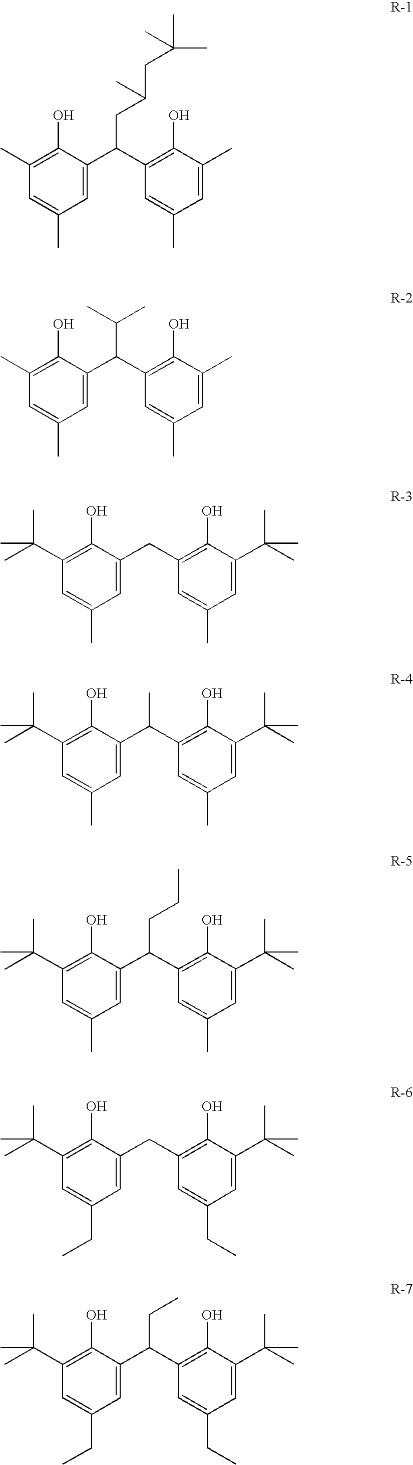

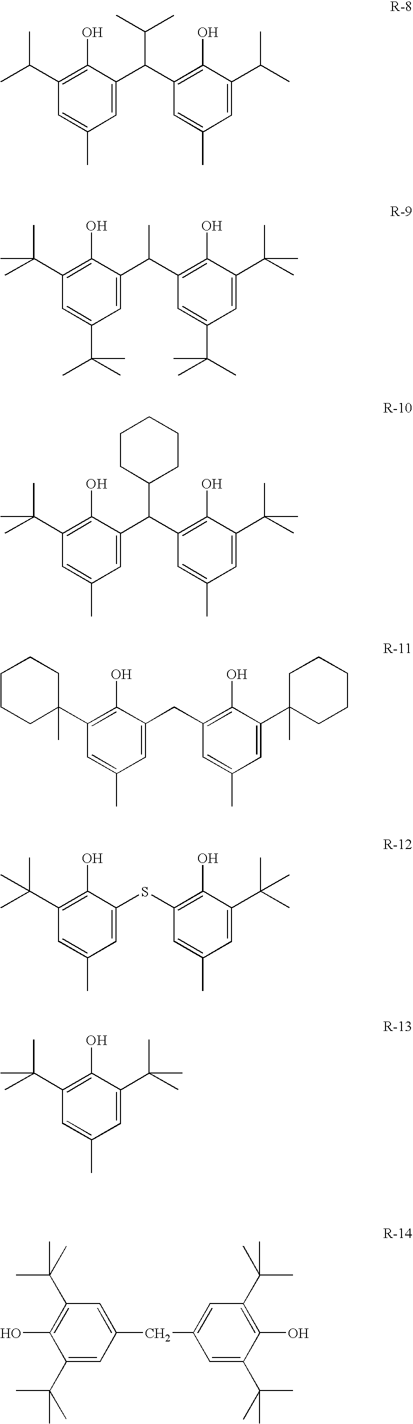

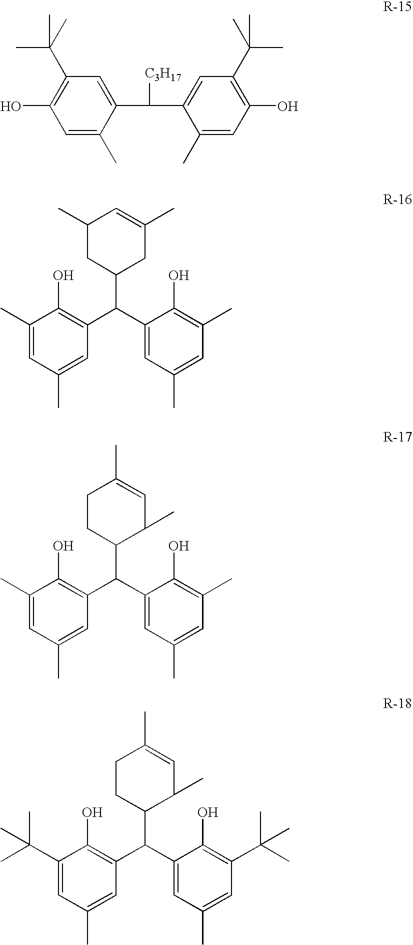

In addition, preferable reducing agents are described in JP-A Nos. 2001-188314, 2001-209145, 2001-350235, and 2002-156727, and EP No. 1278101A2.

The amount of the reducing agent added is preferably 0.1 to 3.0 g/m², more preferably 0.2 to 2.0 g/m², and still more preferably 0.3 to 1.0 g/m². Further, the mol ratio of the reducing agent to silver on the image forming layer side is preferably 5 to 50 mol %, more preferably 8 to 30 mol %, and still more preferably 10 to 20 mol %. The reducing agent is preferably contained in the image-forming layer.

The reducing agent in a coating liquid may be in the form of a solution, emulsion, or solid particle dispersion.

The emulsion of the reducing agent may be prepared by a well-known emulsifying method. The examplary method comprises: dissolving the reducing agent in an oil such as dibutyl phthalate, tricresyl phosphate, dioctyl sebacate or tri(2-ethylhexyl) phosphate, optionally using a cosolvent such as ethyl acetate or cyclohaxanone; and then mechanically emulsifying the reducing agent in the presence of a surfactant such as sodium dodecylbenzenesulfonate, sodium oleoyl-N-methyltaurinate, or sodium di(2-ethylhexyl)sulfosuccinate. In this method, it is preferable to add a polymer such as α-methylstyrene oligomer or poly(t-butylacrylamide) to the emulsion in order to control the viscosity and the refractive index of oil droplets.

In an embodiment, the solid particle dispersion is prepared by a method comprising dispersing powder of the reducing agent in an appropriate solvent such as water using a ball mill, a colloid mill, a vibration ball mill, a sand mill, a jet mill, a roller mill, or ultrasonic waves. A protective colloid such as polyvinyl alcohol, and/or a surfactant (for example, an anionic surfactant such as sodium triisopropylnaphthalenesulfonate (a mixture of compounds each having the isopropyl groups in different substitution sites) may be used in the preparation. Beads of zirconia, or the like are commonly used as a dispersing medium in the above mills, and in some cases, zirconium, or the like is eluted from the beads and may contaminate the dispersion. The amount of zirconium contaminations in the dispersion depends on the dispersion conditions, and is generally in the range of 1 ppm to 1000 ppm. The eluted zirconia do not cause practical problems as long as the amount of Zr contaminations in the photothermographic material is 0.5 mg or less per 1 g of silver.

The aqueous dispersion preferably contains an antiseptic agent such as a benzoisothiazolinone sodium salt.

The reducing agent is particularly preferably used in the state of a solid particle dispersion. The reducing agent is preferably added in the form of fine particles having an average particle size of 0.01 μm to 10 μm, preferably 0.05 μm to 5 μm, and still more preferably 0.1 μm to 2 μm. In the invention, the particle sizes of particles in other solid dispersions are preferably in the above range.

(Development Accelerator)

The photothermographic material of the invention preferably comprises a development accelerator, and typical examples thereof include sulfonamidophenol compounds represented by the formula (A) described in JP-A Nos. 2000-267222 and 2000-330234; hindered phenol compounds represented by the formula (II) described in JP-A No. 2001-92075; hydrazine compounds represented by the formula (I) described in JP-A Nos. 10-62895 and 11-15116; hydrazine compounds represented by the formula (D) described in JP-A No. 2002-156727; hydrazine represented by the formula (1) described in JP-A No. 2002-278017; and phenol and naphthol compounds represented by the formula (2) described in JP-A No. 2001-264929; phenol compounds described in JP-A Nos. 2002-311533 and 2002-341484; and naphthol compounds described in JP-A No. 2003-66558. Naphthol compounds described in JP-A No. 2003-66558 are preferable.

The mol ratio of the development accelerator to the reducing agent is 0.1 to 20 mol %, preferably 0.5 to 10 mol %, and more preferably 1 to 5 mol %.

The development accelerator may be added to the photothermographic material in any of the manners described above as examples of the method of adding the reducing agent. The development accelerator is particularly preferably added in the form of a solid dispersion or an emulsion. The emulsion of the development accelerator is preferably a dispersion prepared by emulsifying the development accelerator in a high-boiling solvent that is solid at room temperature and a low-boiling cosolvent, or as a so-called oilless emulsion which includes no high-boiling solvents.

In the invention, the hydrazine compounds described in JP-A No. 2002-156727 or 2002-278017, and the naphthol compounds described in JP-A No. 2003-66558 are more preferable development accelerators.

In the invention, the development accelerator is particularly preferably a compound represented by the following the formula (A-1) or (A-2).
Q₁-NHNH-Q₂ Formula (A-1)

In the formula (A-1), Q₁ represents an aromatic group or a heterocyclic group each of which has a carbon atom bonded to the —NHNH-Q₂ group. Q₂ represents a carbamoyl, acyl, alkoxycarbonyl, aryloxycarbonyl, sulfonyl, or sulfamoyl group.

In the formula (A-1), the aromatic group or the heterocyclic group represented by Q₁ preferably has a five- to seven-membered unsaturated ring. Typical examples of the five- to seven-membered unsaturated ring include benzene, pyridine, pyrazine, pyrimidine, pyridazine, 1,2,4-triazine, 1,3,5-triazine, pyrrole, imidazole, pyrazole, 1,2,3-triazole, 1,2,4-triazole, tetrazole, 1,3,4-thiadiazole, 1,2,4-thiadiazole, 1,2,5-thiadiazole, 1,3,4-oxadiazole, 1,2,4-oxadiazole, 1,2,5-oxadiazole, thiazole, oxazole, isothiazole, isoxazole and thiophene rings, and condensed rings of these groups.

The ring may have one or more substituents. When the ring has two or more substituents, these substituents may be the same as each other or different from each other. Examples of the substituents include halogen atoms, and alkyl, aryl, carbonamide, alkylsulfonamide, arylsulfonamide, alkoxy, aryloxy, aklylthio, arylthio, carbamoyl, sulfamoyl, cyano, alkylsulfonyl, arylsulfonyl, alkoxycarbonyl, aryloxycarbonyl, and acyl groups. These substituents may further have substituents, and preferred examples thereof include halogen atoms, and alkyl, aryl, carbonamide, alkylsulfonamide, arylsulfonamide, alkoxy, aryloxy, aklylthio, arylthio, acyl, alkoxycarbonyl, aryloxycarbonyl, carbamoyl, cyano, sulfamoyl, alkylsulfonyl, arylsulfonyl, and acyloxy groups.

When Q₂ represents a carbamoyl group, the carbamoyl group preferably has 1 to 50 carbon atoms, and more preferably has 6 to 40 carbon atoms. Example of the carbamoyl group include unsubstituted carbamoyl, methylcarbamoyl, N-ethylcarbamoyl, N-propylcarbamoyl, N-sec-butylcarbamoyl, N-octylcarbamoyl, N-cyclohexylcarbamoyl, N-tert-butylcarbamoyl, N-dodecylcarbamoyl, N-(3-dodecyloxypropyl)carbamoyl, N-octadecylcarbamoyl, N-{3-(2,4-tert-pentylphenoxy)propyl}carbamoyl, N-(2-hexyldecyl)carbamoyl, N-phenylcarbamoyl, N-(4-dodecyloxyphenyl)carbamoyl, N-(2-chloro-5-dodecyloxycarbonylphenyl)carbamoyl, N-naphthylcarbamoyl, N-3-pyridylcarbamoyl, and N-benzylcarbamoyl.

When Q₂ represents an acyl group, the acyl group preferably has 1 to 50 carbon atoms, and more preferably has 6 to 40 carbon atoms. Examples of the acyl group include formyl, acetyl, 2-methylpropanoyl, cyclohexylcarbonyl, octanoyl, 2-hexyldecanoyl, dodecanoyl, chloroacetyl, trifluoroacetyl, benzoyl, 4-dodecyloxybenzoyl, and 2-hydroxymethylbenzoyl.

When Q₂ represents an alkoxycarbonyl group, the alkoxycarbonyl group preferably has 2 to 50 carbon atoms, and more preferably 6 to 40 carbon atoms. Examples of the alkoxycarbonyl group include methoxycarbonyl, ethoxycarbonyl, isobutyloxycarbonyl, cyclohexyloxycarbonyl, dodecyloxycarbonyl, and benzyloxycarbonyl.

When Q₂ represents an aryloxycarbonyl group, the aryloxycarbonyl group preferably has 7 to 50 carbon atoms, and more preferably 7 to 40 carbon atoms. Examples of the aryloxycarbonyl group include phenoxycarbonyl, 4-octyloxyphenoxycarbonyl, 2-hydroxymethylphenoxycarbonyl, and 4-dodecyloxyphenoxycarbonyl.

When Q₂ represents a sulfonyl group, the sulfonyl group preferably has 1 to 50 carbon atoms, and more preferably 6 to 40 carbon atoms. Examples of the sulfonyl group include methylsulfonyl, butylsulfonyl, octylsulfonyl, 2-hexadecylsulfonyl, 3-dodecyloxypropylsulfonyl, 2-octyloxy-5-tert-octylphenylsulfonyl, and 4-dodecyloxyphenyl sulfonyl.

When Q₂ represents a sulfamoyl group, the sulfamoyl group preferably has 0 to 50 carbon atoms, and more preferably 6 to 40 carbon atoms. Examples of the sulfamoyl group include unsubstituted sulfamoyl, N-ethylsulfamoyl, N-(2-ethylhexyl)sulfamoyl, N-decylsulfamoyl, N-hexadecylsulfamoyl, N-{3-(2-ethylhexyloxy)propyl}sulfamoyl, N-(2-chloro-5-dodecyloxycarbonylphenyl)sulfamoyl, and N-(2-tetradecyloxyphenyl)sulfamoyl.

The group represented by Q₂ may have a substituent selected from the groups described above as examples of the substituent on the five- to seven-membered unsaturated ring of Q₁. When the group represented by Q₂ has two or more substituents, these substituents may be the same as each other or different from each other.

The group represented by Q₁ preferably has a five-membered or six-membered unsaturated ring, and more preferably a benzene, pyrimidine, 1,2,3-triazole, 1,2,4-triazole, tetrazole, 1,3,4-thiadiazole, 1,2,4-thiadiazole, 1,3,4-oxadiazole, 1,2,4-oxadiazole, thiazole, oxazole, isothiazole, or isoxazole ring, or a condensed ring in which any of the above rings is fused with a benzene ring or an unsaturated heterocyclic ring. Q₂ is preferably a carbamoyl group, particularly preferably a carbamoyl group having a hydrogen atom on the nitrogen atom.

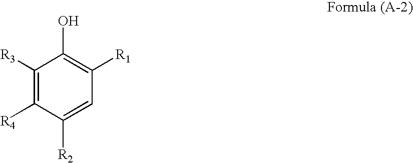

In the formula (A-2), R₁ represents an alkyl, acyl, acylamino, sulfonamide, alkoxycarbonyl, or carbamoyl group. R₂ represents a hydrogen or halogen atom, or an alkyl, alkoxy, aryloxy, aklylthio, arylthio, acyloxy, or carbonic acid ester group. R₃ and R₄ each independently represent a substituent which can be bonded to the benzene ring, which may be selected from the substituents described above in the explanation on the formula (A-1). R₃ and R₄ may bind to each other to form a fused ring.

R₁ is preferably an alkyl group having 1 to 20 carbon atoms (e.g., a methyl, ethyl, isopropyl, butyl, tert-octyl, or cyclohexyl group), an acylamino group (e.g., an acetylamino, benzoylamino, methylureido, or 4-cyanophenylureido group), or a carbamoyl group (e.g., a n-butylcarbamoyl, N,N-diethylcarbamoyl, phenylcarbamoyl, 2-chlorophenylcarbamoyl, or 2,4-dichlorophenylcarbamoyl group). R₁ is more preferably an acylamino group, which may be a ureido group or a urethane group. R₂ is preferably a halogen atom (more preferably, a chlorine or bromine atom), an alkoxy group (e.g., a methoxy, butoxy, n-hexyloxy, n-decyloxy, cyclohexyloxy, or benzyloxy group), or an aryloxy group (e.g., a phenoxy or naphthoxy group).

R₃ is preferably a hydrogen atom or a halogen atom, or an alkyl group having 1 to 20 carbon atoms, and more preferably a halogen atom. R₄ is preferably a hydrogen atom, an alkyl group, or an acylamino group, and more preferably an alkyl or acylamino group. Preferred examples of the groups represented by R₃ or R₄ are the same as the above mentioned examples of the groups represented by R₁. When R₄ is an acylamino group, R₄ and R₃ may be bound to each other to form a carbostyryl ring.

When R₃ and R₄ combine with each other to form a condensed ring in the formula (A-2), the condensed ring is preferably a naphthalene ring. The naphthalene ring may have one or more substituents selected from the above-mentioned examples of the substituents on the ring of Q₁ in the formula (A-1). When the compound represented by the formula (A-2) is a naphthol based compound, R₁ is preferably a carbamoyl group, more preferably a benzoyl group. R₂ is preferably an alkoxy or aryloxy group, and more preferably an alkoxy group.

Typical examples of the development accelerator in the invention are shown below, but the invention is not restricted by these examples. 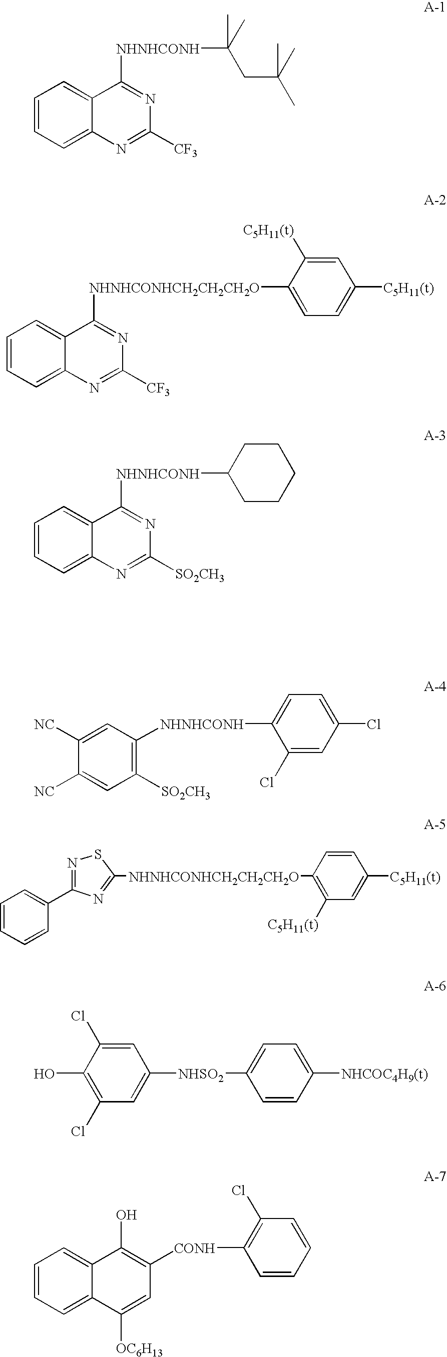 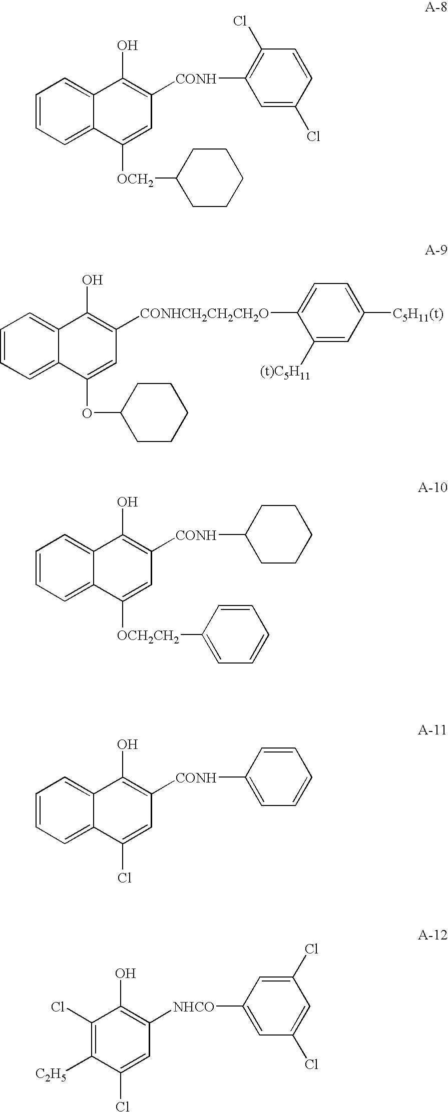
(Hydrogen-Bonding Compound)

When the reducing agent in the invention has an aromatic hydroxyl (—OH) or amino group (—NHR group, wherein R is a hydrogen atom or an alkyl group), especially when the reducing agent is the above-mentioned bisphenol compound, it is preferable to use a non-reducible compound having a group capable of forming a hydrogen bond with the hydroxyl or amino group.

Examples of the group capable of forming a hydrogen bond with the hydroxyl or amino group include phosphoryl, sulfoxide, sulfonyl, carbonyl, amido, ester, urethane, ureido group, tertiary amino, and nitrogen-containing aromatic groups. The group capable of forming a hydrogen bond with the hydroxyl or amino group is preferably a phosphoryl group, a sulfoxide group, an amido group having no >N—H groups, but the nitrogen atom being blocked as >N—Ra (wherein Ra represents a substituent other than H), an urethane group having no >N—H groups, but the nitrogen atom being blocked as >N—Ra (wherein Ra represents a substituent other than H), or an ureido group having no >N—H groups, but the nitrogen atom being blocked as >N—Ra (wherein Ra represents a substituent other than H).

The hydrogen-bonding compound in the invention is particularly preferably a compound represented by the following formula (D).

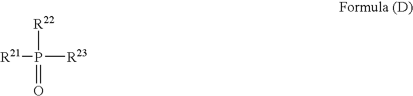

In the formula (D), R²¹ to R²³ each independently represent an alkyl, aryl, alkoxy, aryloxy, amino or heterocyclic group, and these groups may be unsubstituted or substituted.

When any of R²¹ to R²³ has a substituent, examples of the substituent include halogen atoms, and alkyl, aryl, alkoxy, amino, acyl, acylamino, alkylthio, arylthio, sulfonamide, acyloxy, oxycarbonyl, carbamoyl, sulfamoyl, sulfonyl, and phosphoryl groups. Preferred substituents are preferably an alkyl or aryl group, and specific examples thereof include methyl, ethyl, isopropyl, t-butyl, t-octyl, phenyl, 4-alkoxyphenyl, and 4-acyloxyphenyl groups.

When any of R²¹ to R²³ represent an alkyl group, examples thereof include methyl, ethyl, butyl, octyl, dodecyl, isopropyl, t-butyl, t-amyl, t-octyl, cyclohexyl, 1-methylcyclohexyl, benzyl, phenethyl, and 2-phenoxypropyl groups.

When any of R²¹ to R²³ represent an aryl group, examples thereof include phenyl, cresyl, xylyl, naphthyl, 4-t-butylphenyl, 4-t-octylphenyl, 4-anisidyl, and 3,5-dichlorophenyl groups.

When any of R²¹ to R²³ represent an alkoxy group, examples thereof include methoxy, ethoxy, butoxy, octyloxy, 2-ethylhexyloxy, 3,5,5-trimethylhexyloxy, dodecyloxy, cyclohexyloxy, 4-methylcyclohexyloxy, and benzyloxy groups.

When any of R²¹ to R²³ represent an aryloxy group, examples thereof include phenoxy, cresyloxy, isopropylphenoxy, 4-t-butylphenoxy, naphthoxy, and biphenyloxy groups.

When any of R²¹ to R²³ represent an amino group, examples thereof include dimethylamino, diethylamino, dibutylamino, dioctylamino, N-methyl-N-hexylamino, dicyclohexylamino, diphenylamino, and N-methyl-N-phenylamino groups.

R²¹ to R²³ are each independently preferably an alkyl, aryl, alkoxy, or aryloxy group. From the viewpoint of the effects of the invention, at least one of R²¹ to R²³ is preferably an alkyl or aryl group. More preferably, two or more of R²¹ to R²³ are an alkyl or aryl group. From the viewpoint of reducing the cost, it is preferable to use a compound represented by the formula D in which R²¹ to R²³ are preferably the same groups.

Specific examples of the hydrogen-bonding compound (such as a compound represented by the formula (D)) are shown below, but the invention is not limited thereto.

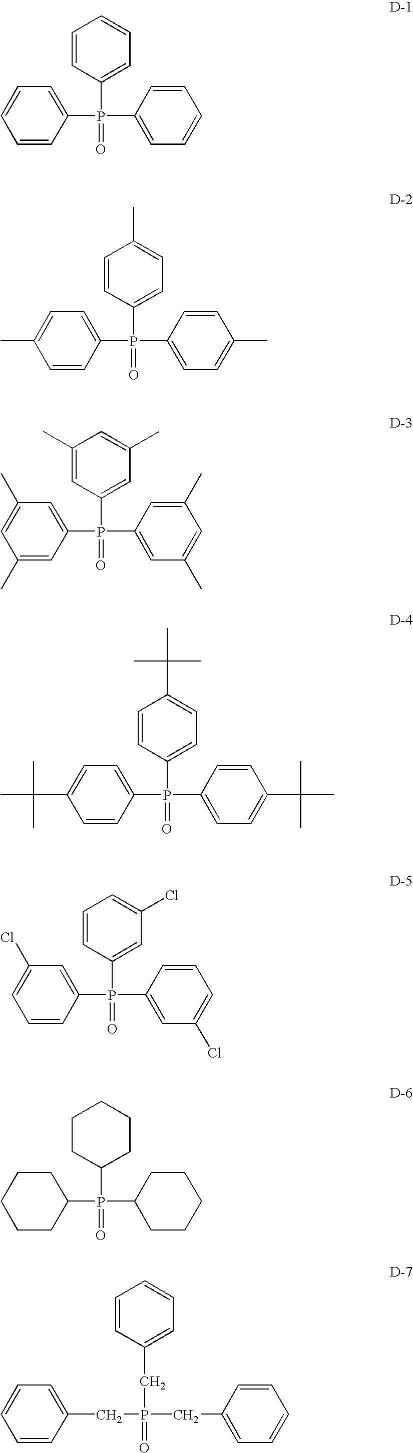

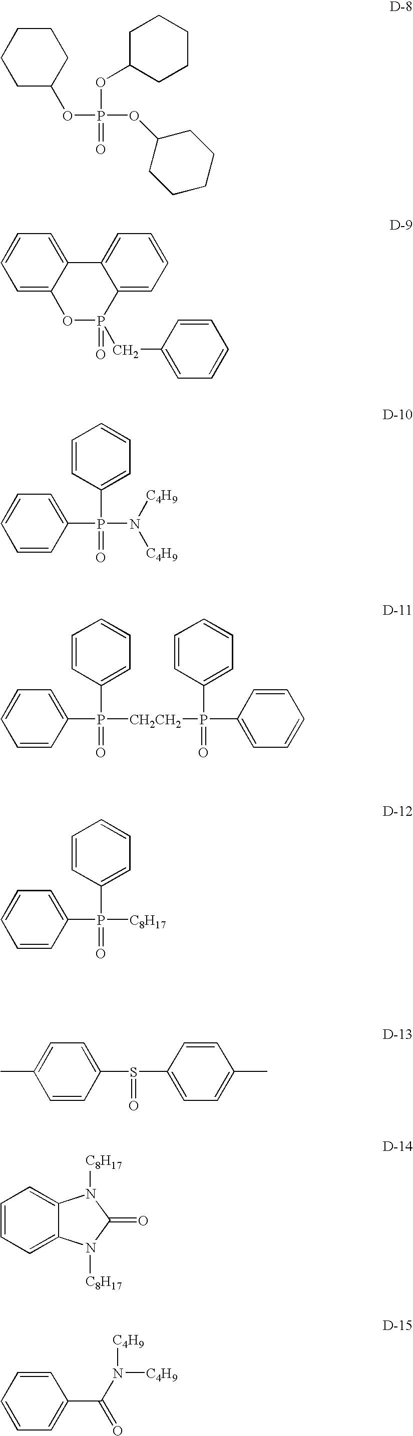

Specific examples of the hydrogen-bonding compound further include those described in EP No. 1096310 and JP-A Nos. 2002-156727 and 2002-318431.

The compound represented by the formula (D) may be added to a coating liquid and used in the photothermographic material in the form of a solution, an emulsion, or a solid particle dispersion. The specific manner of producing the solution, emulsion, or solid particle dispersion may be the same as in the case of the reducing agent. The compound is preferably used in the form of a solid dispersion. The compound of the formula (D) forms a hydrogen-bonding complex with the reducing agent having a phenolic hydroxyl group or an amino group in the solution. The complex can be isolated as a crystal depending on the combination of the reducing agent and the compound of the formula (D).

It is particularly preferred to use the powder of the isolated crystal to form a solid particle dispersion, from the viewpoint of achieving stable performances. Further, powder of the reducing agent and powder of the compound of the formula (D) are mixed, and then the mixture is dispersed in the presence of a dispersant by a sand grinder mill, or the like, thereby forming the complex in the dispersing process.

The amount of the compound represented by the formula (D) is preferably 1 mol % to 200 mol %, more preferably 10 mol % to 150 mol %, and still more preferably 20 mol % to 100 mol % with respect to the reducing agent.

(Preferable Solvent for Coating Liquid)

The solvent used in the coating liquid for the image-forming layer of the photosensitive material (hereinafter, both a solvent and a dispersing medium are called solvents for simplicity) is preferably an aqueous solvent including water in an amount of 30 mass % or more. In addition to water, the aqueous solvent may include any of water-miscible organic solvents such as methyl alcohol, ethyl alcohol, isopropyl alcohol, methyl cellosolve, ethyl cellosolve, dimethylformamide, or ethyl acetate. The water content of the solvent for coating liquid is preferably 50 mass % or more, and more preferably 70 mass % or more. Preferred examples of the solvent composition include water, a mixture of water and methyl alcohol at a mass ratio of 90/10, a mixture of water and methyl alcohol at a mass ratio of 70/30, a mixture of water, methyl alcohol and dimethylformamide at a mass ratio of 80/15/5, a mixture of water, methyl alcohol and ethyl cellosolve at a mass ratio of 85/10/5, and a mixture of water, methyl alcohol and isopropyl alcohol at a mass ratio of 85/10/5.

(Silver Halide)

1) Halogen Composition

The halogen composition of the photosensitive silver halide used in the invention is not particularly restricted, and may be silver chloride, silver chlorobromide, silver bromide, silver iodobromide, silver iodochlorobromide or silver iodide. Among them, silver bromide, silver iodobromide and silver iodide are preferable. In a particle of the photosensitive silver halide, the halogen composition may be uniform in the entire particle, or may vary stepwise or continuously. Also, the photosensitive silver halide particles have a core/shell structure. The core/shell structure is preferably a 2- to 5-layered structure, more preferably 2- to 4-layered structure. It is also preferable to use techniques for localizing silver bromide or silver iodide on the surface of the particle of silver chloride, silver bromide, or silver chlorobromide.

2) Method of Forming Photosensitive Silver Halide Particle

Methods for forming photosensitive silver halide particles are well known in the art. For example, the methods described in Research Disclosure, No. 17029, June 1978 and U.S. Pat. No. 3,700,458 may be used in the invention. In an embodiment, the photosensitive silver halide are prepared by adding a silver source and a halogen source to a solution of gelatin or another polymer to form a photosensitive silver halide; and then mixing the silver halide with an organic silver salt. The methods disclosed in the following documents are also preferable: JP-A No. 11-119374, paragraph 0217 to 0224, and JP-A Nos. 11-352627 and 2000-347335.

3) Particle Size

The particle size of the photosensitive silver halide particles is preferably small so as to suppress the clouding after image formation. Specifically, the particle size is preferably 0.20 μm or less, more preferably 0.01 to 0.15 μm, further preferably 0.02 to 0.12 μm. The particle size of the photosensitive silver halide particles is the average diameter of the circle having the same area as the projected area of the particle; in the case of tabular particle, the projected area refers to the projected area of the principal plane.

4) Shape of Photosensitive Silver Halide Particle

The photosensitive silver halide particle may be a cuboidal particle, an octahedral particle, a tabular particle, a spherical particle, a rod-shaped particle, a potato-like particle, or the like. In the invention, the cuboidal particle is preferable. Silver halide particles with roundish corners are also preferable. The face index (Miller index) of the outer surface plane of the photosensitive silver halide particle is not particularly limited. In a preferable embodiment, the silver halide particles have a high proportion of {100} faces; a spectrally sensitizing dye adsorbed to the {100} faces exhibits a higher spectral sensitization efficiency. The proportion of the {100} faces is preferably 50% or higher, more preferably 65% or higher, further preferably 80% or higher. The proportion of the {100} faces according to the Miller indices can be determined by a method described in T. Tani, J. Imaging Sci., 29, 165 (1985) using adsorption dependency between {111} faces and {100} faces upon adsorption of a sensitizing dye.

5) Heavy Metal

The photosensitive silver halide particle used in the invention may include a metal selected from the metals of Groups 6 to 13 of the Periodic Table of Elements (having Groups 1 to 18) or a complex thereof When the photosensitive silver halide particle includes a metal selected from the metals of Groups 6 to 10 of the Periodic Table of Elements or a metal complex containing a metal selected from the metals of Groups 6 to 10 as the central metal, the metal or the central metal is preferably rhodium, ruthenium, iridium or iron. The metal complex may be used alone, or in combination with another complex including the same or different metal. The amount of the metal or the metal complex is preferably 1×10⁻⁹ to 1×10⁻³ mol per 1 mol of silver. The heavy metals, the metal complexes, and methods of adding them are described, for example, in JP-A Nos. 7-225449, 11-65021, paragraph 0018 to 0024, and 11-119374, paragraph 0227 to 0240.

In the invention, the silver halide particle is preferably a silver halide particle having a hexacyano metal complex on its outer surface. Examples of the hexacyano metal complex include [Fe(CN)₆]⁴⁻, [Fe(CN)₆]³⁻, [Ru(CN)₆]⁴⁻, [Os(CN)₆]⁴⁻, [Co(CN)₆]³⁻, [Rh(CN)₆]³⁻, [Ir(CN)₆]³⁻, [Cr(CN)₆]³⁻, and [Re(CN)₆]³⁻. The hexacyano metal complex is preferably a hexacyano iron complex.

Since the hexacyano metal complex is present in the form of ions in an aqueous solution, the counter cation of the hexacyano metal complex is not important. However, the counter cation is preferably a cation which is highly miscible with water and suitable for precipitating the silver halide emulsion; and examples thereof include alkali metal ion such as a sodium ion, a potassium ion, a rubidium ion, a cesium ion or a lithium ion, an ammonium ion or an alkylammonium ion (such as a tetramethylammonium ion, a tetraethylammonium ion, a tetrapropylammonium ion or a tetra(n-butyl)ammonium ion).

The hexacyano metal complex can be added in the form of a solution in water, or in a mixed solvent of water and a water-miscible organic solvent (e.g., alcohol, ether, glycol, ketone, ester, amide, or the like), or in a gelatin.

The amount of the hexacyano metal complex added is preferably 1×10⁻⁵ to 1×10⁻² mol per 1 mol of silver, and more preferably 1×10⁻⁴ to 1×10⁻³ mol per 1 mol of silver.

In order to allow the hexacyano metal complex to exist on the outer surface of the silver halide particles, the hexacyano metal complex may be directly added to the silver halide particles after the completion of the addition of an aqueous silver nitrate solution for particle formation before the chemical sensitization (which may be chalcogen sensitization such as sulfur sensitization, selenium sensitization or tellurium sensitization, or may be noble metal sensitization such as gold sensitization). Specifically, the hexacyano metal complex may be directly added to the silver halide particles before the completion of the preparation step, in the water-washing step, in the dispersion step, or before the chemical sensitization step. It is preferable to add the hexacyano metal complex immediately after particle fromation but before the completion of the preparation step so as to prevent excess growth of the silver halide particles.

In an embodiment, the addition of the hexacyano metal complex is preferably started after 96 mass % of the total amount of silver nitrate for the particle formation is added. In a preferable embodiment, the addition is started after 98 mass % of the total amount of silver nitrate is added. In a more preferable embodiment, the addition is started after 99 mass % of the total amount of silver nitrate is added.

When the hexacyano metal complex is added after the addition of the aqueous silver nitrate solution but immediately before the completion of the particle formation, the hexacyano metal complex is adsorbed onto the outer surface of the silver halide particle, and most of the adsorbed hexacyano metal complex forms a poorly soluble salt with silver ion on the surface. The silver salt of hexacyanoferrate (II) is less soluble than AgI and thus preventing redissolution of the fine particles, whereby the silver halide particles with a smaller particle size can be produced.

The metal atom or metal complexes such as [Fe(CN)₆]⁴⁻ which may be added to the silver halide particles, and a desalting method and a chemical sensitizing method for the silver halide emulsion are described in JP-A No. 11-84574, paragraph 0046 to 0050, JP-A No. 11-65021, paragraph 0025 to 0031, and JP-A No. 11-119374, paragraph 0242 to 0250.

6) Gelatin

In the invention, the gelatin contained in the photosensitive silver halide emulsion may be selected from various gelatins. The gelatin has a molecular weight of preferably 10,000 to 1,000,000 so as to maintain the excellent dispersion state of the photosensitive silver halide emulsion in the coating liquid containing the organic silver salt. Substituents on the gelatin are preferably phthalated. The gelatin may be added during the particle formation or during the dispersing process after the desalting treatment, and is preferably added during the particle formation.

7) Sensitizing Dye

The sensitizing dye used in the invention is a sensitizing dye which can spectrally sensitize the silver halide particles when adsorbed by the particles, so that the sensitivity of the silver halide is heightened in the desired wavelength. The sensitizing dye may be selected from sensitizing dyes having spectral sensitivities which are suitable for spectral characteristics of the exposure light source. The sensitizing dye and methods of adding them are described, for example, in JP-A No. 11-65021, paragraph 0103 to 0109, JP-A No. 10-186572 (the compounds represented by the formula (II)), JP-A No. 11-119374 (the dyes represented by the formula (I) and paragraph 0106), U.S. Pat. No. 5,510,236, U.S. Pat. No. 3,871,887 (the dyes described in Example 5), JP-A No. 2-96131 and JP-A No. 59-48753 (the dyes disclosed therein), EP-A No. 0803764A1, page 19, line 38 to page 20, line 35; JP-A Nos. 2001-272747, 2001-290238 and 2002-23306. Only a sensitizing dye may be used alone or two or more sensitizing dyes may be used together. In an embodiment, the sensitizing dye is added to the silver halide emulsion after the desalting process but before the coating. In a preferable embodiment, the sensitizing dye is added to the silver halide emulsion after the desalting process but before the completion of the chemical ripening.

The amount of the sensitizing dye added may be selected depending on a desired sensitivity or desired fogging properties, and is preferably 10⁻⁶ to 1 mol, and more preferably 10⁻⁴ to 10⁻¹ mol per 1 mol of the silver halide in the image-forming layer.

In the invention, a super sensitizer may be used in order to improve the spectral sensitization efficiency. Examples of the super sensitizer include compounds described in EP-A No. 587338, U.S. Pat. Nos. 3,877,943 and 4,873,184 and JP-A Nos. 5-341432, 11-109547 and 10-111543.

8) Chemical Sensitization

The photosensitive silver halide particles in the invention are preferably chemically sensitized by methods selected from the sulfur sensitization method, the selenium sensitization method or the tellurium sensitization method. Known compounds such as the compounds described in JP-A No. 7-128768 may be used in the sulfur sensitization method, the selenium sensitization method and the tellurium sensitization method. In the invention, the tellurium sensitization is preferred, and it is preferable to use a compound or compounds selected from the compounds described in JP-A No. 11-65021, paragraph 0030 and compounds represented by the formulae (II), (III), or (IV) described in JP-A No. 5-313284.

The photosensitive silver halide particles used in the invention are preferably chemically sensitized by a gold sensitization method, which may be conducted alone or in combination with the chalcogen sensitization. The gold sensitization method preferably uses a gold sensitizer having a gold atom with the valence of +1 or +3. The gold sensitizer is preferably a common gold compound. Typical examples of the gold sensitizer include chloroauric acid, bromoauric acid, potassium chloroaurate, potassium bromoaurate, auric trichloride, potassium auricthiocyanate, potassium iodoaurate, tetracyanoauric acid, ammonium aurothiocyanate, and pyridyl trichloro gold. In addition, the gold sensitizers described in U.S. Pat. No. 5,858,637 and JP-A No. 2002-278016 are also preferable in the invention.

In the invention, the chemical sensitization may be carried out at any time between particle formation and coating. For example, the chemical sensitization may be carried out after desalting, and/or (1) before spectral sensitization, (2) during spectral sensitization, (3) after spectral sensitization, (4) immediately before coating.

The amount of the sulfur, selenium or tellurium sensitizer may be changed in accordance with the kind of the silver halide particles, the chemical ripening conditions, and the like, and is generally 10⁻⁸ to 10⁻² mol per 1 mol of the silver halide, preferably 10⁻⁷ to 10⁻³ mol per 1 mol of the silver halide.

The amount of the gold sensitizer to be added depends on various conditions, and is generally 10⁻⁷ to 10⁻³ mol per 1 mol of the silver halide, and preferably 10⁻⁶ to 5×10⁻⁴ mol per 1 mol of the silver halide.

The conditions for the chemical sensitization are not particularly restricted and are generally conditions in which pH is 5 to 8, the pAg is 6 to 11 and temperature is 40 to 95° C.

A thiosulfonic acid compound may be added to the silver halide emulsion by a method described in EP No. 293,917.

In the invention, the photosensitive silver halide particles may be subjected to reduction sensitization using a reduction sensitizer. The reduction sensitizer is preferably selected from ascorbic acid, aminoiminomethanesulfinic acid, stannous chloride, a hydrazine derivative, a borane compound, a silane compound, or a polyamine compound. The reduction sensitizer may be added at any time between crystal growth and coating in the preparation of the photosensitive emulsion. It is also preferred to ripen the emulsion while maintaining the pH value of the emulsion at 7 or higher and/or maintaining the pAg value at 8.3 or lower, so as to conduct reduction sensitization of the photosensitive emulsion. Further, it is also preferable to conduct reduction sensitization by introducing a single addition part of a silver ion during particle formation.

9) Compound Whose One-Electron Oxidized Form Formed by One-Electron Oxidation Can Release One or More Electron(s)

The photothermographic material of the invention preferably comprises a compound whose one-electron oxidized form formed by one-electron oxidation can release one or more electron(s). The compound may be used alone or in combination with the above-mentioned chemical sensitizers, thereby heightening the sensitivity of the silver halide.

The compound whose one-electron oxidized form formed by one-electron oxidation can release one or more electron(s) is the following compound of Type 1 or 2.
Type 1: a compound whose one-electron oxidized form formed by one-electron oxidation can release one or more electron(s) through a subsequent bond cleavage reaction.
Type 2: a compound whose one-electron oxidized form formed by one-electron oxidation can release one or more electron(s) through a subsequent bond formation.

The compound of Type 1 will be explained first.

Examples of the compound of Type 1 include compounds described as one-photon two-electron sensitizer or a deprotonating electron-donating sensitizer in JP-A No. 9-211769 (Compounds PMT-1 to S-37 described in Tables E and F in pages 28 to 32), JP-A No. 9-211774, JP-A No. 11-95355 (Compounds INV 1 to 36), JP-A No. 2001-500996 (Compounds 1 to 74, 80 to 87, and 92 to 122), U.S. Pat. Nos. 5,747,235 and 5,747,236, EP No. 786692A1 (Compounds INV 1 to 35), EP No. 893732A1, U.S. Pat. Nos. 6,054,260 and 5,994,051. Preferred embodiments of these compounds are also described in the patent documents.

Further, examples of the compounds of Type 1 include compounds represented by the following formula (1) (equivalent to the formula (1) described in JP-A No. 2003-114487), compounds represented by the following formula (2) (equivalent to the formula (2) described in JP-A No. 2003-114487), compounds represented by the following formula (3) (equivalent to the formula (1) described in JP-A No. 2003-114488), compounds represented by the following formula (4) (equivalent to the formula (2) described in JP-A No. 2003-114488), compounds represented by the following formula (5) (equivalent to the formula (3) described in JP-A No. 2003-114488), compounds represented by the following formula (6) (equivalent to the formula (1) described in JP-A No. 2003-75950), compounds represented by the following formula (7) (equivalent to the formula (2) described in JP-A No. 2003-75950), and compounds represented by the following formula (8) (equivalent to the formula (1) described in JPA No. 2004-239943), and compounds represented by the following formula (9) (equivalent to the formula (3) described in JPA No. 2004-245929) which can undergo a reaction represented by the following chemical reaction formula (1) (equivalent to the chemical reaction formula (1) described in JPA No. 2004-245929). Preferred embodiments of the compounds are also described in the patent documents.

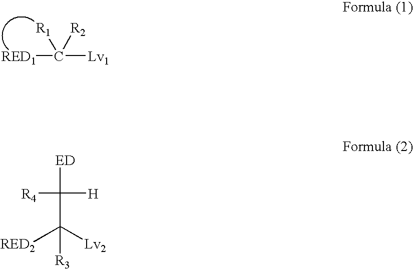

In the formulae (1) and (2), RED₁ and RED₂ each represent a reductive group. R₁ represents a nonmetallic atomic group which, together with the carbon atom C and RED₁, forms a ring structure corresponding to a tetrahydro- or a hexahydro-derivative of a five- or six-membered aromatic ring (including aromatic heterocycle). R₂, R₃, and R₄ each represent a hydrogen atom or a substituent. Lᵥ₁ and Lᵥ₂ represent a leaving group. ED represents an electron-donating group.

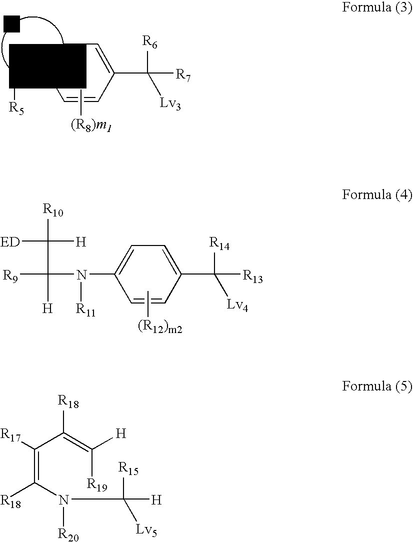

In the formulae (3) to (5), Z₁ represents an atomic group which, together with the nitrogen atom and two carbon atoms in the benzene ring, can form a six-membered ring. R₅ to R₇, R₉ to R₁₁, and R₁₃ to R₁₉ each independently represent a hydrogen atom or a substituent. R₂₀ represents a hydrogen atom or a substituent. When R₂₀ represents a group other than an aryl group, R₁₆ and R₁₇ are bonded to each other to form an aromatic ring or an aromatic heterocycle. R₈ and R₁₂ each independently represent a substituent which can be bonded to the benzene ring, m1 represents an integer of 0 to 3, and m2 represents an integer of 0 to 4. Lv₃, Lv₄, and Lv₅ each independently represent a leaving group.

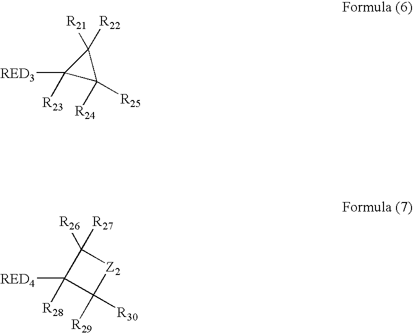

In the formulae (6) and (7), RED₃ and RED₄ independently represent a reductive group. R₂₁ to R₃₀ each independently represents a hydrogen atom or a substituent. Z₂ represents —CR₁₁₁R₁₁₂—, —NR₁₁₃—, or —O—. R₁₁₁ and R₁₁₂ independently represent a hydrogen atom or a substituent. R₁₁₃ represents a hydrogen atom or an alkyl, aryl, or heterocyclic group.

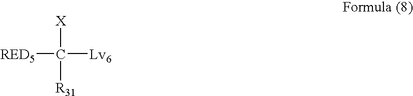

In the formula (8), RED₅ represents a reductive group, i.e., an arylamino group or a heterocyclic amino group. R₃₁ represents a hydrogen atom or a substituent. X represents an alkoxy, aryloxy, heterocyclic oxy, aklylthio, arylthio, heterocyclic thio, alkylamino, arylamino, or heterocyclic amino group. Lv₆ represents a leaving group, i.e., a carboxy group or a salt thereof, or a hydrogen atom.

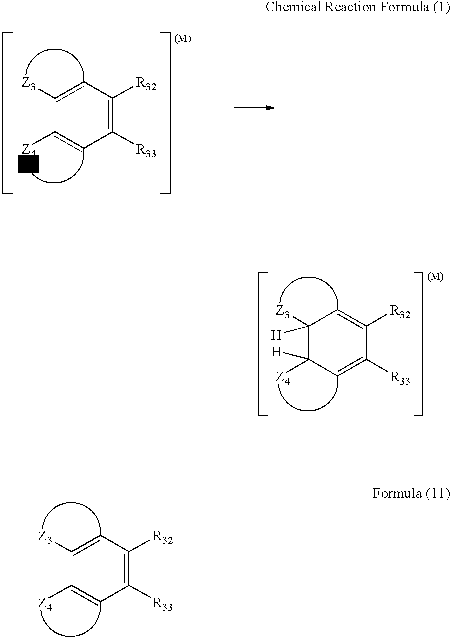

The compound represented by the formula (9) is a compound which, when oxidized after two-electron oxidation accompanied by decarboxylation, causes a bond formation reaction represented by chemical reaction formula (1). In the chemical reaction formula (1), R₃₂ and R₃₃ independently represent a hydrogen atom or a substituent. Z₃ represents a group which, together with the C═C group, forms a five-membered or six-membered heterocycle. Z₄ represents a group which, together with the C═C group, forms a five- or six-membered, aryl or heterocyclic group. M represents a radical, a radical cation, or a cation. In the formula (9), the definitions of R₃₂, R₃₃, and Z₃ are the same as those of R₃₂, R₃₃, and Z₃ in the chemical reaction formula (1). Z₅ represents a group which, together with the C—C group, forms a five-membered or six-membered alicyclic hydrocarbon group or heterocyclic group.

Next, the compound of Type 2 will be explained.

Specific examples of the compounds of Type 2 include a compound represented by the following formula (10) (equivalent to the formula (1) described in JP-A No. 2003-140287), and a compound represented by the formula (11) (equivalent to the formula (2) described in JPA No. 2004-245929) which can undergo a reaction represented by the following chemical reaction formula (1) (equivalent to the chemical reaction formula (1) described in JP-A No. 2004-245929). Preferred embodiments of these compounds are described in the patent document.
RED₆-Q-Y Formula (10)

In the formula (10), RED₆ represents a reductive group that can be one-electron oxidized. Y represents a reactive group containing a carbon-carbon double bond, a carbon-carbon triple bond, an aromatic group, or a benzo-condensed non-aromatic heterocyclic group, and which can react with the one-electron oxidized group derived from RED₆ to form a bond. Q represents a linking group that connects RED₆ and Y.

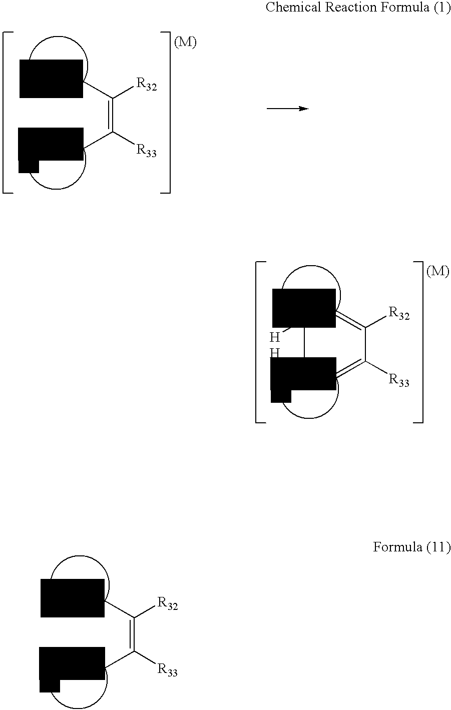

The compound represented by the formula (11) is a compound that, when oxidized, causes a bond formation reaction represented by the chemical reaction formula (1). In the chemical reaction formula (1), R₃₂ and R₃₃ each independently represent a hydrogen atom or a substituent. Z₃ represents a group which, together with the C═C group, forms a five- or six-membered heterocycle. Z₄ represents a group which, together with the C═C group, forms a five- or six-membered aryl group or a heterocycle. Z₅ represents a group which, together with the C—C group, forms a five- or six-membered alicyclic hydrocarbon group or a heterocycle. M represents a radical, a radical cation, or a cation. In the formula (11), R₃₂, R₃₃, Z₃, and Z₄ have the same meanings as in the chemical reaction formula (1).

The compound of Type 1 or 2 preferably has a group which can adsorb the silver halide, or a spectrally sensitizing dye moiety. Typical examples of the group which can adsorb the silver halide include groups described in JP-A No. 2003-156823, Page 16, Right column, Line 1 to Page 17, Right column, Line 12. The spectrally sensitizing dye moiety has a structure described in JP-A No. 2003-156823, Page 17, Right column, Line 34 to Page 18, Left column, Line 6.

The compound of Type 1 or 2 is more preferably a compound having at least one group which can adsorb the silver halide, and still more preferably a compound having two or more groups which can adsorb the silver halide. When the compound has two or more groups which can adsorb the silver halide, the groups may be the same as each other or different from each other.

Preferable examples of the group which can adsorb the silver halide include a mercapto-substituted, nitrogen-containing, heterocyclic group (e.g., a 2-mercaptothiadiazole, 3-mercapto-1,2,4-triazole, 5-mercaptotetrazole, 2-mercapto-1,3,4-oxadiazole, 2-mercaptobenzoxazole, 2-mercaptobenzthiazole, or 1,5-dimethyl-1,2,4-triazolium-3-thiolate group, or the like), and a nitrogen-containing heterocyclic group having an —NH— group capable of forming a silver imide (>NAg) as a moiety of the heterocycle (e.g., a benztriazole, benzimidazole, or indazole group, or the like). Particularly preferred among them are a 5-mercaptotetrazole, 3-mercapto-1,2,4-triazole, and benztriazole group, and most preferred are a 3-mercapto-1,2,4-triazole and 5-mercaptotetrazole group.

In a preferable embodiment, the compound of Type 1 or 2 is a compound having group which can adsorb the silver halide, the group having two or more mercapto groups. Each mercapto group (—SH) may be converted to a thione group when it can be tautomerized. The group which can adsorb the silver halide and has two or more mercapto groups may be a dimercapto-substituted, nitrogen-containing heterocyclic group, etc., and preferred examples thereof include a 2,4-dimercaptopyrimidine group, a 2,4-dimercaptotriazine group, and a 3,5-dimercapto-1,2,4-triazole group.

The group which can adsorb the silver halide may be a quaternary salt group of nitrogen or phosphorus. Specifically, the quaternary nitrogen salt group may comprise: an ammonio groups (such as trialkylammonio groups, dialkylaryl (or heteroaryl) ammonio groups, and alkyldiaryl (or heteroaryl) ammonio groups; or a quaternary nitrogen-containing heterocyclic group. The quaternary phosphorus salt group may comprise: phosphonio groups (such as trialkylphosphonio groups, dialkylaryl (or heteroaryl) phosphonio groups, alkyldiaryl (or heteroaryl) phosphonio group, or triaryl (or triheteroaryl) phosphonio groups. The quaternary salt group is more preferably a quaternary nitrogen salt group, further preferably an aromatic, quaternary-nitrogen-containing heterocyclic group having a five- or six-membered ring structure, particularly preferably a pyridinio group, a quinolinio group or an isoquinolinio group. The quaternary nitrogen-containing heterocyclic group may have a substituent.

Examples of the counter anion of the quaternary salt group include a halogen ion, a carboxylate ion, a sulfonate ion, a sulfate ion, a perchlorate ion, a carbonate ion, a nitrate ion, a BF₄⁻ ion, a PF₆⁻ ion and a Ph₄B⁻ ion. When the compound has a group with a negative charge such as a carboxylate group, the quaternary salt may be formed within the molecule. Examples of preferred counter anions other than the internal anions include a chloride ion, a bromine ion or a methanesulfonate ion.

When the compound of Type 1 or 2 has a quaternary nitrogen or phosphorus salt group as the group which can adsorb the silver halide, the compound is preferably a compound represented by the formula (X).
(P-Q₁-)ᵢ-R(-Q₂-S)ⱼ Formula (X)

In the formula (X), P and R each independently represent a quaternary nitrogen or phosphorus salt group which is not the sensitizing dye moiety. Q₁ and Q₂ each independently represent a linking group which may be selected from a single bond, an alkylene group, an arylene group, a heterocyclic group, —O—, —S—, —NR_{N}—, —C(═O)—, —SO₂—, —SO—, or —P(═O)—, or a combination thereof. R_{N} represents a hydrogen atom, or an alkyl, aryl, or heterocyclic group. S is a residue obtained by removing an atom from a compound of Type 1 or 2. i and j each independently represent an integer of 1 or more, the sum of i and j being 2 to 6. Preferably, i is 1 to 3 and j is 1 or 2. More preferably, i is 1 or 2 and j is 1. Still more preferably, i is 1 and j is 1. The compound represented by the formula (X) preferably has 10 to 100 carbon atoms, more preferably 10 to 70 carbon atoms, still more preferably 11 to 60 carbon atoms, and most preferably 12 to 50 carbon atoms.

The compound of Type 1 or 2 may be added at any time in the preparation of the photothermographic material, for example, in the preparation of the photosensitive silver halide emulsion. For example, the compound may be added, during the formation of the photosensitive silver halide particles, during the desalination, during the chemical sensitization, or before coating. The compound may be added two or more times. The compound may be added, preferably after the completion of the photosensitive silver halide particles formation but before desalination; or during the chemical sensitization (just before the chemical sensitization to immediately after the chemical sensitization), or before coating. The compound may be added, more preferably during the period from the chemical sensitization to just before the mixing of the silver halide with the non-photosensitive organic silver salt.

The compound of Type 1 or 2 may be added preferably after dissolved in water, a water-soluble solvent such as methanol or ethanol, or a mixture of these solvents. When the compound whose solubility in water varies depending on pH is dissolved in water, the pH value of the solution may be appropriately adjusted so as to dissolve the compound well, before added to the silver halide.

It is preferable to incorporate the compound of Type1 or 2 into the image-forming layer comprising the photosensitive silver halide and the non-photosensitive organic silver salt. It is also preferable to incorporate the compound Type 1 or 2 into a protective layer, an intermediate layer, or the like as well as the image-forming layer, so that the compound diffuses during the coating. The compound may be added after or before or simultaneously with the addition of the sensitizing dye. In the silver halide emulsion layer (image-forming layer), the amount of the compound is preferably 1×10⁻⁹ mol to 5×10⁻¹ mol, and more preferably 1×10⁻⁸ mol to 5×10⁻² mol based on 1 mol of silver halide.

10) Adsorbent Redox Compound Having Adsorbent Group and Reducing Group

The photothermographic material of the invention preferably includes an adsorbent redox compound having a reducing group and an adsorbent group which can adsorb the silver halide. The adsorbent redox compound is preferably a compound represented by the following the formula (I): A-(W)n-B

In the formula (I), A represents a group which can adsorb the silver halide (hereinafter, referred to as an adsorbent group); W represents a divalent linking group; n is an integer of 0 or 1; and B represents a reducing group.

In the formula (I), the adsorbent group represented by A is a group which can directly adsorb the silver halide, or a group which facilitates the adsorption of silver halide. Specifically, the adsorbent group may be a mercapto group or a salt thereof, a thione group comprising —C(═S)—; a heterocyclic group including at least one atom selected from group consisting of a nitrogen atom, a sulfur atom, a selenium atom and a tellurium atom; a sulfide group; a disulfide group; a cationic group; or an ethynyl group.

The mercapto group (or a salt thereof) serving as the adsorbent group may be a mercapto group itself (or a salt thereof), and more preferably a heterocyclic, aryl, or alkyl group, each of which has at least one mercapto group (or a salt thereof). The heterocyclic group may be a five- to seven-membered, aromatic or non-aromatic heterocyclic group having a monocyclic or condensed ring structure, and examples thereof include imidazole, thiazole, oxazole, benzimidazole, benzthiazole, benzoxazole, triazole, thiadiazole, oxadiazole, tetrazole, purine, pyridine, quinoline, isoquinoline, pyrimidine, and triazine ring groups. The heterocyclic group may contain a quaternary nitrogen atom, and in this case, the mercapto group as the substituent may be dissociated to form a meso ion. When the mercapto group forms a salt, the counter ion thereof may be a cation of an alkali metal, alkaline earth metal, or heavy metal ion, or the like such as Li⁺, Na⁺, K⁺, Mg²⁺, Ag⁺, and Zn²⁺; an ammonium ion; a heterocyclic group containing a quaternary nitrogen atom, or a phosphonium ion.

The mercapto group as the adsorbent group may be tautomerized into a thione group.

Tthe thione group as the adsorbent group may be, for example, a linear or cyclic, thioamido, thioureido, thiourethane, or dithiocarbamic acid ester groups.

The heterocyclic group containing at least one atom selected from the group consisting of nitrogen, sulfur, selenium and tellurium atoms, used as the adsorbent group, is a nitrogen-containing heterocyclic group having —NH— capable of forming a silver imide (>NAg) as a moiety of the heterocycle, or a heterocyclic group having, as a moiety of the heterocycle, 13 S—, —Se—, —Te—, or ═N— capable of forming a coordinate bond with a silver ion. Examples of the former include benzotriazole, triazole, indazole, pyrazole, tetrazole, benzimidazole, imidazole, and purine groups. Examples of the latter include thiophene, thiazole, oxazole, benzothiophene, benzothiazole, benzoxazole, thiadiazole, oxadiazole, triazine, selenazole, benzoselenazole, tellurazole, and benzotellurazole groups.

The sulfide and disulfide groups used as the adsorbent group may be any group having an —S— or —S—S— moiety.

The cationic group used as the adsorbent group is a group containing a quaternary nitrogen atom, and may be a group having a nitrogen-containing heterocyclic group which contains an ammonio group or a quaternary nitrogen atom. Examples of the quaternary nitrogen-containing heterocyclic group include pyridinio, quinolinio, isoquinolinio, and imidazolio groups.

The ethynyl group used as the adsorbent group is a —C≡CH group, in which the hydrogen atom may be substituted.

The above-described adsorbent groups may have one or more substituents.

Specific examples of the adsorbent group further include those described in JP-A No. 11-95355, Page 4 to 7.

In the formula (I), the adsorbent group represented by A is preferably a mercapto-substituted heterocyclic group (e.g., a 2-mercaptothiadiazole group, a 2-mercapto-5-aminothiadiazole group, a 3-mercapto-1,2,4-triazole group, a 5-mercaptotetrazole group, a 2-mercapto-1,3,4-oxadiazole group, a 2-mercaptobenzimidazole group, a 1,5-dimethyl-1,2,4-triazolium-3-thiolate group, a 2,4-dimercaptopyrimidine group, a 2,4-dimercaptotriazine group, a 3,5-dimercapto-1,2,4-triazole group, or a 2,5-dimercapto-1,3-thiazole group, or the like), or a nitrogen-containing heterocyclic group having —NH— capable of forming a silver imide (>NAg) in the heterocycle (e.g., a benzotriazole group, a benzimidazole group, an indazole group, or the like), more preferably a 2-mercaptobenzimidazole group or a 3,5-dimercapto-1,2,4-triazole group.

In the formula (I), W represents a divalent linking group. The linking group is not particularly limited as long as the linking group causes no adverse effects on the photographic properties. For example, the divalent linking groups may be composed of an atom or atoms selected from a carbon, hydrogen, oxygen, nitrogen, or sulfur atom. Specific examples of the divalent linking group include alkylene groups each having 1 to 20 carbon atoms such as methylene, ethylene, trimethylene, tetramethylene, and hexamethylene groups; alkenylene group each having 2 to 20 carbon atoms; alkynylene group each having 2 to 20 carbon atoms; arylene group each having 6 to 20 carbon atoms such as phenylene and naphthylene groups; —CO—; —SO₂—; —O—; —S—; —NR₁—; and combinations thereof R₁ represents a hydrogen atom, or an alkyl, heterocyclic, or aryl group.

The linking group represented by W may have any substituent(s).

In the formula (I), the reducing group represented by B is a group capable of reducing silver ions, and examples thereof include a formyl group, an amino group, a triple bond group such as an acetylene or propargyl group, a mercapto group, and residues obtained by removing a hydrogen atom from any one of hydroxylamines, hydroxamic acids, hydroxyureas, hydroxyurethanes, hydroxysemicarbazides, reductones (including reductone derivatives), anilines, phenols (including chroman-6-ols, 2,3-dihydrobenzofuran-5-ols, aminophenols, sulfonamidophenols, and polyphenols such as hydroquinones, catechols, resorcinols, benzenetriols, and bisphenols), acylhydrazines, carbamoylhydrazines, and 3-pyrazolidones. The above reducing groups may have any substituent group(s).

The oxidation potential of the reducing group represented by B in the formula (I) can be measured by a method described in Akira Fujishima, Denki Kagaku Sokutei-ho, Pages 150 to 208, Gihodo Shuppan Co., Ltd., or The Chemical Society of Japan, Jikken Kagaku Koza, 4th edition, Vol. 9, Pages 282 to 344, and Maruzen. For example, the oxidation potential may be determined by a rotating disc voltammetry technique; specifically, in the technique, a sample is dissolved in a 10/90 (volume %) solvent of methanol/pH 6.5 Britton-Robinson buffer, and then the solution is subjected to bubbling with nitrogen gas for 10 minutes, and then the electric potential of the solution is measured at 25° C. at a rotational speed of 1000 rpm at a sweep rate of 20 mV/second using a glassy carbon rotating disc electrode (RDE) as a working electrode, a platinum wire as a counter electrode, and a saturated calomel electrode as a reference electrode, thereby obtaining a voltammogram. The half-wave potential (E1/2) can be obtained from the voltammogram.

The reducing group represented by B has an oxidation potential of preferably about −0.3 V to about 1.0 V when measured by the above method. The oxidation potential is more preferably about −0.1 V to about 0.8 V, and still more preferably about 0 V to about 0.7 V.

The reducing group represented by B is preferably a residue obtained by removing one hydrogen atom from one of hydroxylamines, hydroxamic acids, hydroxyureas, hydroxysemicarbazides, reductones, phenols, acylhydrazines, carbamoylhydrazines, and 3-pyrazolidones.

The compound represented by the formula (I) may have a ballast group or a polymer chain each of which is commonly used in an immobile photographic additives such as couplers. The polymer chain may be selected from the polymer chains described in JP-A No. 1-100530.

The compound represented by the formula (I) may be in the form of a dimer or trimer. The molecular weight of the compound represented by the formula (I) is preferably 100 to 10,000, more preferably 120 to 1,000, and still more preferably 150 to 500.

Examples of the compound represented by the formula (I) are illustrated below, but the invention is not restricted by these examples.

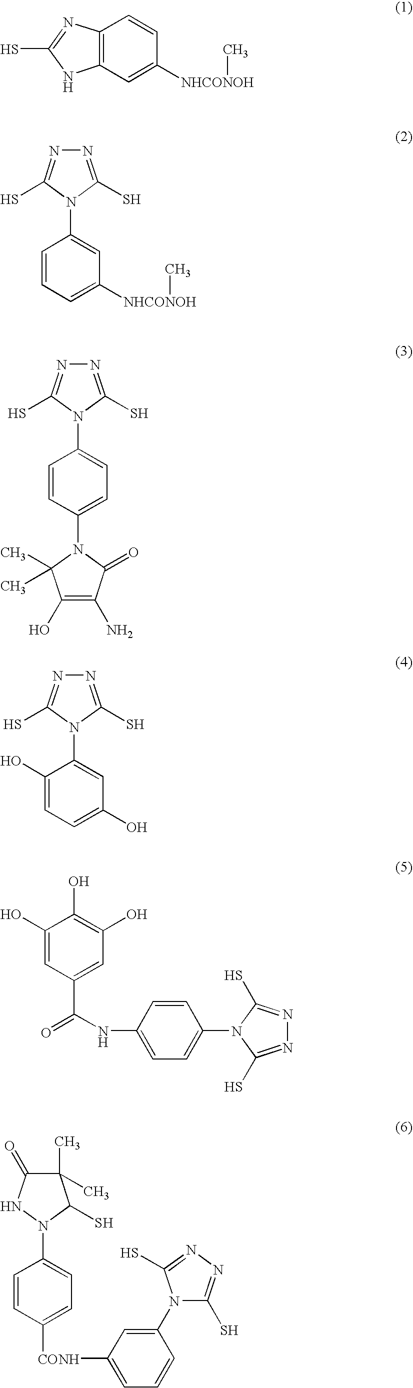

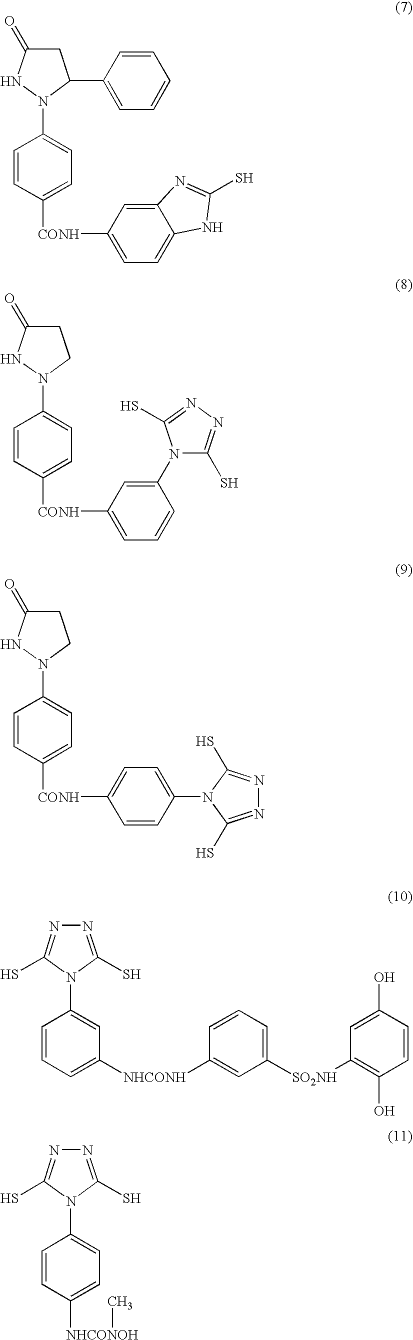

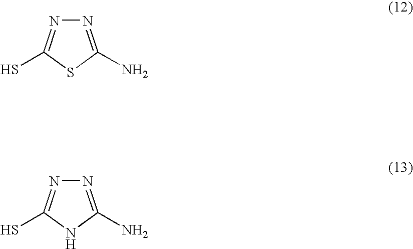

Further, Compounds 1 to 30 and 1″-1 to 1″-77 shown in EP No. 1308776A2, Pages 73 to 87 may be preferably used as the compound having the adsorbent group and the reducing group.

These compounds can be easily synthesized by known methods. A compound of the formula (I) may be used alone, or two or more compounds of the formula (I) may be used in combination. When two or more compounds of the formula (I) are used, they may be included in the same layer or respectively different layers, and may be added by respectively different methods.

The compound represented by the formula (I) is preferably included in the silver halide emulsion layer (image-forming layer). It is preferable to add the compound of the formula (I) during the preparation of the silver halide emulsion. The compound may be added at any time in the preparation of the emulsion. For example, the compound may be added (i) during the silver halide particles formation, (ii) before the desalination, (iii) during the desalination, (iv) before the chemical ripening, (v) during the chemical ripening, (vi) before the finishing. The compound may be added two or more times. The compound may be used preferably in the image-forming layer. In an embodiment, the compound is added to a protective layer, an intermediate layer, or the like as well as the image-forming layer, so that the compound diffuses during coating.

The preferred amount of the compound to be added depends largely on the adding method and the type of the compound. The amount of the compound is generally 1×10⁻⁶ mol to 1 mol, preferably 1×10⁻⁵ mol to 5×10⁻¹ mol, and more preferably 1×10⁻⁴ mol to 1×10⁻¹ mol based on 1 mol of the photosensitive silver halide.

The compound represented by the formula (I) may be added in the form of a solution in water, a water-soluble solvent such as methanol or ethanol, or a mixture of these solvents. The pH value of the solution may be appropriately adjusted by an acid or a base. A surfactant may be added to the solution. Further, the compound may be added in the form of an emulsion in an organic high-boiling point solvent, or in the form of a solid dispersion.

11) Combination of Silver Halides

In an embodiment, one photosensitive silver halide emulsion is used alone in the photothermographic material of the invention. In other embodiment, two or more photosensitive silver halide emulsions are used in the photothermographic material; the photosensitive silver halide emulsion may be different from each other in characteristics such as average particle sizes, halogen compositions, crystal habits, or chemical sensitization conditions. The image gradation can be adjusted by using two or more photosensitive silver halide emulsions having different sensitivities. The related techniques are described, for example in JP-A Nos. 57-119341, 53-106125, 47-3929, 48-55730, 46-5187, 50-73627, and 57-150841. The difference in sensitivity between the emulsions is preferably 0.2 log E or more.

12) Application Amount

The amount of the photosensitive silver halide(s) to be applied is, in terms of the applied silver amount per 1 m² of photothermographic material, preferably 0.03 g/m² to 0.6 g/m², more preferably 0.05 g/m² to 0.4 g/m², most preferably 0.07 g/m² to 0.3 g/m². Further, the amount of the photosensitive silver halide is preferably 0.01 mol to 0.5 mol, more preferably 0.02 mol to 0.3 mol, and still more preferably 0.03 mol to 0.2 mol based on 1 mol of the organic silver salt.

13) Mixing of Photosensitive Silver Halide and Organic Silver Salt

The methods and conditions of mixing the photosensitive silver halide and the organic silver salt, which are separately prepared, are not particularly restricted as long as the advantageous effects of the invention can be sufficiently obtained. In an embodiment, the silver halide and the organic silver salt are separately prepared and then mixed by a high speed stirrer, a ball mill, a sand mill, a colloid mill, a vibrating mill, a homogenizer, or the like. In another embodiment, the prepared photosensitive silver halide is added to the organic silver salt during the preparation of the organic silver salt, and the preparation of the organic silver salt is then completed. It is preferable to mix two or more aqueous organic silver salt dispersions and two or more aqueous photosensitive silver salt dispersions so as to adjust the photographic properties.

14) Addition of Silver Halide to Coating Liquid

The silver halide is added to a coating liquid for the image-forming layer preferably between 1 80 minutes before coating and immediately before coating, more preferably between 60 minutes before coating and 10 seconds before coating. There are no particular restrictions on the method and conditions of the coating as long as the advantageous effects of the invention can be sufficiently obtained. In an embodiment, the silver halide is mixed with the coating liquid in a tank while controlling the addition flow rate and the feeding amount to the coater, such that the average retention time calculated from the addition flow rate and the feeding amount to the coater is the desired time. In another embodiment, the silver halide is mixed with the coating liquid by a method using a static mixer described, for example, in N. Harnby, M. F. Edwards and A. W. Nienow, translated by Koji Takahashi, Ekitai Kongo Gijutsu, Chapter 8 (Nikkan Kogyo Shinbun, Ltd., 1989).

Antifogging Agent

Examples of an antifogging agent, a stabilizer, and a stabilizer precursor usable in the invention include compounds disclosed in JP-A No. 10-62899, Paragraph 0070 and EP No. 0803764A1, Page 20, Lline 57 to Page 21, Line 7; compounds described in JP-A Nos. 9-281637 and 9-329864; and compounds described in U.S. Pat. No. 6,083,681 and EP No. 1048975.

1) Organic Polyhalogen Compound

Organic polyhalogen compounds, which can be preferably used as the antifogging agent in the invention, will be described in detail hereinafter. The antifogging agent is particularly preferably an organic polyhalogen compound represented by the following formula (H).
Q-(Y)n-C(Z₁)(Z₂)X Formula (H)

In the formula (H), Q represents an alkyl, aryl or heterocyclic group; Y represents a divalent linking group; n denotes 0 to 1; Z₁ and Z₂ each independently represent a halogen atom; and X represents a hydrogen atom or an electron-withdrawing group.

In the formula (H), Q is preferably an alkyl group having 1 to 6 carbon atoms, an aryl group having 6 to 12 carbon atoms, or a heterocyclic group containing at least one nitrogen atom such as a pyridyl, or quinolyl group.

In the formula (H), when Q is an aryl group, the aryl group is preferably a phenyl group substituted by an electron-withdrawing group with a positive Hammett's substituent constant σp. The Hammett's substituent constant is described, for example, in Journal of Medicinal Chemistry, 1973, Vol. 16, No. 11, 1207-1216. Examples of such an electron-withdrawing group include halogen atoms, alkyl groups substituted by an electron-withdrawing group, aryl groups substituted by an electron-withdrawing group, heterocyclic groups, alkyl-or aryl-sulfonyl groups, acyl groups, alkoxycarbonyl groups, carbamoyl groups, and sulfamoyl groups. The electron-withdrawing group is preferably a halogen atom, a carbamoyl group, or an arylsulfonyl group, and more preferably a carbamoyl group.

X is preferably an electron-withdrawing group. The electron-withdrawing group is preferably halogen atoms, aliphatic, aryl or heterocyclic sulfonyl groups, aliphatic, aryl or heterocyclic acyl groups, aliphatic, aryl or heterocyclic oxycarbonyl groups, carbamoyl groups, and sulfamoyl groups. The electron- withdrawing group is more preferably a halogen atom or a carbamoyl group, and particularly preferably a bromine atom.

Z₁ and Z₂ each independently are preferably a bromine or iodine atom, more preferably a bromine atom.

Y is preferably —C(═O)—, —SO—, —SO₂—, —C(═O)N(R)—, or —SO₂N(R)—, more preferably —C(═O)—, —SO₂—, or —C(═O)N(R)—, and still more preferably —SO₂—, or —C(═O)N(R)— in which R represents a hydrogen atom, or an aryl or alkyl group, and is preferably a hydrogen atom or an alkyl group, and more preferably a hydrogen atom.

In the formula (H), n denotes 0 or 1, and is preferably 1.

In the formula (H), when Q is an alkyl group, Y is preferably —C(═O)N(R)—. When Q is an aryl group or heterocyclic group, Y is preferably —SO₂—.

In an embodiment, the organic polyhalogen compound is preferably a compound including two or more units represented by the formula (H), wherein each unit is bound to another unit, and a hydrogen atom in the formula (H) is substituted with the bond in each unit. Such a compound is referred to as a bis-, tris-, or tetrakis-type compound.

The compound represented by the formula (H) is preferably substituted by a dissociative group (e.g., a COOH group or a salt of a COOH group, an SO₃H group or a salt of an SO₃H group, or a PO₃H group or a salt of a PO₃H group), a quaternary nitrogen cation-containing group such as an ammonium group or a pyridinium group; a polyethyleneoxy group; a hydroxyl group, or the like.

Specific examples of the compound of the formula (H) are shown below.

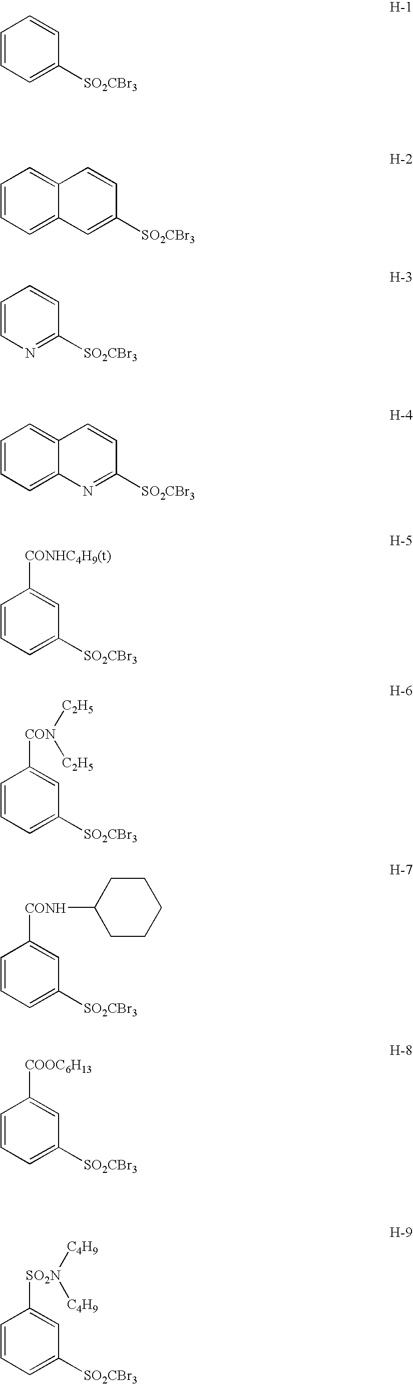

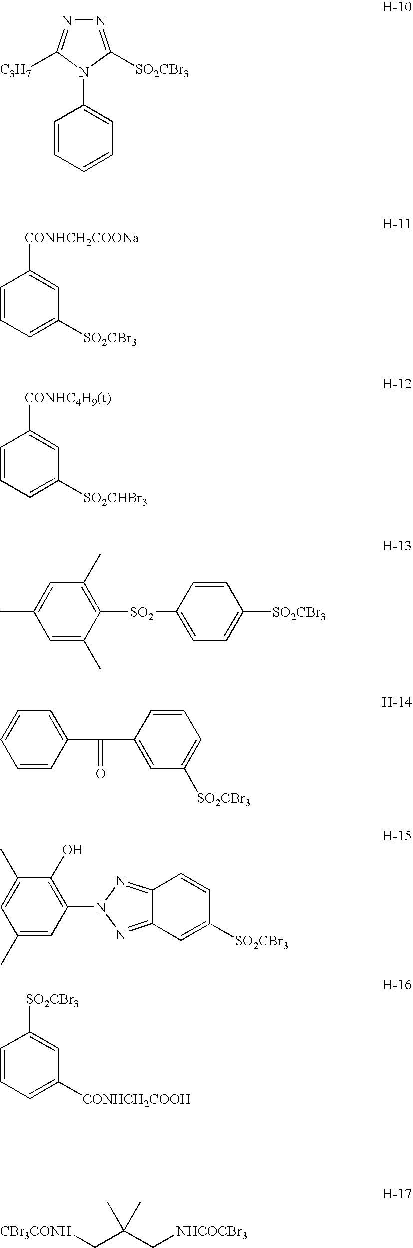

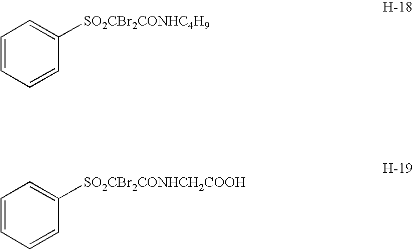

Examples of the usable organic polyhalogen compound include, in addition to the above compounds, compounds disclosed in U.S. Pat. Nos. 3,874,946, 4,756,999, 5,340,712, 5,369,000, 5,464,737, and 6,506,548, and JP-A Nos. 50-137126, 50-89020, 50-119624, 59-57234, 7-2781, 7-5621, 9-160164, 9-244177, 9-244178, 9-160167, 9-319022, 9-258367, 9-265150, 9-319022, 10-197988, 10-197989, 11-242304, 2000-2963, 2000-112070, 2000-284410, 2000-284412, 2001-33911, 2001-31644, 2001-312027, and 2003-50441. Among them, the organic polyhalogen compound is more preferably compounds disclosed in JP-A Nos. 7-2781, 2001-33911 and 2001-312027.

The amount of the compound represented by the formula (H) is preferably 10⁻⁴ to 1 mol, more preferably 10⁻³ to 0.5 mol, and still more preferably 10⁻² to 0.2 mol based on 1 mol of the non-photosensitive silver salt in the image-forming layer.

The antifogging agent may be added to the photothermographic material in any of the manners described above as examples of the method of adding the reducing agent. The organic polyhalogen compound is preferably added in the state of a solid particle dispersion.

2) Other Antifogging Agent

Examples of other antifogging agent usable in the invention include mercury (II) salts described in JP-A No. 11-65021, Paragraph 0113, benzoic acids compounds described in JP-A No. 11-65021, Paragraph 0114, salicylic acid derivatives described in JP-A No. 2000-206642, formalin scavenger compounds represented by the formula (S) described in JP-A No. 2000-221634, triazine compounds described in claim 9 of JP-A No. 11-352624, compounds represented by the formula (III) described in JP-A No. 6-11791, and 4-hydroxy-6-methyl-1,3,3a,7-tetrazaindene.

The photothermographic materials of the invention may further contain an azolium salt for the purpose of preventing the fogging. Examples of the azolium salt include compounds represented by the formula (XI) described in JP-A No. 59-193447; compounds described in JP-B No. 55-12581; and compounds represented by the formula (II) described in JP-A No. 60-153039. In an embodiment, the azolium salt is added to a layer on the same side as the image-forming layer. The layer to which the azolium salt may be added is preferably the image-forming layer. However, the azolium salt may be added to any portion of the material. The azolium salt may be added in any step in the preparation of the coating liquid. When the azolium salt is added to the image-forming layer, the azolium salt may be added in any step between the preparation of the organic silver salt and the preparation of the coating liquid. In an embodiment, the azolium salt is added during the period after the preparation of the organic silver salt but before the application of the coating liquid. The azolium salt may be added in the form of powder, a solution, a fine particle dispersion, or the like. Further, the azolium salt may be added in the form of a solution which further contains other additives such as sensitizing dyes, reducing agents, and color tone adjusting agents. The amount of the azolium salt to be added is not particularly limited, but is preferably 1×10⁻⁶ to 2 mols, and more preferably 1×10⁻³ to 0.5 mol per 1 mol of silver.

(Other Additives)

1) Mercapto, Disulfide and Thione Compound

Substances selected from mercapto compounds, disulfide compounds and thione compounds may be used in the photothermographic material of the invention in order to suppress or accelerate the development, to heighten the spectral sensitization efficiency, or to improve storability before or after the development, or the like. Examples of the compounds are described in JP-A No. 10-62899, Paragraph 0067 to 0069; JP-A No. 10-186572, the compounds represented by the formula (I) and specific examples thereof described in Paragraph 0033 to 0052; EP No. 0803764A1, Page 20, Llines 36-56. Mercapto-substituted heteroaromatic compounds described, for example, in JP-A Nos. 9-297367, 9-304875, 2001-100358, 2002-303954 and 2002-303951 are particularly preferred in the invention.

2) Color Tone Adjusting Agent

It is preferable to add a color tone adjusting agent to the photothermographic material of the invention. Examples of the color tone adjusting agent usable in the invention include those described in JP-A No. 10-62899, Paragraph 0054 and 0055, EP No. 0803764A1, Page 21, Llines 23 to 48, and JP-A Nos. 2000-356317 and 2000-187298. The specific examples of the color tone adjusting agent include phthalazinones such as phthalazinone, phthalazinone derivatives or metal salts thereof, such as 4-(1-naphthyl)phthalazinone, 6-chlorophthalazinone, 5,7-dimethoxyphthalazinone and 2,3-dihydro-1,4-phthalazinedione; combinations of phthalazinones with phthalic acids derivative such as phthalic acid, 4-methylphthalic acid, 4-nitrophthalic acid, diammonium phthalate, sodium phthalate, potassium phthalate and tetrachlorophthalic anhydride; phthalazines such as phthalazine, phthalazine derivatives and metal salts thereof, such as 4-(1-naphthyl)phthalazine, 6-isopropylphthalazine, 6-t-butylphtahlazine, 6-chlorophthalazine, 5,7-dimethoxyphthalazine and 2,3-dihydrophthalazine; and combinations of phthalazines with phthalic acids. The color tone adjusting agent is preferably a combination of phthalazines with phthalic acids. Among them, the color tone adjusting agent is more preferably a combination of 6-isopropylphthalazine with phthalic acid or 4-methylphthalic acid.

3) Plasticizer and Lubricant

A plasticizer or a lubricant may be used in the invention in order to improve the physical properties of the layers. In particular, it is preferred to use a lubricant such as liquid paraffin, a long-chain fatty acid, a fatty acid amide, a fatty acid ester, or the like for the purpose of improving handling property at the time of production and scratch resistance at the time of thermal development. The lubricant is preferably liquid paraffin from which low-boiling ingredients have been removed, or a fatty acid ester having a molecular weight of 1,000 or more and a branched structure.

The plasticizer and lubricant for the image-forming layer or the non-photosensitive layer(s) are preferably a compound described in JP-A No. 11-65021, Paragraph 0117, JP-A Nos. 2000-5137, 2004-219794, 2004-219802 and 2004-334077.

4) Dye and Pigment

Various kinds of dyes or pigments such as C. I. Pigment Blue 60, C. I. Pigment Blue 64, or C. I. Pigment Blue 15:6 may be used in the image-forming layer for the purpose of improving the color tone, preventing generation of interference fringe upon laser exposure, and preventing irradiation. The dyes and pigments are described, for example, in WO98/36322 and JP-A Nos. 10-268465 and 11-338098.

5) Nucleating Agent

The photothermographic material of the invention preferably contains a nucleating agent in the image-forming layer. The nucleating agent, adding method and addition amount thereof are described in JP-A No. 11-65021, Paragraph 0118, JP-A No. 11-223898, Paragraph 0136 to 0193, JP-A No. 2000-284399 (compounds represented by the formulae (H), (1) to (3), (A), and (B)), and JP-A No. 2000-347345 (compounds represented by the formulae (III) to (V), and specific compounds described in the formulae 21 to 24). A nucleation accelerator is described in JP-A No. 11-65021, Paragraph 0102 and JP-A No. 11-223898, Paragraph 0194 and 0195.

When formic acid or formate serving as a strong fogging agent is contained in the photothermographic material, it is preferably incorporated into any of a layer or layers disposed on the surface of a support on which the image-forming layer containing a photosensitive silver halide is formed in an amount of 5 mmol or less, and more preferably 1 mmol or less per 1 mol of silver.

When the photothermographic material of the invention contains the nucleating agent, it is preferable that the material further contains an acid resulting from hydration of diphosphorus pentaoxide, or a salt thereof Examples of such acid and salt thereof include metaphosphoric acid and salts thereof, pyrophosphoric acid and salts thereof, orthophosphoric acid and salts thereof, triphosphoric acid and salts thereof, tetraphosphoric acid and salts thereof, and hexametaphosphoric acid and salts thereof Particularly preferred are orthophosphoric acid or a salt thereof, or hexametaphosphoric acid or a salt thereof Specifically, the salt can be sodium orthophosphate, sodium dihydrogen orthophosphate, sodium hexametaphosphate, ammonium hexametaphosphate, or the like.

The amount of the acid generated by the hydration of diphosphorus pentaoxide or the salt thereof may be selected depending on the sensitivity, the fogging properties, etc. The amount of the acid or the salt to be applied per 1 m² of the photosensitive material is preferably 0.1 to 500 mg/m², more preferably 0.5 to 100 mg/m².

(Preparation and Application of Coating Liquid)

The coating liquid for the image-forming layer is prepared preferably at a preparation temperature of 30° C. to 65° C., more preferably 35° C. to 60° C., and still more preferably 35° C. to 55° C. The temperature of the coating liquid immediately after adding the polymer latex is preferably 30° C. to 65° C.

(Layer Constitution and Components)

The image-forming layer of the invention comprises at least one layer formed on the support. When the image-forming layer comprises one layer, the image-forming layer comprises an organic silver salt, a photosensitive silver halide, a reducing agent and a binder, and contains additional materials such as a color tone adjusting agent, a covering auxiliary agent and the other auxiliary agent, if necessary. When the image-forming layer comprises two or more layers, a first image-forming layer (layer usually adjacent to the support) contains the organic silver salt and the photosensitive silver halide, and a second image-forming layer or both the layers preferably contains the other components. The multicolor photosensitive heat developing photographic material may contain the combination of two layers with respect to each color. Also, a single layer may include all components as disclosed in U.S. Pat. No. 4,708,928. In the case of multi-dye multicolor photosensitive heat developing photograph material, as disclosed in U.S. Pat. No. 4,460,681, each image-forming layer is generally formed so as to be distinguished from each other by using a barrier layer having functionality or non-functionality between the image-forming layers. The photothermographic material of the invention may comprise a non-photosensitive layer in addition to the image-forming layer. The non-photosensitive layer comprises: (a) a surface protective layer provided on the image-forming layer (at the side which is farther from the support), (b) an intermediate layer provided between a plurality of image-forming layers or between the image-forming layer and the protective layer, (c) an undercoating layer provided between the image-forming layer and the support and (d) a back layer provided at the opposite side of the image-forming layer in the order of configuration.

In an embodiment, a layer acting as an optical filter may further be provided, and the layer may be formed as the layer (a) or (b). In another embodiment, an antihalation layer may be formed as the layer (c) or (d) in the photothermographic material.

1) Surface Protective Layer

In the photothermographic material of the invention, a surface protective layer may be formed for the purpose of preventing the adhesion of the image-forming layer, or the like. The surface protective layer may be in the form of a single layer and multi layers. The surface protective layer is described in JP-A No. 11-65021, paragraph 0119 to 0120 and JP-A No. 2000-171936.

Gelatin is preferably use as a binder for the surface protective layer. Alternatively, polyvinyl alcohol (PVA) may be used or may be used in combination with gelatin. Examples of the gelatin include inert gelatin (for example, Nitta Gelatin 750), phthalated gelatin (for example, Nitta Gelatin 801) or the like. Preferred examples of the PVA include one described in JP-A No. 2000-171936, paragraph 0009 to 0020, PVA-105 as a fully saponified material, PVA-205 and PVA-335 as a partly saponified material and MP-203 as a modified polyvinyl alcohol, which are manufactured by Kuraray Co., Ltd. The amount of polyvinyl alcohol to be applied (per 1 m² of support) as the protective layer (per one layer) is preferably 0.3 g/m² to 4.0 g/m², and more preferably 0.3 g/m² to 2.0 g/m².

The total amount of the binder (including the water-soluble polymer and the latex polymer) to be applied (per 1 m² of support) of the surface protective layer (per one layer) is preferably within the range of 0.3 g/m² to 5.0 g/m², and more preferably 0.3 g/m² to 2.0 g/m².

In a preferable embodiment, a lubricant agent such as a liquid paraffin and an aliphatic ester may be used in the surface protective layer. The amount of the lubricant agent to be use is 1 mg/m² to 200 mg/m2, more preferably 10 mg/m² to 150 mg/m², and still more preferably 20 mg/m² to 100 mg/m².

2) Antihalation Layer

In the photothermographic material of the invention, the antihalation layer may be disposed such that the antihalation layer is farther from the exposure light source than the image-forming layer is.

The antihalation layer is disclosed, for example, in JP-A No. 11-65021, Paragraph 0123 to 0124, JP-A Nos. 11-223898, 9-230531, 10-36695, 10-104779, 11-231457, 11-352625 and 11-352626. The antihalation layer includes an antihalation dye having absorption in the range of exposure wavelength.

When the exposure wavelength is within the infrared region, an infrared absorbing dye may be used as the antihalation dye, and the infrared-absorbing dye is preferably a dye which does not absorb visible region.

When a dye having absorption in the visible region is used to prevent the halation, in a preferable embodiment, the color of the dye does not substantially remain after image formation. It is preferable to achromatize the dye by heat at the heat development. In a more preferable embodiment, a base precursor and a thermally-achromatizable dye are added to a non-photosensitive layer so as to impart the antihalation function to the non-photosensitive layer. These techniques are disclosed, for example, in JP-A No. 11-231457.

The amount of the achromatizable dye to be applied may be determined depending on the purpose. Generally, the amount of the achromatizable dye is selected such that the optical density (absorbance) exceeds 0.1 at the desired wavelength. The optical density is preferably 0.15 to 2, more preferably 0.2 to 1. The amount of the dye required for obtaining the optical density is generally 0.001 g/m² to about 1 g/m².

When the dye is achromatized in this manner, the optical density after the heat development can be lowered to 0.1 or less. In an embodiment, two or more achromatizable dyes are used in combination in a thermally achromatizable recording material or a photothermographic material. Similarly, two or more base precursors may be used in combination.

In the thermal achromatization, it is preferable to use an achromatizable dye, a base precursor, and a substance which can lower the melting point of the base precursor by 3° C. or more when mixed with the base precursor, in view of the thermal achromatizability, as described in JP-A No. 11-352626. Examples of the substance include diphenylsulfone, 4-chlorophenyl (phenyl)sulfone, 2-naphthylbenzoate or the like.

3) Back Layer

Example of the back layer usable in the invention are described in JP-A No. 11-65021, Paragraph 0128 to 0130.

In the invention, a colorant having an absorption peak within the wavelength range of 300 to 450 nm may be added to the photosensitive material so as to improve the color tone of silver and to suppress the image deterioration over time. Examples of the colorant are described in JP-A Nos. 62-210458, 63-104046, 63-103235, 63-208846, 63-306436, 63-314535, 1-61745 and 13-100363.

The colorant is usually added within the range of 0.1 mg/M² to 1 mg/M², and the back layer provided at the opposite side of the image-forming layer is preferable as the layer to be added. So as to adjust the base color tone, it is preferable to use a dye having an absorption peak at 580 nm to 680 nm. An azomethine oil soluble dye having small absorption intensity of the side of short wavelength and described in JP-A Nos. 4-359967 and 4-359968, and a phthalocyanine water-soluble dye described in JP-A No. 2003-295388 are preferable as the dye for the purpose. Although the dye for the purpose may be added into any layer, it is more preferable to add to the non-photosensitive layer on the face side of the image-forming layer or on the back face side.

The photothermographic material of the invention is preferably a so-called single-sided photosensitive material, which comprises at least one image-forming layer containing the silver halide emulsion on one side of the support, and a back layer on the other side of the support.

4) Matting Agent

A matting agent may be used in the photothermographic material of the invention in order to improve transportability, and examples of the matting agent are described in JP-A No. 11-65021, Paragraph 0126 and 0127. The coating amount of the matting agent per m² of the photothermographic material is preferably 1 to 400 mg/m², more preferably 5 to 300 mg/M².

The matting agent may have a definite shape or an indefinite shape, and preferably have a definite shape, and more preferably have a spherical shape.

The volume-weighted average of the sphere-equivalent diameters of the matting agent particles contained in the outer layer of layers provided on a surface of a support on which an image-forming layer is provided is preferably 0.3 to 10 μm, more preferably 0.5 to 7 μm. In addition, the variation coefficient of the size distribution of the matting agent particles is preferably 5 to 80% and more preferably 20 to 80%. The variation coefficient is a value expressed by (standard deviation of particle diameter)/(average of particle diameter)×100. The outer layer may contain two or more matting agents having different average particle diameters. In such a case, the difference between the largest average particle diameter and the smallest average particle diameter is preferably 2 to 8 μm and more preferably 2 to 6 μm.

The volume-weighted average of the sphere-equivalent diameters of the matting agent particles contained in the outer layer of at least one layer provided on a surface of a support on which a back layer is provided is preferably 1 to 15 μm, more preferably 3 to 10 μm. In addition, the variation coefficient of the size distribution of the matting agent particles is preferably 3 to 50% and more preferably 5 to 30%. The outer layer may contain two or more matting agents having different average particle diameters. In such a case, the difference between the largest average particle diameter and the smallest average particle diameter is preferably 2 to 14 μm and more preferably 2 to 9 μm.

The degree of matting on the outer surface of layers provided on a surface of a support on which an image-forming layer is provided is set so that star-dust defects do not occur. However, the Beck's smoothness of the outer surface is preferably 30 seconds to 2000 seconds, and more preferably 40 seconds to 1500 seconds. The Beck's smoothness can be easily obtained by Japan Industrial Standard (JIS) P8119 (the disclosure of which is incorporated herein by reference) “Method of measuring Beck's smoothness of paper and paperboard with Beck's tester”, or TAPPI standard method T479.

The Beck's smoothness, which represents the degree of matting, of the outer surface of at least one layer provided on a surface of a support on which a back layer is provided is preferably 10 to 1200 seconds, more preferably 20 to 800 seconds, and still more preferably 40 to 500 seconds.

The matting agent is preferably contained in the outermost layer of the photothermographic material, a layer functioning as an outermost layer, or a layer close to the outermost layer, and is preferably is contained in the layer functioning as a so-called protection layer.

5) Polymer Latex

It is preferable that the photothermographic material of the invention contains the polymer latex dispersed and stabilized with the water-soluble polymer protective colloid during the polymerization in the intermediate layer, the surface protective layer or the back layer. Various polymer latexes conventionally known besides the polymer latex can be used alone or used together. The polymer latex is described in “synthetic resin emulsion (Taira Okuda, Hiroshi Inagaki, Polymer Publication Meeting (1978)”, “Application of Synthesis Latex (Takaaki Sugimura, Yasuo Kataoka, Soichi Suzuki, Keiji Kasahara, polymer publication meeting (1993)”, and “Chemistry of Synthesis Latex” (Soichi Muroi, polymer publication meeting (1970)) or the like. Specific examples thereof include a latex of methyl methacrylate (33.5 mass %)/ethyl acrylate (50 mass %)/methacrylic acid (16.5 mass %) copolymer, a latex of methyl methacrylate (47.5 mass %)/butadiene (47.5 mass %)/itaconic acid (5 mass %) copolymer, a latex of ethyl acrylate/methacrylic acid copolymer, a latex of methyl methacrylate (58.9 mass %)/2-ethylhexylacrylate (25.4 mass %)/styrene (8.6 mass %)/2-hydroxyethyl methacrylate (5.1 mass %)/acrylic acid (2.0 mass %) copolymer, and a latex of methyl methacrylate (64.0 mass %)/styrene (9.0 mass %)/butylacrylate (20.0 mass %)/2-hydroxyethyl methacrylate (5.0 mass %)/acrylic acid (2.0 mass %) copolymer. The combination of polymer latexes described in Japanese Patent Application No. 11-6872, a technique described in JP-A No. 2000-267226, Paragraph 0021 to 0025, a technique described in Japanese Patent Application No. 11-6872, Paragraph 0027 to 0028, a technique described in JP-A No. 2000-19678, Paragraph 0023 to 0041 may be applied as the binder for the surface protecting layer.

6) Surface pH

The photothermographic material of the invention before thermal development preferably has a surface pH of 7.0 or less. The surface pH is more preferably 6.6 or less. The lower limit of the surface pH is not particularly restricted but is generally about 3. The surface pH is most preferably from 4 to 6.2. It is preferable to adjust (lower) the surface pH using an organic acid such as a phthalic acid derivative, a non-volatile acid such as sulfuric acid, or a volatile base such as ammonia from the viewpoint of lowering the surface pH. In order to achieve a low surface pH, it is preferable to use ammonia since ammonia is high in volatility and can be removed during coating or before thermal development.

It is also preferable to use a non-volatile base such as sodium hydroxide, potassium hydroxide or lithium hydroxide in combination with ammonia. A method for measuring the surface pH is described in JP-A No. 2000-284399, Paragraph 0123.

7) Film Hardener

A film hardener may be used in layers such as the image-forming layer, the protective layer and the back layer. Examples of the film hardeners are described in T. H. James, The Theory of the Photographic Process, Fourth Edition, Pages 77 to 87 (Macmillan Publishing Co., Inc., 1977). Preferred examples of the film hardners include chromium alum; 2,4-dichloro-6-hydroxy-s-triazine sodium salt; N,N-ethylenebis (vinylsulfoneacetamide); N,N-propylenebis (vinylsulfoneacetamide); polyvalent metal ions described in Page 78 of the above reference; polyisocyanates described in U.S. Pat. No. 4,281,060 and JP-A No. 6-208193 or the like; epoxy compounds described in U.S. Pat. No. 4,791,042 or the like; and vinylsulfone compounds described in JP-A No. 62-89048 or the like.

The film hardener is added in the form of a solution, and the solution is added to the coating liquid for the protective layer preferably in the period of 180 minutes before applying to immediately before coating, more preferably in the period of 60 minutes before coating to 10 seconds before coating. The method and conditions of mixing the film hardner into the coating liquid are not particularly limited as long as the advantageous effects of the invention can be sufficiently obtained. In an embodiment, the film hardener is mixed with the coating liquid in a tank while controlling the addition flow rate and the feeding amount to the coater, such that the average retention time calculated from the addition flow rate and the feeding amount to the coater is the desired time. In another embodiment, the film hardener is mixed with the coating liquid by a method using a static mixer described, for example, in N. Harnby, M. F. Edwards, A. W Nienow, translated by Koji Takahashi Ekitai Kongo Gijutsu, Chapter 8 (Nikkan Kogyo Shimbun, Ltd., 1989).

8) Surfactant

Surfactants usable in the invention are described in JP-A No. 11-65021, Paragraph 0132. Also, this reference describes a solvent in Paragraph 0133, a support in Paragraph 0134, an antistatic or electrically conductive layer in Paragraph 0135, and a method for obtaining a color image in Paragraph 0136. A lubricant is described in JP-A No. 11-84573, Paragraph 0061-0064 and JP-A No. 2001-83679, Paragraph 0049-0062.

The photothermographic material of the invention preferably contains a fluorinated surfactant. Specific examples of the fluorinated surfactant include those described in JP-A Nos. 10-197985, 2000-19680 and 2000-214554. Moreover, the fluorinated surfactant is preferably a fluorinated polymer surfactant described in JP-A No. 9-281636. The photothermographic material more preferably contains a fluorinated surfactant described in JP-A Nos. 2002-82411, 2003-57780 and 2003-149766. In particular, the fluorinated surfactants described in JP-A Nos. 2003-57780 and 2001-264110 have a good charge controlling ability, good stability of a coated surface and a good lubricating ability when coated in the form of an aqueous coating liquid. The fluorinated surfactant described in JP-A No. 2001-264110 is the most preferable in that it has a high charge controlling ability and in that it can be effective even in a small amount.

The fluorinated surfactant may be contained in a surface layer provided on one side of the photothermographic material on which one side of an image-forming layer is provided and/or a surface layer provided on the other side of the material on which a back layer is provided, and is preferably contained the surface layer provided on the one side and that on the other side. In addition, it is particularly preferable to use it in combination with an electrically conductive layer containing a metal oxide. In such a case, even when the amount of the fluorinated surfactant contained in a surface layer provided on a side of the photothermographic material on which side the electrically conductive layer is provided is reduced or zero, the resultant photosensitive material can have satisfactory performance.

The amount of the fluorinated surfactant contained in the surface layers provided on one side of the photothermographic material on which one side an image-forming layer is provided and that provided on the other side of the material on which a back layer is provided is preferably in the range of 0.1 to 100 mg/m², more preferably 0.3 to 30 mg/m², and still more preferably 1 to 10 mg/m². The fluorinated surfactant described in JP-A No. 2001-264110 is particularly effective, and the amount thereof is preferably in the range of 0.01 to 10 mg/m² and more preferably 0.1 to 5 mg/m².

9) Antistatic Agent

The phtothermographic material of the invention preferably comprises an electrically conductive layer containing an electrically conductive material such as a metal oxide or an electrically conductive polymer. The antistatic layer may serve as an undercoat layer or a back layer surface protective layer. Alternatively, these layers can be provided separately. A metal oxide into which oxygen defects or a foreign metal atom is introduced to improve conductivity is preferably used as the conductive material of the antistatic layer. The metal oxide is preferably ZnO, TiO₂, or SnO₂. Aluminum or indium is preferably added to ZnO. Antimony, Niobium or phosphorous or a halogen element is preferably added to SnO₂. Niobium or tantalum is preferably added to TiO₂. In particular, the metal oxide is more preferably SnO₂ to which antimony is added. The amount of the foreign atom added is preferably in the range of 0.01 to 30 mol % and more preferably 0.1 to 10 mol % with respect to the metal oxide. The shape of the metal oxide particles may be spherical, needle-like, or plate shape, but needle-like particles having a ratio of a major axis length/minor axis length of 2.0 or more, preferably 3.0 to 50, are preferable from the viewpoint of conductivity. The amount of the metal oxide used is preferably in the range of 1 to 1,000 mg/m², more preferably 10 to 500 mg/m², and still more preferably 20 to 200 mg/m². The antistatic layer can be provided on one side of the support on which one side an image-forming layer is provided and on the other side of the support on which a back layer is provided, but is preferably provided between the support and the back layer. Examples of the antistatic layer in the invention are described in JP-A No. 11-65021, Paragraph 0135, JP-A Nos. 56-143430, 56-143431, 58-62646, and 56-120519, JP-A No. 11-84573, Paragraph 0040 to 0051, U.S. Pat. No. 5,575,957, and JP-A No. 11-223898, Paragraph 0078 to 0084.

10) Support

The photothermographic material of the invention preferably has a transparent support. The transparent support is preferably a polyester film, particularly a polyethylene terephthalate film, which has been subjected to heat treatment at a temperature in the range of 130° C. to 185° C. to relax the internal strains of the film generated during biaxial stretching, thereby eliminating the heat shrinkage strains during heat development. In the case of a photothermographic material for medical use, the support may be colored with a blue dye (e.g., dye-1 described in Examples of JP-A No. 8-240877) or uncolored. The support is preferably undercoated, for example, with a water-soluble polyester described in JP-A No. 11-84574, a styrene-butadiene copolymer described in JP-A No. 10-186565, a vinylidene chloride copolymer described in JP-A No. 2000-39684 or Japanese Patent Application No. 11-106881, Paragraph 0063 to 0080. When the support is coated with the image-forming layer or the back layer, the support preferably has a moisture content of 0.5 wt % or less.

11) Other Additives

The photothermographic material of the invention may further contain additives such as an antioxidant, a stabilizer, a plasticizer, a UV absorbent, and a coating aid. The additives may be added to any one of the image-forming layer and the non-photosensitive layers. The additives may be used with reference to WO No. 98/36322, EP No. 803764A1, JP-A Nos. 10-186567 and 10-18568.

12) Coating Method

The photothermographic material of the invention may be formed by any coating method. Specific examples of the coating methods include extrusion coating methods, slide coating methods, curtain coating methods, dip coating methods, knife coating methods, flow coating methods, extrusion coating methods using a hopper described in U.S. Pat. No. 2,681,294. The coating method is preferably an extrusion coating described in Stephen F. Kistler and Petert M. Schweizer, Liquid Film Coating, Pages 399 to 536 (CHAPMAN&HALL, 1997), or a slide coating method, more preferably a slide coating method. Examples of the slide coaters for the slide coating methods are described in the above reference, Page 427, FIG. 11b. 1. Two or more layers may be simultaneously formed by any of methods described in the above reference, Pages 399 to 536, and methods described in U.S. Pat. No. 2,761,791 and U. K. patent No. 837,095. Particularly preferable coating methods used in the invention include those disclosed in JP-A Nos. 2001-194748, 2002-153808, 2002-153803 and 2002-182333.

In the invention, the coating liquid for the image-forming layer is preferably a so-called a thixotropy fluid. The thixotropy fluid may be used with reference to JP-A No. 11-52509. The viscosity of the coating liquid for the image-forming layer is preferably 400 mPa·s to 100,000 mPa·s at a shear rate of 0.1S⁻¹, more preferably 500 mPa·s to 20,000 mPa·s at a shear rate of 0.1 S⁻¹. Further, the viscosity of the coating liquid is preferably 1 mPa·s to 200 mPa·s at a shear rate of 1000 S⁻¹, more preferably 5 mPa·s to 80 mPa·s at a shear rate of 1000 S⁻¹.

In the preparation of the coating liquid, it is preferable to use a known in-line mixing apparatus or a known in-plant mixing apparatus when two or more liquids are mixed. An in-line mixing apparatus described in JP-A No. 2002-85948 and an in-plant mixing apparatus described in JP-A No. 2002-90940 can be preferably used in the invention.

The coating liquid is preferably subjected to a defoaming treatment to keep the coated-surface uniformity well. The preferable methods for defoaming treatment are described in JP-A No. 2002-66431.

In or before the application of the coating liquid, the support is preferably subjected to electrical neutralization so as to prevent adhesion of dusts, dirts, or the like caused by the electrification of the support. Preferred examples of the neutralizing methods are described in JP-A No. 2002-143747.

When a non-setting type coating liquid for the image-forming layer is dried, it is important to precisely control drying air and drying temperature. Preferred drying methods are described in detail in JP-A Nos. 2001-194749 and 2002-139814.

The photothermographic material of the invention is preferably heat-treated immediately after coating and drying, so as to increase film formability. In a preferable embodiment, the heating temperature of the heat treatment is controlled such that the film surface temperature is 60° C. to 100° C. The heating time is preferably 1 to 60 seconds. The film face temperature in the heat treatment is more preferably 70° C. to 90° C., and the heating time is more preferably 2 to 10 seconds. Preferred examples of the heat treatments are described in JP-A No. 2002-107872.

Further, the production methods described in JP-A Nos. 2002-156728 and 2002-182333 can be preferably used to stably produce the photothermographic material of the invention continuously.

The photothermographic material of the invention is preferably a mono sheet type material, which can form an image on the material without using another sheet such as an image-receiving material.

13) Packaging Material

It is preferable to seal the photosensitive material of the invention by a packaging material having low oxygen permeability and/or a low water permeability so as to prevent deterioration of the photograph performance at raw preservation or improve curling or the like, the photothermographic properties during storage or to prevent curling. The oxygen permeability is preferably 50 ml/atm·m²·day or less at 25° C., and more preferably 10 ml/atm·m²·day or less at 25° C., and still more preferably 10 ml/atm·m²·day or less at 25° C. The water permeability is preferably 10 g/atm·m²·day or less, more preferably 5 g/atm·m²·day or less, and still more preferably 1 g/atm·m²·day or less.

The specific examples of the packaging materials having a low oxygen permeability and/or a low water permeability include materials described in JP-A Nos. 8-254793 and 2000-206653.

14) Other Usable Techniques

Other techniques usable for the photothermographic material of the invention include those described in EP Nos. 803764A1 and 883022A1; WO 98/36322, and JP-A Nos. 56-62648, 58-62644, 9-43766, 9-281637, 9-297367, 9-304869, 9-311405, 9-329865, 10-10669, 10-62899, 10-69023, 10-186568, 10-90823, 10-171063, 10-186565, 10-186567, 10-186569 to 10-186572, 10-197974, 10-197982, 10-197983, 10-197985 to 10-197987, 10-207001, 10-207004, 10-221807, 10-282601, 10-288823, 10-288824, 10-307365, 10-312038, 10-339934, 11-7100, 11-15105, 11-24200, 11-24201, 11-30832, 11-84574, 11-65021, 11-109547, 11-125880, 11-129629, 11-133536 to 11-133539, 11-133542, 11-133543, 11-223898, 11-352627, 11-305377, 11-305378, 11-305384, 11-305380, 11-316435, 11-327076, 11-338096, 11-338098, 11-338099, 11-343420, 2001-200414, 2001-234635, 2002-020699, 2001-275471, 2001-275461, 2000-313204, 2001-292844, 2000-324888, 2001-293864, 2001-348546, and 2000-187298.

(Image Forming Method)

1) Exposure

The photothermographic material of the invention may be image-exposed by various means. The photothermographic material is preferably scan-exposed by a laser beam. The laser beam is preferably a red to infrared emission laser such as a He—Ne laser and a red semiconductor laser, or a blue to green emission laser such as an Ar⁺, He—Ne, He—Cd laser, and a blue semiconductor laser. The laser beam is preferably a red to infrared emission semiconductor laser, and the peak wavelength of the laser beam is 600 nm to 900 nm, preferably 620 nm to 850 nm.

In recent years, a blue semiconductor laser, a module comprising an SHG (Second Harmonic Generator) and a semiconductor laser have been developed, and thus laser output units with short wavelength regions have attracted much attention. The blue semiconductor lasers can form a highly fine image, can increase recording density, is long lived, and has stable output, whereby the demand thereof is expected to be increased. The peak wavelength of the blue laser beam is preferably 300 nm to 500 nm, more preferably 400 nm to 500 nm. In a preferable embodiment, the laser beam is emitted in vertical multimode by high frequency superposition, or the like.

2) Heat Development

The photothermographic material of the invention may be developed by any method, but is usually exposed imagewise and then heat-developed. The development temperature is generally 80 to 250° C., preferably 100° C. to 140° C., and more preferably 110° C. to 130° C. The development time is preferably 1 to 60 seconds, more preferably 3 to 30 seconds, still more preferably 5 to 25 seconds, and most preferably 7 to 15 seconds.

The heat development may be performed by a drum heater or a plate heater, preferably performed by a plate heater. A heat development method using a heat development apparatus comprising a plate heater described in JP-A No. 11-133572 can be preferably used in the invention. The heat development apparatus comprises a heat developing section, and a visible image is formed by: forming a latent image on a photothermographic material, and bringing the material into contact with a heating unit in the heat developing section. In the heat development apparatus, the heating unit comprises the plate heater, a plurality of press rollers facing each other are arranged along one surface of the plate heater, and the photothermographic material is passed between the press rollers and the plate heater to be heat-developed. In a preferable embodiment, the plate heater is divided into two to six stages and the temperature of the end part is lowered by approximately 1° C. to 10° C. For example, four plate heaters may be independently controlled at 112° C., 119° C., 121° C., and 120° C. Such a method is described also in JP-A No. 54-30032. In the method, water and organic solvents contained in the photothermographic material can be removed, and deformation of the support caused by rapid heating can be prevented.

To reduce the size of the heat development apparatus and heat development time, more stable control of the heater is preferred. In an embodiment, the heat development of the leading end of the photothermographic material is started before the rear end is exposed. Rapid processing type imagers preferred for the invention are described in JP-A Nos. 2002-289804 and 2003-285455. When such an imager is used, for example, the photothermographic material can be heat-developed in 14 seconds by a plate heater having three stages controlled at 107° C., 121° C., and 121° C., respectively, and the first sheet of the material can be outputted in about 60 seconds. In such rapid development, it is preferable to use the photothermographic material of the invention, which is high in the sensitivity and hardly affected by ambient temperature.

3) System

Fuji Medical Dry Laser Imager FM-DPL and DRYPIX 7000 are known as laser imagers for medical use comprising an exposure region and a heat developing region. FM-DPL is described in Fuji Medical Review, No. 8, Pages 39 to 55, and the techniques disclosed therein can be applied to the invention. The photothermographic material of the invention can be used for the laser imager in AD Network, proposed by Fuji Film Medical Co., Ltd. as a network system according to DICOM Standards.

Hereinafter, the present invention will be described with reference to examples but is not limited thereto.

### EXAMPLES

### Example 1

### Preparation of PET Support

1) Film Formation

A PET having an intrinsic viscosity IV of 0.66, which was measured in a 6/4 mixture (weight ratio) of phenol/tetrachloroethane at 25° C., was prepared from terephthalic acid and ethylene glycol in an ordinary manner. The PET was pelletized, and the pellet was dried at 130° C. for 4 hours, and melted at 300° C. The melted PET was extruded from a T-die, and rapidly cooled to obtain an unstretched film.

The film was stretched 3.3 times in the longitudinal direction at 110° C. by rollers with different peripheral speeds, and then stretched 4.5 times in the horizontal direction at 130° C. by a tenter. The stretched film was subject to thermal fixation at 240° C. for 20 seconds, and relaxed by 4% in the horizontal direction at this temperature. Then, the chuk of the tenter was slit, the both ends of the film were knurled, and the film was rolled up into 4 kg/cm², to obtain a roll having a thickness of 175 μm.

2) Surface Corona Treatment

Both surfaces of the support were treated at the room temperature at 20 m/minute using a solid state corona treatment machine Model 6 KVA manufactured by Pillar Inc. The electric current and voltage were read in the treatment, whereby it was found that the support was treated under the condition of 0.375 kV.A.min/m². The discharging frequency of the treatment was 9.6 kHz, and the gap clearance between the electrode and the dielectric roll was 1.6 mm.

3) Undercoating

<Preparation of Coating Liquids for Undercoat Layer>

Prescription (1) for an Undercoat Layer on the Image-Forming Layer Side

| | | |
|---|---|---|
| PES RESIN A-520 (30 mass % solution) | 46.8 | g |
| manufactured by Takamatsu Oil & Fat Co., Ltd | | |
| VYLONAL MD-1200 manufactured by Toyobo Co., Ltd. | 10.4 | g |
| 1 mass % solution of Polyethylene glycol monononylphenyl | 11.0 | g |
| ether (average number of ethylene oxide: 8.5) | | |
| MP-1000 (PMMA polymer fine particles having | 0.91 | g |
| an average particle size of 0.4 μm) | | |
| manufactured by Soken Chemical & Engineering Co., Ltd. | | |
| Distilled water | 931 | ml |

Prescription (2) for First Back Undercoat Layer

| | | |
|---|---|---|
| Styrene-butadiene copolymer latex | 130.8 | g |
| (solid content 40 mass %, styrene/butadiene mass ratio 68/32) | | |
| 8 mass % aqueous solution of 2,4-Dichloro-6-hydroxy- | 5.2 | g |
| S-triazine sodium salt | | |
| 1 mass % aqueous solution of sodium laurylbenzenesulfonate | 10 | ml |
| Polystyrene particle dispersion (average particle diameter | 0.5 | g |
| 2 μm, 20 mass %) | | |
| Distilled water | 854 | ml |

Prescription (3) for a Second Back Undercoat Layer

| | | |
|---|---|---|
| 17 mass % dispersion of SnO₂/SbO (mass ratio 9/1, | 84 | g |
| average particle size 0.5 μm,) | | |
| Gelatin | 7.9 | g |
| 2 mass % aqueous solution of METOLOSE TC-5 | 10 | g |
| manufactured by Shin-Etsu Chemical Co., Ltd. | | |
| 1 mass % aqueous solution of sodium | 10 | ml |
| dodecylbenzenesulfonate | | |
| NaOH (1 mass %) | 7 | g |
| PROXEL (manufactured by Avecia Ltd.) | 0.5 | g |
| Distilled water | 881 | ml |

After subjecting the both surfaces of the biaxially stretched polyethylene terephthalate support having a thickness of 175 μm to the corona discharge treatment, the undercoating liquid of Prescription (1) was applied to one surface (image-forming layer side) of the support by a wire bar in a wet amount of 6.6 ml/m², and dried at 180° C. for 5 minutes. Then, the undercoating liquid of Prescription (2) was applied to the other surface (back surface) by a wire bar in a wet amount of 5.7 ml/m², and dried at 180° C. for 5 minutes. Then, the undercoating liquid of Prescription (3) was applied to the back surface by a wire bar in a wet amount of 8.4 ml/m², and dried at 180° C. for 6 minutes, to prepare an undercoated support.

(Back Layer)

1) Preparation of Coating Liquid for Back Layer

<Preparation of Base Precursor Solid Particle Dispersion (a)>

2.5 kg of the base precursor compound 1, 300 g of a surfactant (DEMOL N™ manufactured by Kao Corporation), 800 g of diphenylsulfone and 1.0 g of benzoisothiazolinone sodium salt were mixed with distilled water so that the total amount was 8.0 kg. The mixture liquid was fed by a diaphragm pump to a horizontal sand mill (UVM-2 manufactured by Imex Co., Ltd.), which was packed with zirconia beads having the average diameter of 0.5 mm, and bead-dispersed in the mill under an inner pressure of 50 hPa or higher until the desired average particle diameter was obtained.

The dispersion was carried out while conducting an optical absorption measurement until the ratio of the absorbancies at 450 nm and 650 nm (D₄₅₀/D₆₅₀) became 3.0. The resulting dispersion was diluted with distilled water until the concentration of the base precursor became 25 mass %. Thereafter, the dispersion was filtrated with a polypropylene filter having an average pore diameter of 3 μm to remove extraneous substances.

2) Preparation of Dye Solid Particle Dispersion

6.0 kg of cyanine dye compound 1, and 3.0 kg of sodium p-dodecylbenzenesulfonate, 0.6 kg of a surfactant DEMOL SNB (manufactured by Kao Corporation), and 0.15 kg of a antifoaming agent (SURFYNOL 104E™ manufactured by Nissin Chemical Industry Co., Ltd.) were mixed with distilled water into the total amount of 60 kg. The resultant mixture was dispersed in the presence of 0.5 mm zirconia beads by using a horizontal sand mill (UVM-2 manufactured by Imex Co., Ltd.).

The dispersion was carried out while conducting an optical absorption measurement until the ratio of the absorbancies at 650 nm and 750 nm (D₆₅₀/D₇₅₀) became 5.0 or more. The resulting dispersion was diluted with distilled water until the concentration of the cyanine dye compound 1 became 6 mass %. Thereafter, the dispersion was filtrated with a filter having an average pore diameter of 1 μm to remove extraneous substances.

3) Preparation of Coating Liquid for Antihalation Layer

37 g of gelatin having an isoelectric point of 6.6 (ABA GELATIN manufactured by Nippi, Inc.), 0.1 g of benzisothiazolinone, and water were added to a vessel to dissolve the gelatin while keeping the temperature of the vessel at 40° C. Further, the resultant solution was mixed with 36 g of the above dye solid particle dispersion, 73 g of the base precursor solid particle dispersion (a), 43 ml of 3 mass % aqueous solution of sodium polystyrenesulfonate, and 82 g of a 10 mass % SBR latex (styrene/butadiene/acrylic acid copolymer, mass ratio 68.3/28.7/3.0). Thus, a coating liquid for antihalation layer having a total amount of 773 ml was obtained. The pH of the final liquid was 6.3.

4) Preparation of Coating Liquid for Back Protective Layer

43 g of gelatin having an isoelectric point of 4.8 (PZ GELATIN manufactured by JELLICE Co., Ltd.), 0.21 g of benzisothiazolinone, and water were added to a vessel to dissolve the gelatin while keeping the temperature of the vessel at 40° C. The resultant solution was mixed with 8.1 ml of a 1 mol/l aqueous sodium acetate solution, 0.93 g of monodispersed poly(ethyleneglycol dimethacrylate-co-methyl methacrylate) particles (average particle diameter of 7.7 μm, and particle diameter standard deviation of 0.3 μm), 5 g of a 10 mass % emulsion of liquid paraffin, 10 g of a 10 mass % emulsion of acid dipentaerythrityl hexaisostearate, 10 ml of a 5 mass % aqueous solution of sodium di(2-ethylhexyl) sulfoscuccinate, 17 ml of a 3 mass % aqueous solution of sodium polystyrenesulfonate, 2.4 ml of a 2 mass % solution of fluorinated surfactant (F-1), 2.4 ml of a 2 mass % solution of fluorinated surfactant (F-2), and 30 ml of a 20 mass % ethyl acrylate/acrylic acid copolymer (copolymerization mass ratio 96.4/3.6) latex. Immediately before coating, 50 ml of a 4 mass % aqueous solution of N,N-ethylene bis(vinylsulfoneacetamide) was mixed with the resultant mixture to give a coating liquid for back protective layer having a total amount of 855 ml. The pH of the final liquid was 6.2.

5) Application of Back Layer

The back surface of the undercoated support was subjected to simultaneous multilayer coating with the coating liquid for the antihalation layer and the coating liquid for back protective layer, and the applied liquids were dried to form a back layer. The coating liquid for the antihalation layer was applied such that the application amount of gelatin was 0.54 g/m² and the coating liquid for the back protective layer was applied such that the application amount was 1.85 g/m².

(Image-Forming Layer, Intermediate Layer and Surface Protective Layer)

1. Preparation of Coating Materials

1) Silver Halide Emulsion

<<Preparation of Silver Halide Emulsion 1>>

3.1 ml of a 1 mass % potassium bromide solution was added to 1421 ml of distilled water, and 3.5 ml of 0.5 mol/l sulfuric acid solution and 31.7 g of phthalated gelatin were further added thereto. While stirring the resulting mixture in a stainless steel reaction pot at 30° C., a solution A prepared by diluting 22.22 g of silver nitrate with distilled water into 95.4 ml and solution B prepared by diluting 15.3 g of potassium bromide and 0.8 g of potassium iodide with distilled water into 97.4 ml were added to the liquid at the constant flow rate over 45 seconds. Then, 10 ml of a 3.5 mass % aqueous solution of hydrogen peroxide was added to the resultant mixture, and 10.8 ml of a 10 mass % aqueous solution of benzimidazole was further added. Further, a solution C prepared by diluting 51.86 g of silver nitrate with distilled water to 317.5 ml and solution D prepared by diluting 44.2 g of potassium bromide and 2.2 g of potassium iodide with distilled water to 400 ml were added to the mixture. These solutions C was added over 20 minutes at a constant flow rate, and the solution D was added by a controlled double jet method while adjusting the pAg value to 8.1. 10 minutes after staring the addition of the solutions C and D, potassium hexachloroiridate (III) was added to the mixture in an amount of 1×10⁻⁴ mol per 1 mol of silver. Further, 5 seconds after completing the addition of the solution C, an aqueous solution of potassium iron (II) hexacyanide was added to the mixture in an amount of 3×10⁻⁴ mol per 1 mol of silver. The pH value of the mixture was adjusted to 3.8 using a 0.5 mol/l sulfuric acid, then stirring was stopped, and the mixture was subjected to precipitation, desalination, and water-washing. The pH value of the mixture was adjusted to 5.9 using a 1 mol/l sodium hydroxide to prepare a silver halide dispersion 1 with pAg of 8.0.

5 ml of a 0.34 mass % methanol solution of 1,2-benzisothiazolin-3-one was added to the silver halide dispersion 1 while stirring the dispersion at 38° C., and 40 minutes after the addition, the resultant mixture was heated to 47° C. 20 minutes after heating, a methanol solution of sodium benzenethiosufonate was added to the mixture in an amount of 7.6×10⁻⁵ mol per 1 mol of silver. Further, 5 minutes after the addition, a methanol solution of tellurium sensitizer C was added to the mixture in an amount of 2.9×10⁻⁴ mol per 1 mol of silver, and the resultant mixture was ripened for 91 minutes. Thereafter, a methanol solution of 3/1 mol ratio mixture of the spectrally sensitizing dyes A and B was added to the mixture such that the total amount of the dyes A and B was 1.2×10⁻³ mol per I mol of silver. 1 minute after the addition, 1.3 ml of a 0.8 mass % methanol solution of N,N′-dihydroxy-N″-diethylmelamine was added to the mixture, 4 minutes after the addition, a methanol solution of 5-methyl-2-mercaptobenzimidazole in an amount of 4.8×10⁻³ mol per 1 mol of silver, a methanol solution of 1-phenyl-2-heptyl-5-mercapto-1,3,4-triazole in an amount of 5.4×10⁻³ mol per 1 mol of silver, and an aqueous solution of 1-(3-methylureidophenyl)-5-mercaptotetrazole in an amount of 8.5×10⁻³ mol per 1 mol of silver were added thereto to prepare a silver halide emulsion 1.

The silver halide emulsion thus obtained contained silver iodobromide particles having an average sphere-equivalent diameter of 0.042 μm and a variation coefficient of the sphere-equivalent diameters of 20% and containing 3.5 mol % of iodo uniformly. The particle size and the like was an average value of 1,000 particles obtained using an electron microscope. The particles had a {100} plane proportion of 80%, obtained by Kubelka Munk method.

<<Preparation of Silver Halide Emulsion 2>>

A silver halide emulsion 2 was prepared in the same manner as the silver halide emulsion 1, except that the liquid temperature was changed from 30° C. to 47° C. during particle formation, the solution B was prepared by diluting 15.9 g of potassium bromide with distilled water to 97.4 ml, the solution D was prepared by diluting 45.8 g of potassium bromide with distilled water to 400 ml, the solution C was added over 30 minutes, and the potassium iron (II) hexacyanide was not used. The precipitation, desalination, water-washing, and dispersion were carried out in the same manner as the preparation of the silver halide emulsion 1. Further, silver halide emulsion 2 was subjected to the steps of the spectral sensitization, the chemical sensitization, and the addition of 5-methyl-2-mercaptobenzoimidazole and 1-phenyl-2-heptyl-5-mercapto-1,3,4-triazole in the same manner as the preparation of the silver halide emulsion 1, except that the amount of the tellurium sensitizer C was 1.1×10⁻⁴ mol, methanol solution of 3/1 mol ratio mixture of the spectrally sensitizing dyes A and B was added such that the total amount of the sensitizing dyes A and B was 7.0×10⁻⁴ mol, the amounts of 1-phenyl-2-heptyl-5-mercapto-1,3,4-triazole was 3.3×10⁻³ mol and the amount of 1-(3-methylureidophenyl)-5-mercaptotetrazole was 4.7×10⁻³ mol and 4.7×10⁻³ mol, per 1 mol of silver, to prepare a silver halide emulsion 2. The silver halide emulsion 2 comprised cuboidal pure silver bromide particles having an average sphere-equivalent diameter of 0.080 μm and a variation coefficient of the sphere-equivalent diameters of 20%.

<<Preparation of Silver Halide Emulsion 3>>

A silver halide emulsion 3 was prepared in the same manner as the silver halide emulsion 1, except that the liquid temperature was changed from 30° C. to 27° C. during particle formation. The precipitation, desalination, water-washing, and dispersion were carried out in the same manner as the preparation of the silver halide emulsion 1. Then, a silver halide emulsion 3 was prepared in the same manner as the preparation of the silver halide emulsion 1, except that a solid dispersion (aqueous gelatin solution) of a 1/1 mol ratio mixture of the spectrally sensitizing dyes A and B was added such that the total amount of the dyes A and B was 6×10⁻³ mol per 1 mol of silver, the amount of tellurium sensitizer C was 5.2×10⁻⁴ mol per 1 mol of silver, and 3 minutes after the addition of the tellurium sensitizer, 5×10⁻⁴ mol of bromoauric acid and 2×10⁻³ mol of potassium thiocyanate were added per 1 mol of silver. The prepared silver halide emulsion 3 comprised silver iodobromide particles, which had an average sphere-equivalent diameter of 0.034 μm and a variation coefficient of the sphere-equivalent diameters of 20%, and included 3.5 mol % of iodo uniformly.

<<Preparation of Mixed Emulsion A for Coating Liquid>>

70 mass % of the silver halide emulsion 1, 15 mass % of the silver halide emulsion 2, and 15 mass % of the silver halide emulsion 3 were mixed, and a 1 mass % aqueous solution of benzothiazolium iodide was added to the mixed emulsion such that the amount of benzothiazolium iodide was 7×10⁻³ mol per mol of silver. The above mass % is based on the mass of the resultant mixed emulsion.

Further, to the mixed emulsion was added the compounds 1, 2, and 3, whose one-electron oxidized form can release one or more electron(s). The amount of each of the compounds 1, 2, and 3 was 2×10⁻³ mol per I mol of silver in the silver halide.

Then, the adsorbent redox compounds 1 and 2 having an adsorbent group and reducing groups were added to the mixed emulsion. The amount of each of adsorbent redox compounds 1 and 2 was 5×10⁻³ mol per 1 mol of silver halide.

Water was added to the mixed emulsion for the coating liquid such that the silver amount of the silver halide was 38.2 g per 1 kg of the mixed emulsion. Further, 1-(3-methylureidophenyl)-5-mercaptotetrazole was added such that the amount thereof was 0.34 g per 1 kg of the mixed emulsion.

2) Preparation of Fatty Acid Silver Salt Dispersion

88 kg of recrystallized behenic acid, 422 l of distilled water, 49.2 l of a 5 mol/l aqueous solution of NaOH and 120 l of t-butyl alcohol were mixed and stirred at 75° C. for one hour, to obtain a sodium behenate solution B. Separately, 206.2 l of an aqueous solution (pH 4.0) containing 40.4 kg of silver nitrate was kept at 10° C. A reaction vessel containing 635 l of distilled water and 30 l of t-butyl alcohol was kept at 30° C. The entire amount of the sodium behenate solution and the entire amount of the aqueous solution of silver nitrate were added to the content of the vessel at constant flow rates over 93 minutes and 15 seconds and over 90 minutes, respectively, while the content in the vessel was being sufficiently stirred. At this time, only the aqueous solution of silver nitrate was added for 11 minutes after starting the addition of the aqueous solution of silver nitrate, addition of the sodium behenate solution B was started subsequently, and only the sodium behenate solution B was added for 14 minutes and 15 seconds after completion of the addition of the aqueous solution of silver nitrate. At this time, the internal temperature of the reaction vessel was kept at 30° C. The external temperature was controlled such that the liquid temperature was constant. The pipe line for the sodium behenate solution B was a double-walled pipe and thermally insulated by circulating hot water through the interspace of the double-walled pipe, and the temperature of the solution at the outlet of the nozzle tip was adjusted at 75° C. The pipe line for the aqueous solution of silver nitrate was also a double-walled pipe and thermally insulated by circulating cold water through the interspace of the double-walled pipe. The positions at which the sodium behenate solution was added to the reaction system and that at which the aqueous solution of silver nitrate was added thereto were disposed symmetrically relative to the shaft of the stirrer disposed in the reactor, and the nozzle tips of the pipes were spaced apart from the reaction solution level in the reactor.

After adding the sodium behenate solution B was completed, the reaction mixture was stirred for 20 minutes at that temperature, and then heated to 35° C. over 30 minutes. Thereafter, the mixture was ripened for 210 minutes. Immediately after completion of the ripening, the mixture was centrifugally filtered to collect a solid component, which was washed with water until the conductivity of the washing waste reached 30 μS/cm. The solid thus obtained was a fatty acid silver salt and was stored as a wet cake without drying it.

The shapes of the silver behenate particles were analyzed on the basis of their images taken through electron microscopic photography. The average values of a, b, and c were 0.21 μm, 0.4 μm and 0.4 μm, respectively (a, b and c are defined hereinabove). The average aspect ratio was 2.1. The variation coefficient of the sphere-equivalent diameters of the particles was 11%.

19.3 kg of polyvinyl alcohol (PVA-217™) and water were added to the wet cake whose amount corresponded to 260 kg of the dry weight thereof such that the total amount of the resultant became 1000 kg. The resultant was formed into a slurry by a dissolver blade, and then pre-dispersed in a pipe-line mixer (Model PM-10 available from Mizuho Industry Co.).

Then, the pre-dispersed stock slurry was processed three times with a disperser (MICROFLUIDIZER M-610 obtained from Microfluidex International Corporation, and equipped with a Z-type interaction chamber) at a controlled pressure of 1150 kg/cm². A silver behenate dispersion was thus prepared. Cooling was carried out in corrugated tube-type heat exchangers disposed before and behind the interaction chamber, respectively. The temperature of the coolant in these heat exchangers was so controlled that the system could be processed at a stirring temperature of 18° C.

3) Preparation of Reducing Agent Dispersion

<<Preparation of Reducing Agent 1 Dispersion>>

10 kg of reducing agent 1, (2,2′-methylenebis-(4-ethyl-6-tert-butylphenol)), 16 kg of a 10 mass % aqueous solution of modified polyvinyl alcohol (POVAL MP203 available from Kuraray Co., Ltd.) and 10 kg of water were sufficiently mixed to form a slurry. The slurry was fed by a diaphragm pump into a horizontal sand mill (UVM-2 available from Imex Corporation) which was packed with zirconia beads having the average diameter of 0.5 mm, and dispersed therein for 3 hours. Then, 0.2 g of sodium salt of benzoisothiazolinone and water were added to the dispersed slurry such that the content of the reducing agent was 25 mass %. The resultant dispersion was heated at 60° C. for 5 hours to obtain a reducing agent 1 dispersion. The reducing agent particles in the dispersion had a median size of 0.40 μm, and a maximum particles size of 1.4 μm or less. The reducing agent dispersion was filtered through a polypropylene filter having a pore size of 3.0 μm to remove extraneous substances such as dust, and then stored.

<<Preparation of Reducing Agent 2 Dispersion>>

10 kg of reducing agent-2, (6,6′-di-t-butyl-4,4′-dimethyl-2,2′-butylidenediphenol), 16 kg of a 10 mass % aqueous solution of modified polyvinyl alcohol (POVAL MP203 available from Kuraray Co., Ltd.) and 10 kg of water were sufficiently mixed to form a slurry. The slurry was fed by a diaphragm pump into a horizontal sand mill (UVM-2 available from Imex Corporation) which was packed with zirconia beads having the average diameter of 0.5 mm, and dispersed therein for 3 hours and 30 minutes. Then, 0.2 g of sodium salt of benzoisothiazolinone and water were added to the dispersed slurry such that the reducing agent concentration was 25 mass %. The resultant dispersion was then heated at 40° C. for 1 hour, and subsequently heated at 80° C. for 1 hour to obtain a reducing agent 2 dispersion. The reducing agent particles in the dispersion had a median size of 0.50 μm, and a maximum particle size of 1.6 μm or less. The reducing agent dispersion was filtered through a polypropylene filter having a pore size of 3.0 μm to remove extraneous substances such as dust, and then stored.

4) Preparation of Hydrogen-Bonding Compound 1 Dispersion

10 kg of water was sufficiently mixed with 10 kg of hydrogen-bonding compound 1 (tri(4-t-butylphenyl)phosphine oxide) and 16 kg of a 10 mass % aqueous solution of modified polyvinyl alcohol (POVAL MP203 available from Kuraray Co., Ltd.) to form a slurry. The slurry was fed by a diaphragm pump into a horizontal sand mill (UVM-2 available from Imex Corporation), which was packed with zirconia beads having an average diameter of 0.5 mm, and dispersed therein for 4 hours. Then, 0.2 g of sodium salt of benzoisothiazolinone and water were added to the dispersed slurry such that the hydrogen-bonding compound concentration was 25 mass %. The resultant dispersion was heated at 40° C. for 1 hour and subsequently heated at 80° C. for 1 hour to obtain a hydrogen-bonding compound 1 dispersion. The hydrogen-bonding compound particles in the dispersion had a median size of 0.45 μm, and a maximum particle size of 1.3 μm or less. The hydrogen-bonding compound 1 dispersion was filtered through a polypropylene filter having a pore size of 3.0 μm to remove extraneous substances such as dust, and then stored.

5) Preparation of Development Accelerator 1 Dispersion

10 kg of water was sufficiently mixed with 10 kg of development accelerator 1 and 20 kg of a 10 mass % aqueous solution of modified polyvinyl alcohol (POVAL MP203 available from Kuraray Co., Ltd.) to form a slurry. The slurry was fed by a diaphragm pump into a horizontal sand mill (UVM-2 available from Imex Corporation) which was packed with zirconia beads having an average diameter of 0.5 mm, and dispersed therein for 3 hours and 30 minutes. Then, 0.2 g of sodium salt of benzoisothiazolinone and water were added to the dispersed slurry such that the development accelerator concentration was 20 mass %, to obtain a development accelerator 1 dispersion. The development accelerator particles in the dispersion had a median size of 0.48 μm, and a maximum particle size of 1.4 μm or less. The development accelerator 1 dispersion was filtered through a polypropylene filter having a pore size of 3.0 μm to remove extraneous substances such as dust, and then stored.

6) Preparation of Development Accelerator 2 Dispersion and Color Tone Adjusting Agent 1 Dispersion

A 20 mass % solid dispersion of the development accelerator 2 and a 15 mass % solid dispersion of the color tone adjusting agent 1 were prepared in the same manner as the development accelerator 1 dispersion, respectively.

7) Preparation of Polyhalogen Compound

<<Preparation of Organic Polyhalogen Compound 1 Dispersion>>

10 kg of organic polyhalogen compound 1 (tribromomethanesulfonylbenzene), 10 kg of a 20 mass % aqueous solution of modified polyvinyl alcohol (POVAL MP203 available from Kuraray Co., Ltd.), 0.4 kg of a 20 mass % aqueous solution of sodium triisopropylnaphthalenesulfonate, and 14 kg of water were sufficiently mixed to obtain a slurry. The slurry was fed by a diaphragm pump into a horizontal sand mill (UVM-2 available from Imex Corporation) which was packed with zirconia beads having an average diameter of 0.5 mm, and dispersed therein for 5 hours. Then, 0.2 g of sodium salt of benzoisothiazolinone and water were added to the dispersed slurry such that the content of the organic polyhalogen compound was 26 mass %, to obtain an organic polyhalogen compound 1 dispersion. The organic polyhalogen compound particles in the dispersion had a median diameter of 0.41 μm, and a maximum particle size of 2.0 μm or less. The organic polyhalogen compound dispersion was filtered through a polypropylene filter having a pore size of 10.0 μm to remove extraneous substances such as dust, and then stored.

<<Preparation of Organic Polyhalogen Compound 2 Dispersion>>

10 kg of the organic polyhalogen compound 2, (N-butyl-3-tribromomethanesulfonylbenzamide), 20 kg of a 10 mass % aqueous solution of modified polyvinyl alcohol (POVAL MP203 available from Kuraray Co., Ltd.), and 0.4 kg of a 20 mass % aqueous solution of sodium triisopropylnaphthalenesulfonate were sufficiently mixed to obtain a slurry. The slurry was fed by a diaphragm pump into a horizontal sand mill (UVM-2 available from Imex Corporation) which was packed with zirconia beads which having an average diameter of 0.5 mm, and dispersed therein for 5 hours. Then, 0.2 g of sodium salt of benzoisothiazolinone and water were added to the dispersed slurry such that the content of the organic polyhalogen compound was 30 mass %, and the liquid was heated at 40° C. for 5 hours to obtain an organic polyhalogen compound 2 dispersion. The organic polyhalogen compound particles in the dispersion had a median diameter of 0.40 μm, and a maximum particle size of 1.3 μm or less. The organic polyhalogen compound 2 dispersion was filtered through a polypropylene filter having a pore size of 3.0 μm to remove extraneous substances such as dust, and then stored.

8) Preparation of Phthalazine Compound 1 Solution

8 kg of modified polyvinyl alcohol (MP203 manufactured by Kuraray Co., Ltd.) was dissolved in 174.57 kg of water. To the solution was added 3.15 kg of a 20 mass % aqueous solution of sodium triisopropylnaphthalenesulfonate and 14.28 kg of a 70 mass % aqueous solution of phthalazine compound 1 (6-isopropylphthalazine) to prepare a 5 mass % phthalazine compound 1 solution.

9) Preparation of Mercapto Compound

<<Preparation of Aqueous Mercapto Compound 1 Solution>>

7 g of the mercapto compound 1 (sodium salt of 1-(3-sulfophenyl)-5-mercaptotetrazole) was dissolved in 993 g of water to form a 0.7 mass % aqueous solution of the mercapto 1 compound.

<<Preparation of Aqueous Mercapto Compound 2 solution>>

20 g of the mercapto compound 2 (1-(3-methylureidophenyl)-5-mercaptotetrazole) was dissolved in 980 g of water to form a 2.0 mass % aqueous solution of the mercapto compound 2.

10) Preparation of Pigment 1 Dispersion

250 g of water was sufficiently mixed with 64 g of C.I. Pigment Blue 60 and 6.4 g of DEMOL N manufactured by Kao Corp., to obtain a slurry. The slurry was placed in a vessel together with 800 g of zirconia beads having an average diameter of 0.5 mm, and dispersed for 25 hours by a dispersion apparatus (1/4G sand grinder mill manufactured by Imex Co.). The pigment content of the dispersed slurry was adjusted to 5 mass % by addition of water, to prepare a pigment 1 dispersion. The pigment 1 dispersion comprised pigment particles having an average particle diameter of 0.21 μm.

11) Preparation of Polymer Latex

<<Preparation of Latex 1 According to the Invention>>

A SBR latex grafted with polyvinyl alcohol was prepared. 12 parts of polyvinyl alcohol (viscosity-average polymerization degree: 1760, saponification degree: 90 mol %, polymerization degree by GPC measurement: 17800) was sufficiently dissolved in 290 parts of ion exchanged water at 95° C., and the resultant solution was introduced into a pressure resisting autoclave provided with a nitrogen inlet and a thermometer. After pH of the solution was adjusted with a dilute sulfuric acid to pH 3.9, 165 parts of styrene and 135 parts of butadiene from a pressure resisting meter were introduced thereto. The resultant solution was heated to 70° C., 10 parts of 2 mass % aqueous potassium peroxodisulfate solution was pressed into the pressure resisting autoclave to start the polymerization. The internal pressure was reduced from 4.8 kg/cmG over polymerization, and the pressure was 0.4 kg/cmG after 14 hours. The polymerization rate was 99.2%.

<<Preparation of Latex 2 According to the Invention>>

Another SBR grafted with polyvinyl alcohol was prepared. Latex 2 was prepared in the same manner as in the above latex 1, except that 165 parts of styrene was changed to 150 parts of styrene and 15 parts of acrylic acid.

<<Preparation of Latex 3 According to the Invention>>

An isoprene latex grafted with polyvinyl alcohol was prepared. A latex 3 was prepared in the same manner as in the above latex 2, except that butadiene was changed to isoprene.

<<Preparation of Latex 4 According to the Invention>>

An acrylic latex grafted with polyvinyl alcohol was prepared. 280 parts of ion exchanged water, 10 parts of polyvinyl alcohol (viscosity-average polymerization degree: 2450, saponification degree: 88 mol %, polymerization degree by GPC measurement: 8100) and 17 parts of polyvinyl alcohol having a mercapto group at the end (viscosity-average polymerization degree: 1000, saponification degree: 92 mol %) were introduced into a 1 l glass container provided with a reflux condenser, a dropping funnel, a thermometer and a nitrogen inlet, and were completely dissolved at 95° C. The pH of the solution was then adjusted with a dilute sulfuric acid to pH of 3.5. Then, 300 parts of methylmethacrylate/styrene/butylacrylate/hydroxyethylmethacrylate/acrylic acid at a mol ratio of 64/9/20/5/2 (molar ratio) were introduced thereto while stirring at 140 rpm, were heated to 65° C. and 10 parts of 2 mass % aqueous solution of potassium persulfate was added to start the polymerization. After the polymerization was carried out for 2 hours, 10 parts of 2 mass % aqueous solution of potassium persulfate was further added, and the temperature was increased to 70° C. After 5 hours, the polymerization rate was 99.9%, and the solution was cooled. The solution was diluted with water such that the solid content of the polymer latex was 19 mass %.

<<Preparation of Latex 5 According to the Invention>>

An acrylic latex grafted with gelatin was prepared. In a three necked, round-bottomed flask equipped with a condenser, an air stirrer and a nitrogen supply port under low gas seal pressure, and having capacity of 5 l, 4 l of distilled water purged by nitrogen was placed. The flask was arranged in a bath (CTB) which has a constant temperature of 60° C. After the temperature balance, 0.4 g of a dodecyl sodium sulfate surfactant and a mixture (400 g in total) of methylmethacrylate/styrene/butyl acrylate/hydroxyethylmethacrylate/acrylic acid=64/9/20/5/2 (mol ratio) were added into the reaction flask to form an emulsion. To this emulsion were added 2 g of K₂S₂O₈ and 1 g of Na₂S₂O₅. Then, 10 g of gelatin was further added and the polymerization reaction was performed at 60° C. for 17 hours. The solid content of the latex was 9.3%. The particle diameter of the latex was measured by a photon correlation spectroscopy analysis, and thus, the diameter of the latex was found to be 95 nm. The calculated value of the surface area of the latex was 63 m²/g.

The above latex dispersion was introduced into a round-bottomed, three necked flask equipped with a condenser, and was heated to 60° C. in a bath which has a constant temperature. The pH of the dispersion was adjusted to 8.0 by using a 20 mass % NaOH solution. AlO mass % solution of a carbamoyl sulfoethyl pyridinium inner salt was added into the latex, and the reaction was continued for 15 minutes at 60° C. Gelatin solution was heated to 60° C. and the pH thereof was adjusted to 8.0, and the solution was, then, added into the latex containing the carbamoyl sulfoethyl pyridinium inner salt after the reaction for 15 minutes. After adding the gelatin, grafting reaction was performed at 60° C. for 15 minutes. The grafted latex was continuously dialyzed to distilled water at 45° C. for 17 hours. The grafted latex was filtered by a fine filter cross made of nylon (trademark). The final solid content after dialysis was 5.9 mass %.

<<Preparation of Comparative Polymer Latex A>>

For the comparison, a SBR latex which does not graft a hydrophilic polymer was prepared. 287 g of deionized water, 7.73 g of a surfactant (PIONIN A-43-S (trade name, manufactured by Takemoto Oil & Fat Co., Ltd., solid content of 48.5 mass %), 14.06 ml of 1 mol/l NaOH, 0.15 g of tetra sodium ethylenediamine tetraacetate salt, 255 g of styrene, 11.25 g of acrylic acid and 3.0 g of tert-dodecyl mercaptan were introduced into a polymerization tank of a gas monomer reaction apparatus (Model TAS-2J, manufactured by TAIATSU TECHNO® CORPORATION). The reaction vessel was sealed, and the resultant mixture was stirred at 200 rpm. After the reaction vessel was deaerated by a vacuum pump, and nitrogen gas substitution was repeated several times, 108.75 g of 1,3-butadiene was pressed into the reaction vessel, and the inner temperature is increased to 60° C. A solution of 1.875 g of ammonium persulfate in 50 ml of deionized water was added thereto, and the solution was stirred continuously for 5 hours. The solution was further heated to 90° C., and was stirred for 3 hours. After completion of the reaction, the inner temperature is decreased to room temperature, and 1 mol/l NaOH and NH₄OH were added such that the ratio of Na⁺ ion to NH⁴⁺ ion is set to 1:5.3 (molar ratio), and the pH was adjusted to 8.4. Then, the solution was filtered through a polypropylene filter having a pore size of 1.0 μm to remove extraneous substances such as dust, and then was stored, to obtain 774.7 g of SBR latex TP-1. Halogen ions were measured by an ion chromatography, and the chloride ion concentration was 3 ppm. The concentration of a chelating agent was measured by a high-performance liquid chromatography, and the concentration of the chelating agent was 145 ppm.

The comparative polymer latex A had an average particle diameter of 90 nm, Tg of 17° C. and a solid content concentration of 44 mass %.

<<Preparation of Comparative Polymer Latex B>>

For comparison, an acrylic latex which does not graft a hydrophilic polymer was prepared. A comparative polymer latex B was synthesized in the same manner as the above synthesis of polymer latex 4, except that polyvinyl alcohol was not used and the polymerization time was adjusted such that the polymerization rate was equivalent to the polymer latex 4.

2. Preparation of Coating Liquids

1) Preparation of Coating Liquid 1 for Image-Forming Layer

1000 g of the fatty acid silver dispersion obtained above, water, the pigment 1 dispersion, the organic polyhalogen compound 1 dispersion, the organic polyhalogen compound 2 dispersion, the phthalazine compound 1 solution, the comparative polymer latex A solution, the reducing agent 1 dispersion, the reducing agent 2 dispersion, the hydrogen bonding compound 1 dispersion, the development accelerator 1 dispersion, the development accelerator 2 dispersion, the color tone adjusting agent 1 dispersion, the aqueous mercapto compound 1 solution, the aqueous mercapto compound 2 solution and 17 ml of 15 mass % methanol solution of phthalic acid were successively mixed, and 140 g of the silver halide mixed emulsion A was added to the mixture and well mixed immediately before the application. Thus obtained coating liquid for the image-forming layer was directly transported to a coating die and applied.

2) Preparation of Coating Liquids 2 to 4 for Image-Forming Layer

Coating liquids 2 to 4 for the image-forming layer were prepared in the same manner as the coating liquid 1 for the image-forming layer except that the comparative polymer latex was changed to latexes 1 to 3 according to the invention. The amount of each latex was controlled so as to obtain the same solid content as that of the coating liquid 1 for the image-forming layer.

3) Preparation of Coating Liquid 1 for Intermediate Layer

To a mixture of 10000 g of polyvinyl alcohol PVA-205 (manufactured by Kuraray Co., Ltd.), 163 g of the pigment 1 dispersion, 33 g of a 18.5 mass % aqueous solution of the blue dye 1 (KAYAFECT TURQUOISE RN LIQUID 150 manufactured by Nippon Kayaku Co., Ltd.), 27 ml of a 5 mass % aqueous solution of sodium di (2-ethylhexyl) sulfosuccinate, and 4200 ml of 19 mass % comparative latex B solution were added 27 ml of a 5 mass % aqueous solution of aerosol OT (manufactured by American Cyanamid Co.), 135 ml of a 20 mass % aqueous solution of diammonium phthalate and water such that the total amount was 1000 g. The pH value of the resultant mixture was adjusted to 7.5 with NaOH to obtain a coating liquid 1 for the intermediate layer. The coating liquid 1 for the intermediate layer was transported to a coating die such that the amount of the liquid was 8.9 ml/m².

4) Preparation of Coating Liquid 2 for Intermediate Layer

Coating liquids 2 for the intermediate layer was prepared in the same manner as the coating liquid 1 for the intermediate layer except for using the latex 4 of the invention instead of the comparative latex. The amount of the latex was controlled so as to obtain the same solid content as that of the coating liquid 1 for the image-forming layer.

5) Preparation of Coating Solution 1 for First Surface Protective Layer

100 g of inert gelatin and 10 mg of benzoisothiazolinone were dissolved in 840 ml of water, and to this solution were added 180 g of a 19 mass % solution of the comparative latex B, 12 ml of a 15 mass % methanol solution of phthalic acid, and 5.4 ml of a 5 mass % aqueous solution of sodium di (2-ethylhexyl) sulfosuccinate were mixed, and, 40 ml of a 4 mass % chromium alum was added to the mixture immediately before the application by a static mixer. Thus obtained coating liquid was transported to the coating die such that the amount of coating solution was 26.1 ml/m².

6) Preparation of Coating Liquid 2 for First Surface Protective Layer

Coating liquid 2 for the first surface protective layer was prepared in the same manner as the coating liquid 1 for the first surface protective layer except that the comparative latex B was changed to the latex 5 of the invention. The amount of the latex was controlled so as to obtain the same solid content as that of the coating liquid 1 for the first surface protective layer.

7) Preparation of Coating Solution 1 for Second Surface Protective Layer

100 g of inert gelatin and 10 mg of benzoisothiazolinone were dissolved in 800 ml of water, and to this solution were 10 g of a 10 mass % emulsion of a liquid paraffin, 30 g of a 10 mass % emulsion of dipentaerythrityl hexaisostearate, 180 g of a 19 mass % solution of the comparative latex B, 10 ml of a 15 mass % methanol solution of phthalic acid, 5.5 ml of a 1 mass % fluorinated surfactant (F-1) solution, 5.5 ml of a 1 mass % fluorinated surfactant (F-2) solution, 28 ml of a 5 mass % aqueous solution of a sodium di (2-ethylhexyl) sulfosuccinate, 4 g of polymethylmethacrylate particules (average particle diameter of 0.7 μm, the average particle diameter corresponding to 30% point on the cumulative volume weighted average distribution), and 21 g of fine polymethylmethacrylate particules (average particle diameter of 3.6 μm, the average particle diameter corresponding to 60% point on the cumulative volume weighted average distribution) to prepare a coating liquid for the surface protective layer. The coating liquid was transported to a coating die such that the amount of the liquid was 8.3 ml/m².

8) Preparation of Coating Liquid 2 for Second Surface Protective Layer

Coating liquid 2 for the second surface protective layer was prepared in the same manner as the coating liquid 1 for the second surface protective layer except that the comparative latex B was changed to the latex 5 of the invention. The amount of the latex was controlled so as to obtain the same solid content as that of the coating liquid 1 for the second surface protective layer.

TABLE 1

| | Coating | | | | | | | | |
|---|---|---|---|---|---|---|---|---|---|
| | solution | | | | | | | | |
| | for | | | | First | | Second | | |
| | image- | | Inter- | | surface | | surface | | |
| | forming | | mediate | | protective | | protective | | |
| | layer | | layer | | layer | | layer | | |
| Sample | | Latex | | Latex | | Latex | | Latex | |
| No | No | No | No | No | No | No | No | No | Note |
| 101 | 1 | A | 1 | B | 1 | B | 1 | B | Comparative |
| | | | | | | | | | Example |
| 102 | 2 | 1 | 2 | 4 | 2 | 5 | 2 | 5 | The Invention |
| 103 | 3 | 2 | ″ | ″ | ″ | ″ | ″ | ″ | The Invention |
| 104 | 4 | 3 | ″ | ″ | ″ | ″ | ″ | ″ | The Invention |
| 105 | ″ | ″ | 1 | B | 1 | B | 1 | B | The Invention |
| 106 | ″ | ″ | 2 | 4 | ″ | ″ | ″ | ″ | The Invention |
| 107 | ″ | ″ | 1 | B | 1 | B | 2 | 5 | The Invention |
| 108 | ″ | ″ | ″ | ″ | 2 | 5 | 1 | B | The Invention |

3. Production of Photothermographic Materials 101 to 108

The image-forming layer, the intermediate layer, the first surface protective layer, and the second surface protective layer were applied in this order onto the surface opposite to the back surface of the support by simultaneous mutilayer coating using a slide-bead application method, to produce a photothermographic material. The combination of the coating solution for each layer was shown in Table 2. At application, the coating liquids for the image-forming layer and the intermediate layer were controlled at 31° C., the coating liquid for the first surface protective layer was controlled at 36° C., and the coating liquid for the second surface protective layer was controlled at 37° C.

The application amount (g/m²) of the components of the image-forming layer was as follows.

| | |
|---|---|
| Fatty acid silver | 5.27 |
| Pigment(C.I. Pigment Blue 60) | 0.036 |
| Polyhalogen compound 1 | 0.14 |
| Polyhalogen compound 2 | 0.28 |
| Phthalazine compound 1 | 0.18 |
| Latex binder (shown in table 2) | 9.43 |
| Reducing agent 1 | 0.40 |
| Reducing agent 2 | 0.40 |
| Hydrogen-bonding compound 1 | 0.112 |
| Development accelerator 1 | 0.019 |
| Development accelerator 2 | 0.016 |
| Color tone adjusting agent 1 | 0.006 |
| Mercapto compound 1 | 0.001 |
| Mercapto compound 2 | 0.003 |
| Silver halide (Ag content) | 0.13 |
| Phthalic acid | 0.16 |

The conditions for the application and drying were as follows.

The application was carried out at the rate of 160 m/minute. The distance between the support and the tip of the coating die was 0.10-0.30 mm. The inner pressure of the decompression chamber was 196 to 882 Pa lower than the atmospheric pressure. The support was subjected to electrical neutralization by an ionic wind before the application.

The coating liquid was cooled by an air blow having a dry-bulb temperature of 10 to 20° C. in the chilling zone. Then the coating liquid was contactless-transported and dried by a helical type contactless drying apparatus using a drying wind having the dry-bulb temperature of 23 to 45° C. and the wet-bulb temperature of 15 to 21° C.

After the drying, the moisture content was controlled by leaving the photothermographic material in a condition of 25° C., 40 to 60% RH. Then, the dried layer was heated to 70 to 90° C. and cooled to 25° C.

The degree of matting, in terms of the Beck's smoothness, of the image-forming layer side of the thermographic material thus prepared was 550 seconds and that of the back layer side was 130 seconds. The pH of the image-forming layer side was measured and was found to be 6.0.

The chemical structures of the compounds used in the example are shown below.
Spectrally Sensitizing Dye A 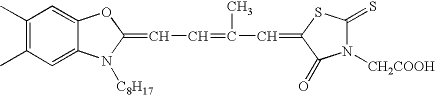
Spectrally Sensitizing Dye B 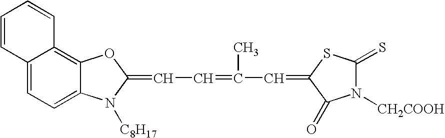
Tellurium Sensitizer C 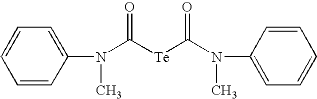
Base Precursor Compound 1 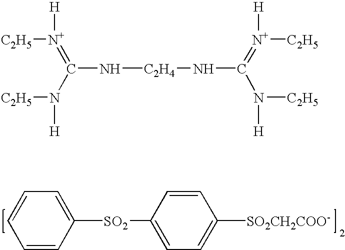
Cyanine Dye Compound 1 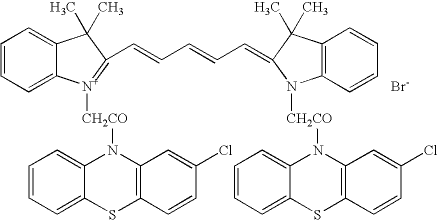
Compound 1 Whose One-Electron Oxidant Can Release One or More Electron(s) 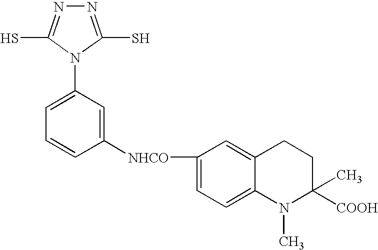
Compound 2 Whose One-Electron Oxidant Can Release One or More Electron(s) 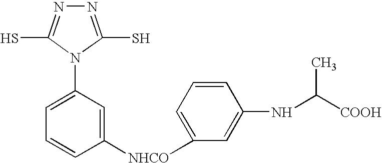
Compound 3 Whose One-Electron Oxidant Can Release One or More Electron(s) 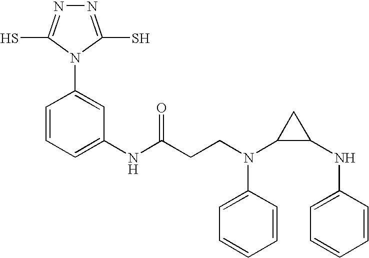
Compound 1 Having Adsorbent Group and Reducing Group 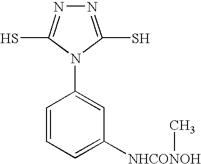
Compound 2 Having Adsorbent Group and Reducing Group 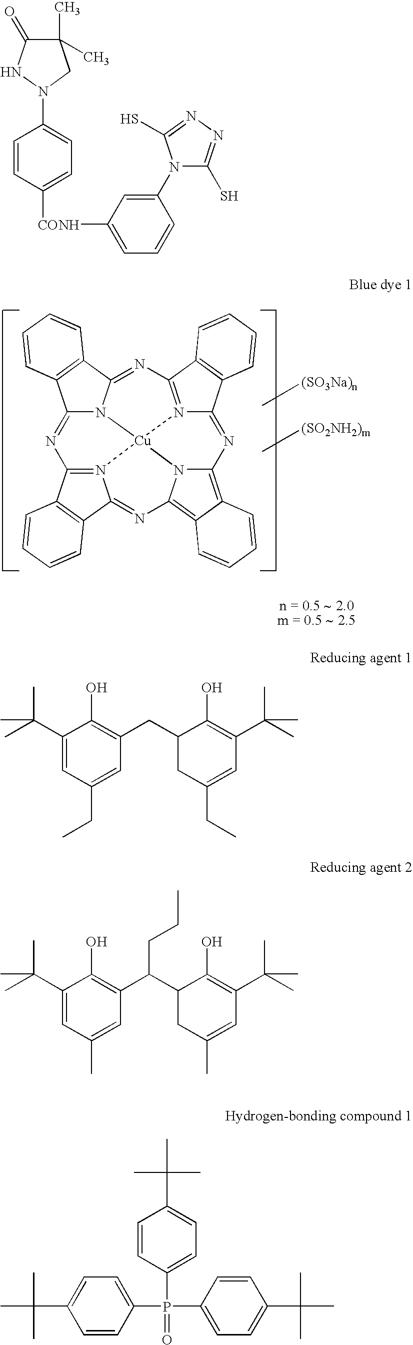 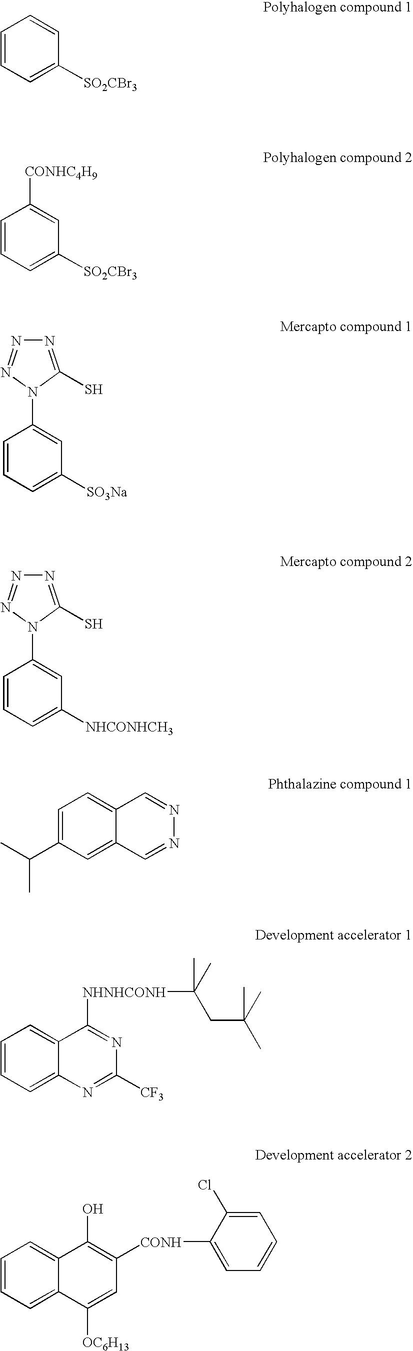 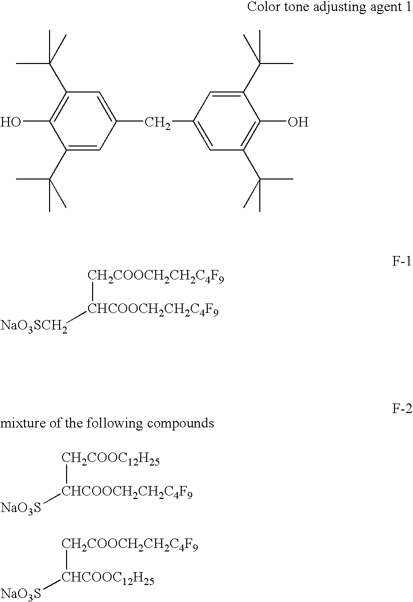
4. Evaluation of Photographic Properties
1) Preparation

Each sample thus prepared was cut into a half-size having a length of 43 cm and a width of 35 cm, enclosed in the following packaging material under conditions of 25° C. and 50% RH, stored at the ordinary temperature for 2 weeks, and subjected to the following evaluation, respectively.

<Packaging Material>

Structure: (10 μm PET)-(12 μm PE)-(9 μm aluminum foil)-(15 μm nylon)-(50 μm polyethylene containing 3 mass % of carbon)

Oxygen permeability: 0.02 ml/atm.m².25° C.day

Water permeability: 0.10 g/atm.m².25° C.day.

2) Exposure and Development of Photothermographic Material

Each of the samples was exposed and heat-developed by Fuji Medical Dry Laser Imager DRYPIX 7000 equipped with a 660 nm semiconductor laser having the maximum output of 50 mW (IIIB) and established on the following two environmental conditions. The material was heat-developed for 14 seconds using three panel heaters controlled at 107° C., 121° C., 121° C., respectively. Each material was transported at a controlled conveying speed in the heat development.

Environmental Condition 1: The image exposure and the heat developing were performed after each sample and the above DRYPIX7000 were left for 24 hours under the conditions of 13° C. and 10% RH environment.

Environmental Condition 2: The image exposure and the heat developing were performed after each sample and the above DRYPIX7000 were left for 24 hours under the conditions of 30° C. and the 80% RH environment.

3) Evaluation of Photographic Properties

Fogging: the concentration of a non-exposed part

Sensitivity: the reciprocal of a light exposure required for obtaining the concentration of 1.0; and the sensitivity of the sample 101 was set to 100, and the sensitivity was expressed by the relative value.

The obtained results were shown in Table 2.

TABLE 2

| | Environmental | | Environmental | | | |
|---|---|---|---|---|---|---|
| | Condition 1 | | Condition 2 | | Coated-Surface | |
| Sample No | Fogging | Sensitivity | Fogging | Sensitivity | Uniformity | Note |
| 101 | 0.20 | 100 | 0.22 | 101 | C | Comparative |
| | | | | | | Example |
| 102 | 0.20 | 100 | 0.20 | 101 | B | The |
| | | | | | | Invention |
| 103 | 0.20 | 100 | 0.20 | 101 | A | The |
| | | | | | | Invention |
| 104 | 0.20 | 100 | 0.20 | 101 | A | The |
| | | | | | | Invention |
| 105 | 0.20 | 100 | 0.20 | 101 | A | The |
| | | | | | | Invention |
| 106 | 0.20 | 100 | 0.20 | 101 | A | The |
| | | | | | | Invention |
| 107 | 0.20 | 100 | 0.20 | 101 | A | The |
| | | | | | | Invention |
| 108 | 0.20 | 100 | 0.20 | 101 | A | The |
| | | | | | | Invention |

(Evaluation of Coated-Surface Uniformity)

An exposure was performed uniformly in DRYPIX 7000 such that the concentration was 1.2. The surface uniformity of 30 cm² was then checked, and the number of decrease feeling substrates having a size of 0.5 mm or more was counted.

A: 0 Piece, B: 1 Piece to 2 Pieces, C: 3 Piece or More

As is apparent from Table 2, the coated-surface uniformity is excellent by using the copolymer of the invention, and even if the environmental condition is changed, there is little change of photography.

The photothermographic material of the invention forms a monochrome image by the silver image. The photothermographic material is preferably used as photothermographic materials for medical diagnosis, photothermographic materials for industrial photographs, photothermographic materials for printing and photothermographic materials for COM.

The invention can provide photothermographic materials having the high image quality and the improved heat developing environmental dependability.

All publications, patent applications, and technical standards mentioned in this specification are herein incorporated by reference to the same extent as if each individual publication, patent application, or technical standard was specifically and individually indicated to be incorporated by reference.

What is claimed is:

1. A photothermographic material comprising: a support and, on at least one surface of the support, an image-forming layer containing at least a photosensitive silver halide, a non-photosensitive organic silver salt, a reducing agent and a binder and at least a non-photosensitive layer, wherein the image forming layer and/or the non-photosensitive layer contains a polymer latex dispersed and stabilized with a water-soluble polymer protective colloid during polymerization.

2. The photothermographic material of claim 1, wherein the amount of the polymer latex is 50 mass % or more based on the amount of the binder in the image-forming layer.

3. The photothermographic material of claim 1, wherein the amount of the polymer latex is 50 mass % or more based on the amount of a binder in the non-photosensitive layer.

4. The photothermographic material of claim 1, wherein the amount of the polymer latex in the image-forming layer is 50 mass % or more based on the amount of the binder in the image-forming layer, and the amount of the polymer latex in the non-photosensitive layer is 50 mass % or more based on the amount of a binder in the non-photosensitive layer.

5. The photothermographic material of claim 1, wherein the water-soluble polymer protective colloid is at least one polymer selected from the group consisting of a vinyl alcohol based polymers including polyvinyl alcohol and derivatives thereof; gelatin or a derivative thereof; a polyacrylic acid or a polymethacrylic acid and salts of these acids; a poly vinyl alkyl ether; copolymers of vinyl acetate and acrylic acid, methacrylic acid or maleic anhydride, and saponified compounds of these copolymers; copolymers of lower alkyl vinyl ether and maleic anhydride; cellulose derivatives including alkylcellulose, hydroxyl alkylcellulose, alkylhydroxyl alkylcellulose and carboxymethyl cellulose; starch derivatives including an alkyl starch, a carboxymethyl starch and an oxidized starch; gum arabic or gum tragacanth; and a polyalkylene glycol.

6. The photothermographic material of claim 5, wherein the water-soluble polymer protective colloid is at least one polymer selected from the group consisting of vinyl alcohol based polymers including polyvinyl alcohol and derivatives thereof.

7. The photothermographic material of claim 5, wherein the water-soluble polymer protective colloid is gelatin or a derivative thereof.

8. The photothermographic material of claim 1, wherein the polymer latex is a (co)polymer comprising, as a main component, at least one kind of monomer unit selected from the group consisting of a (meth)acrylic ester monomer unit, a styrenic monomer unit and a diene monomer unit.

9. The photothermographic material of claim 8, wherein the polymer latex is a polymer latex obtained by copolymerizing 10 mass % to 70 mass % of a monomer unit represented by the following formula (M).
CH₂═CR⁰¹—CR⁰²═CH₂
wherein, R⁰¹ and R⁰² are each independently a group selected from a hydrogen atom, an alkyl group having 1 to 6 carbon atoms, a halogen atom or a cyano group.

10. The photothermographic material of claim 9, wherein one of R⁰¹ and R⁰² in the formula (M) is a hydrogen atom, and the other is a methyl group.

11. The photothermographic material of claim 8, wherein the polymer latex is a polymer latex obtained by copolymerizing 20 mass % to 80 mass % of the (meth) acrylic ester monomer unit.
